(19) United States
(12) Patent Application Publication
(10) Pub. No.: US 2025/0361897 A1
(43) Pub. Date: Nov. 27, 2025

(54) ABUTMENT STRUCTURE

(71) Applicant: DTECH PRECISION INDUSTRIES CO., LTD., New Taipei City (TW)

(72) Inventor: TING-JUI WANG, New Taipei City (TW)

(73) Assignee: DTECH PRECISION INDUSTRIES CO., LTD., New Taipei City (TW)

(21) Appl. No.: 19/084,719

(22) Filed: Mar. 19, 2025

(30) Foreign Application Priority Data
May 24, 2024 (TW) 113119349
Aug. 20, 2024 (TW) 113131434

(51) Int. Cl. F16B 5/06

(52) U.S. Cl. CPC F16B 5/0628; F16B 5/065

(57) ABSTRACT

The present disclosure provides an abutment structure and an abutment method thereof. The abutment structure includes a body portion, an abutment portion, and an elastic element, so that an elastic abutment space is formed between the body portion and the abutment portion. Alternatively, the abutment structure is provided with a wheel member, so that an elastic abutment space is formed between the abutment portion and the wheel member and the body portion. Smoother movement and effects of abutment and limitation can be achieved through the abutment portion, the wheel member, or cooperation between the abutment portion and the wheel member.

### CROSS-REFERENCE TO RELATED APPLICATION

This non-provisional application claims priority under 35 U.S.C. § 119 (a) on Patent Application No(s). 113119349 filed in Taiwan, R.O.C. on May 24, 2024 and Patent Application No(s). 113131434 filed in Taiwan, R.O.C. on Aug. 20, 2024, the entire contents of which are hereby incorporated by reference.

### BACKGROUND OF THE INVENTION

### 1. Field of the Invention

The present disclosure provides an abutment structure, and in particular, to an abutment structure that can achieve smoother movement and abutment and limitation.

### 2. Description of the Related Art

During movement and abutment and limitation of a general object, the object cannot smoothly move and perform abutment and limitation due to absence of a corresponding structure design for movement or abutment.

### BRIEF SUMMARY OF THE INVENTION

In view of the foregoing conventional technology, the inventor developed an abutment structure and an abutment method thereof, to achieve smoother movement and abutment and limitation through the abutment structure.

To achieve the foregoing objective and another objective, the present disclosure provides an abutment structure, including a body portion, at least one abutment portion, and an elastic element. The abutment portion is movably arranged on the body portion. The elastic element is arranged between the body portion and the abutment portion, so that an elastic abutment space is formed between the body portion and the abutment portion.

The present disclosure provides another abutment structure, including a body portion, at least one abutment portion, a wheel member, and an elastic element. The abutment portion is movably arranged on the body portion. The wheel member is movably arranged on the body portion. The elastic element is arranged between the body portion and the abutment portion, so that an elastic abutment space is formed between the abutment portion and the wheel member or the body portion.

In the foregoing abutment structure, the body portion, the abutment portion, and the elastic element are integrally formed, or the body portion and the abutment portion are integrally formed, or the body portion and the elastic element are integrally formed, or the abutment portion and the elastic element are integrally formed, or the wheel member and the abutment portion are integrally formed.

In the foregoing abutment structure, the wheel member and the abutment portion are integrally formed.

In the foregoing abutment structure, the body portion is fitted to an object. The abutment portion is configured to abut against a pushed object, so that the object is aligned through abutment, moved, elastically aligned, elastically moved, limited, or elastically limited.

In the foregoing abutment structure, the wheel member is arranged on a carrier.

In the foregoing abutment structure, one end of the elastic element abuts against the body portion, and an other end of the elastic element abuts against the abutment portion.

In the foregoing abutment structure, one end of the elastic element abuts against the body portion, and the other end of the elastic element abuts against a stop portion fitted to the abutment portion.

In the foregoing abutment structure, the body portion is provided with a fitting portion. The fitting portion is riveted, expanded, welded, or locked to an object, or the fitting portion and an object are integrally formed.

In the foregoing abutment structure, the abutment portion is provided with an engagement portion. The engagement portion is fitted to the body portion.

In the foregoing abutment structure, two or more than two abutment portions are provided. Each of the abutment portions is arranged on two sides, two ends, or different positions of an object to abut against a pushed object.

In the foregoing abutment structure, the body portion is provided with a limit portion. The limit portion is limited between the wheel member and the elastic element.

In the foregoing abutment structure, a surface of the body portion or the abutment portion is provided with a friction reducing material to reduce friction of the body portion or the abutment portion moving on a carrier. The friction reducing material is an electroplated layer, Teflon, nylon, plastic, oil, a spraying material, a soaking material, or a soft material.

In the foregoing abutment structure, a surface of the wheel member is provided with a friction reducing material to reduce friction of the wheel member moving on a carrier. The friction reducing material is an electroplated layer, Teflon, nylon, plastic, oil, a spraying material, a soaking material, or a soft material.

In the foregoing abutment structure, the body portion is arranged on an object. The object is an electronic device, a motherboard, a server, a storage, a data center, a cabinet, a rack, a casing, a heat sink, or a heating member.

In the foregoing abutment structure, the abutment structure or the body portion is arranged on an object. The abutment structure, the body portion, or the object is a rotator, a track member, a column member, a fastening member, a handle member, a flow channel, a flow baffle member, a chip, a flow spoiler, a heat sink, a support member, or an elastic member. Alternatively, the object is an electronic device, a motherboard, a server, a storage, a data center, a cabinet, a rack, a casing, a heat sink, or a heating member, or the abutment portion is a handle, a track, a slider, a moving object, a rod member, a rotating member, a heat sink, a rotator, a track member, a column member, a chip, a fastening member, a handle member, a flow channel, a flow baffle member, a flow spoiler, a heat sink, a support member, an elastic member, a housing, a printed circuit board, or a telescopic structure.

In the foregoing abutment structure, the body portion is provided with a limiting portion. The limiting portion limits movable joining of the abutment portion and the body portion, or the limiting portion limits the abutment portion and the body portion after deformation.

In the foregoing abutment structure, the body portion, the abutment portion, and the elastic element are integrally formed, the elastic element and the body portion or the abutment portion are integrally formed, or the abutment portion is a wheel member.

In the foregoing abutment structure, the abutment portion and the body portion are each provided with a limiting portion for joining.

In the foregoing abutment structure, the abutment portion is located on a lateral side of the body portion, or the abutment portion is located on a lateral side of an object.

In the foregoing abutment structure, the abutment structure or the abutment structure and a pushed object are combined into a module. The abutment structure or the module is a handle, a track, a slider, a moving object, a rod member, a rotating member, a heat sink, a housing, a printed circuit board, or a telescopic structure, or the pushed object is a handle, a track, a slider, a moving object, a rod member, a rotating member, a heat sink, a rotator, a track member, a column member, a chip, a fastening member, a handle member, a flow channel, a flow baffle member, a flow spoiler, a heat sink, a support member, a bundle line member, a bundle tube member, an optical fiber bundle member, a wire member, a tube member, an optical fiber member, an elastic member, a housing, a printed circuit board, or a telescopic structure.

In the foregoing abutment structure, the pushed object is provided with at least one entry portion. The entry portion is in communication with a channel.

In the foregoing abutment structure, the pushed object is provided with at least one entry portion. The entry portion is configured to enable the abutment portion to elastically abut against or be elastically snap-fitted to the entry portion, or the entry portion is configured to lift the abutment portion, or the entry portion is provided with an inclined surface or a slope surface for lifting the abutment portion.

In the foregoing abutment structure, the abutment structure is configured to abut against a heat sink, so that the heat sink applies pressure to the heating member through an abutment force of the abutment portion, to enable the heat sink to dissipate heat of the heating member.

In the foregoing abutment structure, the abutment structure has a pushed object. The pushed object is provided with at least one entry portion. The entry portion is configured to enable the abutment portion to elastically abut against or be elastically snap-fitted to the entry portion. The entry portion has a lifting portion, or the entry portion has two lifting portions. The entry portion is connected to a channel to allow the abutment portion to move. The entry portion is configured to lift the abutment portion. The entry portion is an inclined surface, a slope surface, a step portion, a cross section, or an arc surface for lifting the abutment portion. The abutment structure is a component or a module that is retractable, telescopic, movable, slidable, or laterally slidable on the pushed object, or the abutment structure is a handle that is retractable, telescopic, movable, slidable, or laterally slidable on the pushed object. A width of the channel is greater than that of a neck portion of the abutment portion, or an end of the elastic element abuts against the body portion and the other end abuts against a resisting portion of the abutment portion.

In the foregoing abutment structure, the abutment portion is pressed against a printed circuit board, a printed circuit board with an inconsistent thickness, or an object with an inconsistent thickness through an abutment force.

In the foregoing abutment structure, the abutment portion is configured to be snap-fitted to a receiving member. The receiving member is a fixing bracket, a flow baffle member, a flow guide member, a flow spoiler, a connector, a spacer, or a driving member. The receiving member is configured to fix a tube member, a flat cable, a connector, or a wire, or the receiving member is configured to guide or block a fluid, or the receiving member is configured to separate the fluid, or the receiving member is configured to drive the fluid. The fluid is a gas, a liquid, oil, or a current. The abutment structure and the receiving member are configured to guide a heat source to a fluid, an object, a metal object, or a non-metal object. The abutment portion is configured to be snap-fitted, fitted, clamped, slidably joined to or engaged with the heat sink, or the abutment portion is configured to be snap-fitted, fitted, clamped, slidably joined to or engaged with a track member.

In the foregoing abutment structure, the abutment structure is provided with an anti-rotation portion. The anti-rotation portion and a corresponding anti-rotation portion of an object mutually prevent rotation, provide limitation, or limit a direction of the object. Alternatively, the body portion of the abutment structure is provided with a fitting portion and an anti-rotation portion. The fitting portion is joined to an object, and the anti-rotation portion and a corresponding anti-rotation portion of the object mutually prevent rotation, provide limitation, or limit a direction of the object.

In the foregoing abutment structure, the body portion and the abutment portion are fixedly or movably fitted through a joining portion. The body portion or the abutment portion is provided with a handle portion or a first fastening portion. An intermediary member is arranged between the body portion, the abutment portion, and the elastic element. The abutment structure and an object are fixedly or movably fitted through a joining portion.

In the foregoing abutment structure, the abutment portion is a heat sink which is configured to apply pressure or apply pressure to a heating member for heat dissipation through a snap-fit connection. The heating member is a printed circuit board, an IC, a metal member, a non-metal member, or a chip.

In the foregoing abutment structure, the abutment portion enters through an entry portion of the heating member, or then the abutment portion enters a channel or a structure of the heating member, to enable the abutment portion to be snap-fitted to or arranged on the heating member, or enable the abutment portion to be arranged between the heating member and the body portion.

In the foregoing abutment structure, the abutment portion enters the entry portion and is snap-fitted to the channel.

In the foregoing abutment structure, a medium is provided between the abutment portion and the heating member. The medium is a heat dissipation medium, a thermal grease, an elastic member, or a sheet member.

In the foregoing abutment structure, the body portion and an object are configured to be welded, riveted, expanded, snap-fitted, locked, or integrally formed.

In the foregoing abutment structure, the body portion is a heat sink. The body portion of the abutment structure is fitted to a heat sink. The heat sink is configured to dissipate heat of a heating member. The heat sink is provided with a flow channel for a fluid to pass through, or the heat sink is provided with a fastening member. The abutment portion abuts against the heat sink, or the abutment portion is a handle or a first fastening portion. The heating member is a chip or a conductor, or the heating member is arranged on an object. The object is a printed circuit board, a heat sink, or a metal member. The heat sink is provided with a fastening member which is configured to be snap-fitted to an object. The fastening member has an elastic element for applying an elastic force to the heat sink to apply pressure to the heating member for heat dissipation, or the abutment portion is configured to rotate to reduce a height.

The foregoing abutment structure further includes a second fastening portion. The body portion has an arrangement portion configured to allow the second fastening portion to reach an arrangement position, to allow mounting of the abutment portion or extend through the body portion, or allow the abutment portion to control the second fastening portion.

The foregoing abutment structure further includes a second fastening portion. The body portion has an arrangement portion configured to allow the second fastening portion to reach an arrangement position or configured to be joined to the body portion through a joining portion. The joining portion is the abutment portion for abutting against the second fastening portion. The abutment portion is configured to abut against the second fastening portion. The abutment portion is moved to control movement or snap-fitting of the second fastening portion. The joining portion is jointed to the abutment portion through an other joining portion, the other joining portion is moved to control movement or snap-fitting of the second fastening portion, or the abutment portion drives the movement of the other joining portion to control the movement or snap-fitting of the second fastening portion. The second fastening portion may be a sphere, an inclined surface-equipped member, a one-way inclined surface-equipped member, a column member, or a fastening member. The arrangement portion is a perforation, a movement space or a groove portion, an inclined surface portion, a step portion, an arc surface portion, a right angle portion, or non-right angle portion. The abutment portion is a first fastening portion, or the joining portion is a first fastening portion. Alternatively, the abutment portion is a second fastening portion, or the joining portion is a second fastening portion. The abutment portion and the joining portion are integrally formed, or the abutment portion and the joining portion are fitted to each other. Alternatively, the abutment portion is the joining portion. The second fastening portion reaches the arrangement position through free fall, or the second fastening portion is assisted by a tool or a magnetic tool to reach the arrangement position.

The foregoing abutment structure further includes a pushed object. The pushed object is provided with at least one lifting portion. The lifting portion is configured to enable the abutment portion to elastically abut against or be elastically snap-fitted to the lifting portion or a channel. Alternatively, the pushed object has two lifting portions, or the lifting portion is connected to a channel to allow the abutment portion to move. The lifting portion is configured to lift the abutment portion. The lifting portion is an inclined surface, a slope surface, a step portion, a cross section, or an arc surface for lifting the abutment portion. The abutment structure is a component or a module that is retractable, telescopic, movable, slidable, or laterally slidable on the pushed object, or the abutment structure is a handle that is retractable, telescopic, movable, slidable, or laterally slidable on the pushed object. A width of the lifting portion is less than that of the abutment portion, or a width of the channel is greater than that of a neck portion of the abutment portion. An end of the elastic element abuts against the body portion and the other end abuts against a resisting portion of the abutment portion. Alternatively, the abutment portion has an operating portion for operating the abutment portion to move or be snap-fitted.

The foregoing abutment structure further includes a joining portion. The joining portion is configured to be joined to the body portion. The joining portion is a first fastening portion. The joining portion and the abutment portion are configured to be joined through an other joining portion. The joining portion is moved to control the movement or snap-fitting of the first fastening portion, or the abutment portion drives the movement of the joining portion to control the movement or snap-fitting of the first fastening portion. The joining portion is configured to first pass through the body portion and then be joined to the abutment portion through the other joining portion, or the joining portion is configured to first pass through the body portion and the elastic element and then be joined to the abutment portion through the other joining portion.

The foregoing abutment structure further includes a second fastening portion. The abutment portion has a limiting portion and an open portion configured to rotationally limit a limiting position of the second fastening portion, limit an open position of the second fastening portion. The elastic element is a torsion spring or a torsional elastic member configured to drive the abutment portion to be normally in a position where the second fastening portion is limited or be normally in a position where the second fastening portion is released. The second fastening portion is a sphere, an inclined surface-equipped member, a one-way inclined surface-equipped member, a column member, or a fastening member. Two ends of the elastic element are respectively limited to the body portion and the abutment portion. The body portion or the abutment portion has a limit portion for limiting a rotation angle of the abutment portion. The limiting portion or the open portion is an arc surface, an inclined surface, a spherical surface, a groove body, a hole, a flat surface, a recess, or a protrusion.

In the foregoing abutment structure, the abutment structure is arranged on a heat sink. The heat sink provides heat dissipation for a heating member. The heating member is arranged between two heat sinks for heat dissipation. The heating member has an upper heat sink and a lower heat sink for heat dissipation. The abutment structure is configured to fit two heat sinks, the abutment structure is configured to fit a heat sink to an object, or the abutment structure is a fastening member and configured to lift or operate the heat sink, or the heating member is a transistor, an energized member, a memory, a CPU, or a GPU.

The abutment structure further includes a second fastening portion. The abutment portion abuts against the second fastening portion. The body portion has an arrangement portion, a limiting portion, and a lifting portion. The limiting portion limits the abutment portion. The abutment portion moves longitudinally to enable the second fastening portion to reach an arrangement position of the arrangement portion. The lifting portion is configured to abut against the abutment portion that is rotated.

In the foregoing abutment structure, the body portion is a handle. The body portion is mounted to the object through fitting portions on two ends respectively mated with fixing elements. The body portion is provided with two abutment portions arranged adjacent to each other, or the body portion is provided with one abutment portion.

In the foregoing abutment structure, the abutment structure has a pushed object. The pushed object is a handle. The pushed object is provided with at least one entry portion. The entry portion is in communication with a channel. The entry portion is configured to lift the abutment portion, and the entry portion is configured to enable the abutment portion to elastically abut against or be elastically snap-fitted to the entry portion.

In the foregoing abutment structure, the abutment structure or the body portion is arranged on an object. The object is a casing or a cabinet. The body portion is provided with a handle portion and a fastening member, or the abutment portion is provided with a first fastening portion. The handle portion is configured to move the body portion and mate with abutment of the abutment portion and the elastic element, to implement the snap-fitting and tripping of the fastening member or the first fastening portion and an object.

The foregoing abutment structure further includes a second fastening portion. The abutment portion abuts against the second fastening portion. The body portion, the abutment portion, and the elastic element are integrally formed. The body portion is provided with an arrangement portion or a limiting portion. The abutment portion moves longitudinally or rotationally to enable the elastic element to be elastically limited or elastically disengage from the limiting portion, or to enable the abutment portion to drive the second fastening portion to reach an arrangement position of the arrangement portion. The abutment portion has an open portion, and the open portion is configured to rotationally limit a limiting position of the second fastening portion, or configured to limit an open position of the second fastening portion, so that the second fastening portion may be enabled to perform required position limitation or position release through cooperation of the open portion.

In the foregoing abutment structure, the body portion is provided with a limiting portion. The limiting portion is joined to the body portion through a riveted connection, a threaded connection, a snap fit, a welded connection, a locked connection, hot melting, or stamping with a tool, so that the limiting portion limits movable joining of the abutment portion and the body portion.

In the foregoing abutment structure, an end of the body portion is provided with a fitting portion. The fitting portion includes a snap-fit member or a snap member. The body portion is joined to an object through the snap-fit member or the snap member.

In the foregoing abutment structure, the abutment structure is fitted to two heat sinks. A heating member is arranged between the two heat sinks. The two heat sinks are pressed against the heating member through an abutment force of the abutment portion, to enable the heat sinks to dissipate heat of the heating member.

The foregoing abutment structure further includes a first fastening portion and a second fastening portion. The body portion has an arrangement portion configured to allow the second fastening portion to reach an arrangement position. The abutment portion is joined to the first fastening portion through a joining portion, so that the abutment portion is moved to control movement or snap-fitting of the second fastening portion.

In the foregoing abutment structure, the abutment structure is arranged or integrally formed on one heat sink, and the abutment portion is snap-fitted to or arranged on an object, a circuit board, or the other heat sink, so that the heat sink dissipates heat of the heating member.

In the foregoing abutment structure, the abutment portion is arranged on a fastener, or the abutment portion is configured to be snap-fitted to an object, enable a fastening portion of the fastener to be snap-fitted to or be limited to a snap-fit portion of the object, and prevent the fastener from detaching from the object. The fastening portion is a threaded member, an outer fastening member, an inner fastening member, a snap member, or a column member.

The foregoing abutment structure further includes a first fastening portion and a second fastening portion. The first fastening portion abuts against the second fastening portion. The body portion is provided with a rotating portion. The abutment portion is provided with a corresponding rotating portion. The abutment portion is rotated to enable the rotating portion to mate with the corresponding rotating portion, so that the first fastening portion is allowed to control the movement of the second fastening portion in a spiral manner.

In the foregoing abutment structure, the body portion, the abutment portion, and the elastic element are integrally formed. The elastic element is elastically deformable and snap-fitted to a limiting portion of the body portion, so as to limit the abutment portion, or prevent the corresponding rotating portion of the abutment portion from being detached or loosened from the rotating portion.

In the foregoing abutment structure, the abutment portion is a threaded member, a column member, an outer fastening member, an inner fastening member, or a snap member.

In the foregoing abutment structure, the body portion is provided with a handle portion. The body portion is arranged on an object. The abutment portion is provided with a guide portion. The guide portion is configured to guide the handle portion or the object to approach, enter, be arranged on, or be mounted to an other object.

In the foregoing abutment structure, a margin is defined between the guide portion and the handle portion, or an other margin is defined between the handle portion and the other object.

In the foregoing abutment structure, the guide portion and the handle portion are fitted through a joining portion. The joining portion is a threaded member, a riveted member, or an expanded member.

In the foregoing abutment structure, one end of the elastic element abuts against the body portion, and an other end abuts against the abutment portion.

In the foregoing abutment structure, the body portion is provided with a handle portion, a pulling portion, or a fastening member. The elastic element is arranged on the body portion. The body portion is an elastic element. The fastening member is snap-fitted to an object and an other object, which is configured to perform elastic tripping to enable the object to move through the wheel member. The object is a casing, or the other object is a rack or a cabinet.

In the foregoing abutment structure, the body portion is provided with an anti-rotation portion. The abutment portion is provided with a corresponding anti-rotation portion. The anti-rotation portion and the corresponding anti-rotation portion are configured to prevent rotation between the body portion and the abutment portion, or the anti-rotation portion or the corresponding anti-rotation portion is configured to prevent rotation with respect to an object.

In the foregoing abutment structure, the body portion is provided with a handle portion and a second fastening portion. The body portion is arranged on an object. The second fastening portion is snap-fitted to an other object.

In the foregoing abutment structure, the second fastening portion is an outer fastening member, a threaded member, a column member, a snap member, an inner fastening member, an inclined surface-equipped member, or a curved surface-equipped member.

In the foregoing abutment structure, the body portion is provided with an arrangement portion configured to allow arrangement of the second fastening portion. The arrangement portion has an anti-rotation portion or a limiting portion, which is configured to prevent rotation of or limit the handle portion when it is shaped during manufacturing by stamping by applying a force, so that the arrangement portion is kept in a position or a direction where the second fastening portion is correctly mounted.

In the foregoing abutment structure, the handle portion is formed through injection molding in a mold. The arrangement portion for mounting of the second fastening portion is formed through a mold or a module. The mold is formed through injection molding in a plastic or metal mold.

In the foregoing abutment structure, the body portion is provided with at least one second fastening portion. The body portion is laterally fitted to an object through the second fastening portion.

In the foregoing abutment structure, the body portion is provided with an arrangement portion configured to allow the second fastening portion to enter or reach an arrangement position or a snap-fit position. The arrangement portion is located on a lateral side, above, or below the body portion, so that the second fastening portion first enters the body portion through the arrangement portion, or the second fastening portion enters an arrangement position or a snap-fit position. The abutment portion is configured to abut against the second fastening portion, or the second fastening portion is enabled to be opened or closed through the abutment portion, an elastic element is arranged on the body portion to abut against the abutment portion, or the elastic element is arranged on the body portion to abut against the body portion and the abutment portion, the abutment portion has a guide portion to guide movement of the second fastening portion, the guide portion is an inclined surface, a curved surface, an arc surface, a step portion, a recess, a protrusion, or a flat surface, or the abutment portion has a limiting portion for limiting the position of the second fastening portion or a position after the movement.

In the foregoing abutment structure, one, two, or more than two second fastening portions are arranged.

In the foregoing abutment structure, the body portion is provided with an arrangement portion configured to allow the second fastening portion to enter or reach an arrangement position or a snap-fit position. The arrangement portion is located on a lateral side, above, or below the body portion, so that the second fastening portion first enters the body portion through the arrangement portion, or the second fastening portion enters an arrangement position or a snap-fit position. The abutment portion is configured to abut against the second fastening portion, or the second fastening portion is enabled to be opened or closed through the abutment portion, an elastic element is arranged on the body portion to abut against the abutment portion, or the elastic element is arranged on the body portion to abut against the body portion and the abutment portion, the abutment portion has a guide portion to guide movement of the second fastening portion, the guide portion is an inclined surface, a curved surface, an arc surface, a step portion, a recess, a protrusion, or a flat surface, or the abutment portion has a limiting portion for limiting the position of the second fastening portion or a position after the movement.

In the foregoing abutment structure, the body portion is provided with an arrangement position configured to allow arrangement of a second fastening portion. The arrangement position is located on a lateral side, above, or below the body portion. The second fastening portion enters the arrangement position or a snap-fit position. The abutment portion is configured to abut against the second fastening portion, or the second fastening portion is enabled to be opened or closed through the abutment portion. The second fastening portion is first arranged in the arrangement position, then the abutment portion or an elastic element is arranged on the body portion to abut against the abutment portion, or the elastic element is arranged on the body portion to abut against the body portion and the abutment portion. The abutment portion has a guide portion to guide movement of the second fastening portion. The guide portion is an inclined surface, a curved surface, an arc surface, a step portion, a recess, a protrusion, or a flat surface. The abutment portion has a limiting portion configured to limit a position of the second fastening portion or a position after movement. The body portion has an arrangement portion configured to allow the second fastening portion to reach the arrangement position, and then the abutment portion or the elastic element is arranged on the body portion to abut against the abutment portion.

In the foregoing abutment structure, the body portion is configured to be fitted to or integrally formed with an object. The abutment portion is provided with a first fastening portion. The abutment portion is configured to be fitted or bolted to the body portion to form a fitted member, a connector, or a link member. The elastic element abuts against the body portion and the abutment portion. The object is snap-fitted to an other object through the first fastening portion. The object is provided with a wheel member, a rolling member, a track member, or a sliding member, so that the first fastening portion may be opened or closed to move the object through the wheel member, the rolling member, the track member, or the sliding member, or configured to be detached from the other object.

In the foregoing abutment structure, the abutment portion is provided with an entry portion to enable a second fastening portion to snap-fit the abutment portion to the object. The entry portion has a channel for causing the second fastening portion having the elastic element to limit, temporarily limit, or elastically limit the first fastening portion in a snap-fit position or a tripping position, or causing the first fastening portion to move to the snap-fit position or the tripping position.

In the foregoing abutment structure, the body portion is provided with an anti-rotation portion configured to prevent rotation with respect to an object. The abutment portion is provided with an other anti-rotation portion configured to prevent rotation with respect to the body portion. The other anti-rotation portion is configured to limit a position or movement of the abutment portion, or the other anti-rotation portion is configured to limit a snap-fit direction, a snap-fit angle, or a snap-fit position of a second fastening portion.

In the foregoing abutment structure, the body portion is fitted to the abutment portion and an object, the abutment portion is a fastening portion, or the object is arranged on other object. The object and the other object are each a casing or a cabinet. The abutment portion is snap-fitted to the other object to operate, rotate, or pull the body portion, to enable the abutment portion to be detached from the other object, or to enable an object with a wheel member or a track to be partially or completely detached from or snap-fitted to the other object through rolling of the wheel member or sliding of the track.

In the foregoing abutment structure, the body portion is provided with an arrangement portion configured to allow mounting of the second fastening portion. The body portion is provided with an arrangement position. The arrangement position and the arrangement portion are opposite positions or positions reachable through free fall.

In the foregoing abutment structure, the elastic element is a torsion spring having two ends respectively arranged on the body portion and the abutment portion, so as to enable the abutment portion to elastically rotate and abut against a second fastening portion, or enable the second fastening portion to be located in a snap-fit position or a non-snap-fit position. The body portion or the abutment portion is provided with a limiting portion configured to limit the abutment portion to enable the second fastening portion to be in the snap-fit position or the non-snap-fit position.

In the foregoing abutment structure, two abutment portions and two elastic elements are arranged. The abutment portions are configured to be snap-fitted to two receiving objects. The body portion is provided with a shoulder portion. The shoulder portion is configured to support at least one receiving object. The body portion is provided with a fitting portion. The fitting portion is configured to be fitted to an object. The body portion is provided with an anti-rotation portion. The anti-rotation portion is configured to limit a direction of the body portion. The anti-rotation portion is configured to limit a snap-fit direction of the abutment portions, or the anti-rotation portion is configured to limit directions of the body portion, the abutment portions, and the object.

In the foregoing abutment structure, the body portion is provided with an arrangement portion. An object enters the body portion through the arrangement portion and is snap-fitted, interference-fitted, locked, or enabled to conduct current through the abutment portion. The object is a receiving member, a conductive member, a wire, a fastener, an optical fiber, a metal member, a plastic member, a column member, or a plate member. The abutment portion is a fastening portion, a column member, a threaded member, a convex member, a concave member, or a flat member. Two ends of the elastic element respectively abut against the body portion and the abutment portion, or the arrangement portion is a hole portion, a groove portion, a trench portion, or a space.

In the foregoing abutment structure, the body portion is provided with a limiting portion. The limiting portion is configured to limit the abutment portion and the elastic element. Alternatively, the body portion is provided with a screw thread for fixing to an object, or first passing through the object and then being fixed to other object. The abutment portion is laterally fitted to the body portion and is configured to laterally abut against or be snap-fitted to the object. The abutment portion is configured to laterally abut against or be snap-fitted to a receiving portion of the object, the abutment portion first passes through the object and then laterally abuts against or is snap-fitted to the other object, or the body portion first passes through the object and then is configured to be locked into the other object, so that the abutment portion abuts against or is snap-fitted to the other object or the receiving portion of the other object. The abutment portion is configured to be laterally interference-fitted to a nut, the screw thread, or the object to prevent loosening or snap-fit. The body portion is provided with a fitting portion. The fitting portion is configured to be riveted, expanded, welded, snap-fitted, or locked to the object, the body portion is provided with an operating portion, or the body portion is provided with a head portion.

The foregoing abutment structure further includes an elastic element. The elastic element is arranged between the body portion and the abutment portion and located on an outer side of the body portion.

In the foregoing abutment structure, the abutment portion is a pull member, and the body portion is a handle. The abutment portion is joined to a first fastening portion through an other joining portion, and configured to pull the abutment portion to control snap-fitting or tripping of the first fastening portion and an other object.

In the foregoing abutment structure, the abutment portion is pressed by a tool or a mold, so that the abutment portion is expanded and fitted to the body portion, or the abutment portion is provided with a groove portion, a recess, or a hole portion, and is configured to apply pressure to the groove portion, the recess, or the hole portion through a tool or a mold, causing the abutment portion to be expanded and fitted to the body portion.

In the foregoing abutment structure, the abutment portion is snap-fitted to a heating member or a heat sink. The heat sink is configured to dissipate heat of the heating member.

In the foregoing abutment structure, the body portion is a handle, a fastening member, a track member, a heat sink, a moving member, a wheel, a rotating member, or a rolling member. The body portion is arranged or mounted to an object, or the abutment portion is located on an other side of the object, and is configured to enable the abutment portion to be snap-fitted to an other object.

In the foregoing abutment structure, the body portion is provided with an arrangement portion, or the body portion is provided with an arrangement position. The arrangement portion is configured to allow a second fastening portion to reach the arrangement position, or the arrangement position and the arrangement portion are opposite positions or positions reachable through free fall.

In the foregoing abutment structure, the body portion is provided with an arrangement portion, the body portion is provided with an arrangement position, and the second fastening portion reaches the arrangement position through the arrangement portion.

In the foregoing abutment structure, the body portion is provided with an arrangement portion, the body portion is provided with an arrangement position, the second fastening portion reaches the arrangement position through the arrangement portion, and an abutment portion is arranged on the body portion to abut against the second fastening portion.

In the foregoing abutment structure, the body portion is provided with an arrangement portion, and the body portion is provided with an arrangement position. The second fastening portion reaches the arrangement position through the arrangement portion, or the second fastening portion reaches the arrangement position through free fall through the arrangement portion. The second fastening portion reaches the arrangement position through the arrangement portion by using a tool. The second fastening portion is configured to limit the abutment portion after reaching the arrangement position, or the second fastening portion reaches the arrangement position through the arrangement portion, and then the abutment portion or an elastic element is arranged on the body portion to abut against the abutment portion.

The present disclosure provides an abutment method of an abutment structure. The abutment structure includes a body portion, at least one abutment portion, and an elastic element. The abutment portion is movably arranged on the body portion. The elastic element is arranged between the body portion and the abutment portion, so that an elastic abutment space is formed between the body portion and the abutment portion during application.

The present disclosure provides an abutment method of another abutment structure. The abutment structure includes a body portion, at least one abutment portion, a wheel member, and an elastic element. The abutment portion is movably arranged on the body portion. The wheel member is movably arranged on the body portion. The elastic element is arranged between the body portion and the abutment portion, so that an elastic abutment space is formed between the abutment portion and the wheel member or the body portion during application. The wheel member is an abutment portion, or the wheel member and the abutment portion are integrally formed.

The present disclosure provides an abutment method of another abutment structure. The abutment structure includes a body portion, at least one abutment portion, and an elastic element. The abutment portion is configured to be snap-fitted to a receiving member. The receiving member is a fixing bracket, a flow baffle member, a flow guide member, a flow spoiler, a connector, a spacer, or a driving member. The receiving member is configured to fix a tube member, a flat cable, a connector, or a wire, or the receiving member is configured to guide or block a fluid, or the receiving member is configured to separate the fluid, or the receiving member is configured to drive the fluid. The fluid is a gas, a liquid, oil, or a current. The abutment structure and the receiving member are configured to guide a heat source to a fluid, an object, a metal object, or a non-metal object. The abutment structure is provided with an anti-rotation portion. The anti-rotation portion and a corresponding anti-rotation portion of an object mutually prevent rotation, provide limitation, or limit a direction of the object. The body portion of the abutment structure is provided with a fitting portion or an anti-rotation portion. The fitting portion is joined to an object. The anti-rotation portion and a corresponding anti-rotation portion of the object mutually prevent rotation, provide limitation, or limit the direction of the object. The body portion and the abutment portion are fixedly or movably fitted through a joining portion. The body portion or the abutment portion is provided with a handle portion or a first fastening portion. An intermediary member is arranged between the body portion, the abutment portion, and the elastic element. The abutment structure and an object are fixedly or movably fitted through a joining portion. The abutment portion is a heat sink which is configured to apply pressure or apply pressure to a heating member through a snap-fit connection for heat dissipation. The heating member is a printed circuit board, an IC, a metal member, a non-metal member, or a chip. The abutment portion enters through an entry portion of the heating member, or the abutment portion is enabled to enter a structure or a channel of the heating member, so that the abutment portion is snap-fitted to or arranged on the heating member, or the abutment portion is arranged between the heating member and the body portion. The abutment portion enters the entry portion and snaps into the structure or channel.

The present disclosure provides an abutment method of another abutment structure. The abutment structure includes a body portion, at least one abutment portion, and an elastic element. The body portion of the abutment structure is a heat sink. The body portion of the abutment structure is fitted to a heat sink. The heat sink is configured to dissipate heat of a heating member. The heat sink is provided with a flow channel for a fluid to pass through, or the heat sink is provided with a fastening member. The abutment portion abuts against the heat sink, or the abutment portion is a handle or a first fastening portion. The heating member is a chip or a conductor, or the heating member is arranged on an object. The object is a printed circuit board, a heat sink, or a metal member. The heat sink is provided with a fastening member which is configured to be snap-fitted to an object. The fastening member has an elastic element for applying an elastic force to the heat sink to apply pressure to the heating member for heat dissipation, or the abutment portion is configured to rotate to reduce a height.

The present disclosure provides an abutment method of another abutment structure. The abutment structure includes a body portion, at least one abutment portion, an elastic element, and a first fastening portion. The body portion has an arrangement portion configured to allow the first fastening portion to reach an arrangement position and be joined to the body portion through a joining portion. The joining portion is a first fastening portion. The joining portion is the abutment portion configured to abut against the first fastening portion. The joining portion is jointed to the abutment portion through an other joining portion. The other joining portion is moved to control movement or snap-fitting of the first fastening portion. The abutment portion drives the movement of the other joining portion to control the movement or snap-fitting of the first fastening portion. The first fastening portion is a sphere, an inclined surface-equipped member, a one-way inclined surface-equipped member, a column member, or a fastening member. The arrangement portion is a perforation, a movement space or groove portion, an inclined surface portion, a step portion, an arc surface portion, a right angle portion, or non-right angle portion.

The present disclosure provides an abutment method of another abutment portion, an elastic element, and a pushed object. The pushed object is provided with at least one lifting portion. The lifting portion is configured to enable the abutment portion to elastically abut against or be elastically snap-fitted to the lifting portion or a channel. Alternatively, the pushed object has two lifting portions, or the lifting portion is connected to a channel to allow the abutment portion to move. The lifting portion is configured to lift the abutment portion. The lifting portion is an inclined surface, a slope surface, a step portion, a cross section, or an arc surface for lifting the abutment portion. The abutment structure is a component or a module that is retractable, telescopic, movable, slidable, or laterally slidable on the pushed object, or the abutment structure is a handle that is retractable, telescopic, movable, slidable, or laterally slidable on the pushed object. A width of the lifting portion is less than that of the abutment portion, or a width of the channel is greater than that of a neck portion of the abutment portion. An end of the elastic element abuts against the body portion and the other end abuts against a resisting portion of the abutment portion. Alternatively, the abutment portion has an operating portion for operating the abutment portion to move or be snap-fitted.

The present disclosure provides an abutment method of another abutment portion, and an elastic element, and further includes a joining portion. The joining portion is configured to be joined to the body portion. The joining portion is a first fastening portion. The joining portion and the abutment portion are configured to be joined through an other joining portion. The joining portion is moved to control the movement or snap-fitting of the first fastening portion, or the abutment portion drives the movement of the joining portion to control the movement or snap-fitting of the first fastening portion. The joining portion is configured to first pass through the body portion and then be joined to the abutment portion through the other joining portion, or the joining portion is configured to first pass through the body portion and the elastic element and then be joined to the abutment portion through the other joining portion.

The present disclosure provides an abutment method of another abutment structure. The abutment structure includes a body portion, at least one abutment portion, and an elastic element, and further includes a second fastening portion. The abutment portion has a limiting portion and an open portion configured to rotationally limit a limiting position of the second fastening portion, limit an open position of the second fastening portion. The elastic element is a torsion spring or a torsional elastic member configured to drive the abutment portion to be normally in a position where the second fastening portion is limited or be normally in a position where the second fastening portion is released. The second fastening portion is a sphere, an inclined surface-equipped member, a one-way inclined surface-equipped member, a column member, or a fastening member. Two ends of the elastic element are respectively limited to the body portion and the abutment portion. The body portion or the abutment portion has a limit portion for limiting a rotation angle of the abutment portion. The limiting portion or the open portion is an arc surface, an inclined surface, a spherical surface, a groove body, a hole, a flat surface, a recess, or a protrusion.

The present disclosure provides an abutment method of another abutment structure. The abutment structure includes a body portion, at least one abutment portion, and an elastic element. The abutment structure is arranged on a heat sink. The heat sink provides heat dissipation for a heating member. The heating member is arranged between two heat sinks for heat dissipation. The heating member has an upper heat sink and a lower heat sink for heat dissipation. The abutment structure is configured to fit two heat sinks, the abutment structure is configured to fit a heat sink to an object, or the abutment structure is a fastening member and configured to lift or operate the heat sink, or the heating member is a transistor, an energized member, a memory, a CPU, or a GPU.

The present disclosure provides an abutment method of another abutment structure. The abutment structure includes a body portion, at least one abutment portion, and an elastic element, and further includes a second fastening portion. The body portion has an arrangement portion configured to allow the second fastening portion to reach an arrangement position, to allow mounting of the abutment portion or extend through the body portion, or allow the abutment portion to control the second fastening portion.

The present disclosure provides an abutment method of another abutment structure. The abutment structure includes a body portion, at least one abutment portion, and an elastic element, and further includes a second fastening portion. The body portion has an arrangement portion configured to allow the second fastening portion to reach an arrangement position or configured to be joined to the body portion through a joining portion. The joining portion is the abutment portion for abutting against the second fastening portion. The abutment portion is configured to abut against the second fastening portion. The abutment portion is moved to control movement or snap-fitting of the second fastening portion. The joining portion is jointed to the abutment portion through an other joining portion, the other joining portion is moved to control movement or snap-fitting of the second fastening portion, or the abutment portion drives the movement of the other joining portion to control the movement or snap-fitting of the second fastening portion. The second fastening portion may be a sphere, an inclined surface-equipped member, a one-way inclined surface-equipped member, a column member, or a fastening member. The arrangement portion is a perforation, a movement space or a groove portion, an inclined surface portion, a step portion, an arc surface portion, a right angle portion, or non-right angle portion. The abutment portion is a first fastening portion, or the joining portion is a first fastening portion. Alternatively, the abutment portion is a second fastening portion, or the joining portion is a second fastening portion. The abutment portion and the joining portion are integrally formed, or the abutment portion and the joining portion are fitted to each other. Alternatively, the abutment portion is the joining portion. The second fastening portion reaches the arrangement position through free fall, or the second fastening portion is assisted by a tool or a magnetic tool to reach the arrangement position.

In this way, according to the abutment structure and the abutment method thereof, smoother movement and abutment and limitation may be achieved through the abutment structure.

### BRIEF DESCRIPTION OF THE DRAWINGS

FIG. 1 is a schematic diagram of an appearance according to a first embodiment of the present disclosure.

FIG. 2 is a schematic diagram of an appearance according to a second embodiment of the present disclosure.

FIG. 3 is a schematic diagram of an appearance according to a third embodiment of the present disclosure.

FIG. 4 is a schematic diagram of an appearance according to a fourth embodiment of the present disclosure.

FIG. 5 is a schematic diagram of an appearance according to a fifth embodiment of the present disclosure.

FIG. 6 is a schematic diagram of an appearance according to a sixth embodiment of the present disclosure.

FIG. 7 is a schematic diagram of an appearance according to a seventh embodiment of the present disclosure.

FIG. 8 is another schematic diagram of an appearance according to an eighth embodiment of the present disclosure.

FIG. 9 is a schematic diagram of an appearance according to a ninth embodiment of the present disclosure.

FIG. 10 is a schematic diagram of an appearance according to a tenth embodiment of the present disclosure.

FIG. 11 is a schematic diagram of an eleventh embodiment of the present disclosure.

FIG. 12 is a schematic diagram of a twelfth embodiment of the present disclosure.

FIG. 13 is a schematic diagram of a thirteenth embodiment of the present disclosure.

FIG. 14 is a schematic diagram of a fourteenth embodiment of the present disclosure.

FIG. 15 is a schematic diagram of a fifteenth embodiment of the present disclosure.

FIG. 16 is a schematic diagram of a sixteenth embodiment of the present disclosure.

FIG. 17 is a schematic diagram of a seventeenth embodiment of the present disclosure.

FIG. 18 is a schematic diagram of an eighteenth embodiment of the present disclosure.

FIG. 19 is a schematic diagram of a nineteenth embodiment of the present disclosure.

FIG. 20 is a schematic diagram of a twentieth embodiment of the present disclosure.

FIG. 21 is a schematic diagram of a twenty-first embodiment of the present disclosure.

FIG. 22 is a schematic diagram of a twenty-second embodiment of the present disclosure.

FIG. 23 is a schematic diagram of a twenty-third embodiment of the present disclosure.

FIG. 24 is a schematic diagram of a twenty-fourth embodiment of the present disclosure.

FIG. 25 is a schematic diagram of a twenty-fifth embodiment of the present disclosure.

FIG. 26 is a schematic diagram I of a twenty-sixth embodiment of the present disclosure.

FIG. 27 is a schematic diagram II of a twenty-sixth embodiment of the present disclosure.

FIG. 28 is a schematic diagram of a twenty-seventh embodiment of the present disclosure.

FIG. 29 is a schematic diagram of a twenty-eighth embodiment of the present disclosure.

FIG. 30 is a schematic diagram of a twenty-ninth embodiment of the present disclosure.

FIG. 31 is a schematic diagram of a thirtieth embodiment of the present disclosure.

FIG. 32 is a schematic diagram of a thirty-first embodiment of the present disclosure.

FIG. 33 is a schematic diagram of a thirty-second embodiment of the present disclosure.

FIG. 34 is a schematic diagram of a thirty-third embodiment of the present disclosure.

FIG. 35 is a schematic diagram of a thirty-fourth embodiment of the present disclosure.

FIG. 36 is a schematic diagram of a thirty-fifth embodiment of the present disclosure.

FIG. 37 is a schematic diagram of a thirty-fifth embodiment of the present disclosure.

FIG. 38 is a schematic diagram of a thirty-sixth embodiment of the present disclosure.

FIG. 39 is a schematic diagram of a thirty-seventh embodiment of the present disclosure.

FIG. 40 is a schematic diagram of a thirty-eighth embodiment of the present disclosure.

FIG. 41 is a schematic diagram of a thirty-ninth embodiment of the present disclosure.

FIG. 42 is a schematic diagram of a fortieth embodiment of the present disclosure.

FIG. 43 is a schematic diagram of a forty-first embodiment of the present disclosure.

FIG. 44 is a schematic diagram of a forty-second embodiment of the present disclosure.

FIG. 45 is a schematic diagram of a forty-third embodiment of the present disclosure.

FIG. 46 is a schematic diagram of a forty-fourth embodiment of the present disclosure.

FIG. 47 is a schematic diagram of a forty-fifth embodiment of the present disclosure.

FIG. 48 is a schematic diagram I of a forty-sixth embodiment of the present disclosure.

FIG. 49 is a schematic diagram II of a forty-sixth embodiment of the present disclosure.

FIG. 50 is a schematic diagram of a forty-seventh embodiment of the present disclosure.

FIG. 51 is a schematic diagram of a forty-eighth embodiment of the present disclosure.

FIG. 52 is a schematic diagram I of a forty-ninth embodiment of the present disclosure.

FIG. 53 is a schematic diagram II of a forty-ninth embodiment of the present disclosure.

FIG. 54 is a schematic diagram of a fiftieth embodiment of the present disclosure.

FIG. 55 is a schematic diagram of a fifty-first embodiment of the present disclosure.

FIG. 56 is a schematic diagram I of a fifty-second embodiment of the present disclosure.

FIG. 57 is a schematic diagram II of a fifty-second embodiment of the present disclosure.

FIG. 58 is a schematic diagram of a fifty-third embodiment of the present disclosure.

FIG. 59 is a schematic diagram of a fifty-fourth embodiment of the present disclosure.

FIG. 60 is a schematic diagram I of a fifty-fifth embodiment of the present disclosure.

FIG. 61 is a schematic diagram II of a fifth-fifth embodiment of the present disclosure.

FIG. 62 is a schematic diagram of a fifty-sixth embodiment of the present disclosure.

FIG. 63 is a schematic diagram of a fifty-seventh embodiment of the present disclosure.

FIG. 64 is a schematic diagram of a fifty-eighth embodiment of the present disclosure.

FIG. 65 is a schematic diagram of a fifty-ninth embodiment of the present disclosure.

FIG. 66 is a schematic diagram of a sixtieth embodiment of the present disclosure.

FIG. 67 is a schematic diagram of a sixty-first embodiment of the present disclosure.

FIG. 68 is a schematic diagram of a sixty-second embodiment of the present disclosure.

FIG. 69 is a schematic diagram of a sixty-third embodiment of the present disclosure.

FIG. 70 is a schematic diagram of a sixty-fourth embodiment of the present disclosure.

FIG. 71 is a schematic diagram of a sixty-fifth embodiment of the present disclosure.

FIG. 72 is a schematic diagram of a sixty-sixth embodiment of the present disclosure.

FIG. 73 is a schematic diagram of a sixty-seventh embodiment of the present disclosure.

FIG. 74 is a schematic diagram of a sixty-eighth embodiment of the present disclosure.

FIG. 75 is a schematic diagram of a sixty-ninth embodiment of the present disclosure.

FIG. 76 is a schematic diagram of a seventieth embodiment of the present disclosure.

FIG. 77 is a schematic diagram of a seventy-first embodiment of the present disclosure.

FIG. 78 is a schematic diagram of a seventy-second embodiment of the present disclosure.

FIG. 79 is a schematic diagram of a seventy-third embodiment of the present disclosure.

FIG. 80 is a schematic diagram of a seventy-fourth embodiment of the present disclosure.

FIG. 81 is a schematic diagram of a seventy-fifth embodiment of the present disclosure.

FIG. 82 is a schematic diagram of a seventy-sixth embodiment of the present disclosure.

FIG. 83 is a schematic diagram of a seventy-seventh embodiment of the present disclosure.

FIG. 84 is a schematic diagram of a seventy-eighth embodiment of the present disclosure.

FIG. 85 is a schematic diagram of a seventy-ninth embodiment of the present disclosure.

FIG. 86 is a schematic diagram of an eightieth embodiment of the present disclosure.

FIG. 87 is a schematic diagram of an eighty-first embodiment of the present disclosure.

FIG. 88 is a schematic diagram of an eighty-second embodiment of the present disclosure.

FIG. 89 is a schematic diagram of an eighty-third embodiment of the present disclosure.

FIG. 90 is a schematic diagram of an eighty-fourth embodiment of the present disclosure.

FIG. 91 is a schematic diagram of an eighty-fifth embodiment of the present disclosure.

FIG. 92 is a schematic diagram of an eighty-sixth embodiment of the present disclosure.

FIG. 93 is a schematic diagram of an eighty-seventh embodiment of the present disclosure.

FIG. 94 is a schematic diagram of an eighty-eighth embodiment of the present disclosure.

FIG. 95 is a schematic diagram of an eighty-ninth embodiment of the present disclosure.

FIG. 96 is a schematic diagram of a ninetieth embodiment of the present disclosure.

FIG. 97 is a schematic diagram of a second fastening portion according to the present disclosure in different forms.

FIG. 98 is a schematic diagram of a ninety-first embodiment of the present disclosure.

FIG. 99 is a schematic diagram of a ninety-second embodiment of the present disclosure.

FIG. 100 is a schematic diagram of a ninety-third embodiment of the present disclosure.

FIG. 101 is a schematic diagram of a ninety-fourth embodiment of the present disclosure.

FIG. 102 is a schematic diagram of a ninety-fifth embodiment of the present disclosure.

FIG. 103 is a schematic diagram of a ninety-sixth embodiment of the present disclosure.

FIG. 104 is a schematic diagram of a ninety-seventh embodiment of the present disclosure.

FIG. 105 is a schematic diagram of a ninety-eighth embodiment of the present disclosure.

FIG. 106 is a schematic diagram of a ninety-ninth embodiment of the present disclosure.

FIG. 107 is a schematic diagram of a hundredth embodiment of the present disclosure.

FIG. 108 is a schematic diagram of a one hundred and first embodiment of the present disclosure.

FIG. 109 is a schematic diagram of a one hundred and second embodiment of the present disclosure.

FIG. 110 is a schematic diagram of a one hundred and third embodiment of the present disclosure.

FIG. 111 is a schematic diagram of a one hundred and fourth embodiment of the present disclosure.

FIG. 112 is a schematic diagram of a one hundred and fifth embodiment of the present disclosure.

FIG. 113 is a schematic diagram of a one hundred and sixth embodiment of the present disclosure.

FIG. 114 is a schematic diagram of a one hundred and seventh embodiment of the present disclosure.

FIG. 115 is a schematic diagram of a one hundred and eighth embodiment of the present disclosure.

FIG. 116 is a schematic diagram of a one hundred and ninth embodiment of the present disclosure.

FIG. 117 is a schematic diagram of a one hundred and tenth embodiment of the present disclosure.

FIG. 118 is a schematic diagram of a one hundred and eleventh embodiment of the present disclosure.

FIG. 119 is a schematic diagram of a one hundred and twelfth embodiment of the present disclosure.

FIG. 120 is a schematic diagram of a one hundred and thirteenth embodiment of the present disclosure.

FIG. 121 is a schematic diagram of a one hundred and fourteenth embodiment of the present disclosure.

FIG. 122 is a schematic diagram of a one hundred and fifteenth embodiment of the present disclosure.

FIG. 123 is a schematic diagram of a one hundred and sixteenth embodiment of the present disclosure.

FIG. 124 is a schematic diagram of a one hundred and seventeenth embodiment of the present disclosure.

FIG. 125 is a schematic diagram of a one hundred and eighteenth embodiment of the present disclosure.

FIG. 126 is a schematic diagram of a one hundred and nineteenth embodiment of the present disclosure.

FIG. 127 is a schematic diagram of a one hundred and twentieth embodiment of the present disclosure.

### DETAILED DESCRIPTION OF THE INVENTION

In order to fully understand the purpose, features, and effects of the present disclosure, the present disclosure is described in detail through the following specific embodiments and the accompanying drawings. The description is as follows.

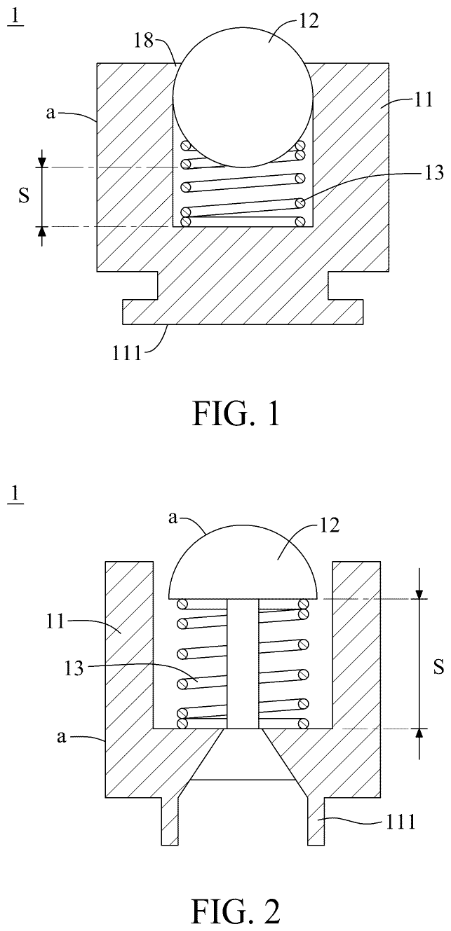

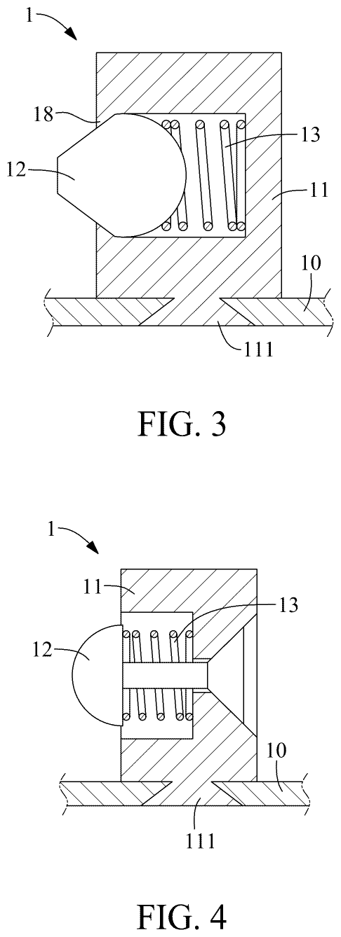

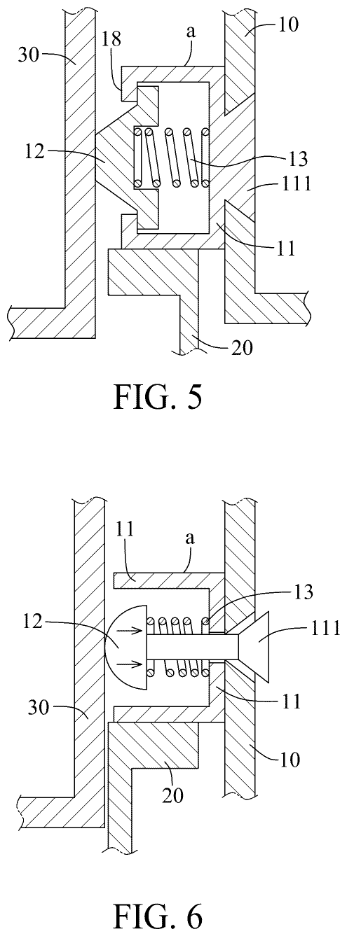

Referring to FIG. 1 to FIG. 6, as shown in the figures, the present disclosure is an abutment structure and an abutment method thereof. The abutment structure 1 includes a body portion 11, at least one abutment portion 12, and an elastic element 13.

The abutment portion 12 is movably arranged on the body portion 11.

The elastic element 13 is arranged between the body portion 11 and the abutment portion 12, so that an elastic abutment space S is formed between the body portion 11 and the abutment portion 12.

During application of the abutment structure 1, the elastic abutment space S may be formed between the body portion 11 and the abutment portion 12 through cooperation among the body portion 11, the abutment portion 12, and the elastic element 13. The abutment structure 1 may be fitted to an object 10 at one end of the body portion 11, an outer side of the body portion 11 is arranged on a carrier 20, and the abutment portion 12 abuts against a pushed object 30 at the other end of the body portion 11, to enable the body portion 11 to move on the carrier 20. However, the abutment portion 12 mates with the elastic element 13 to align through abutment, move, elastically align, elastically move, limit, or elastically limit the object 10. In this way, the purpose of smoother movement and abutment and limitation is achieved through the abutment structure 1.

In addition to the foregoing embodiment, in an embodiment of the present disclosure, a difference from the foregoing embodiment is that the pushed object 30 may be a handle, a track, a slider, a moving object, a rod member, a rotating member, a heat sink, a rotator, a track member, a column member, a chip, a fastening member, a handle member, a flow channel, a flow baffle member, a flow spoiler, a heat sink, a support member, an elastic member, a housing, a printed circuit board, or a telescopic structure. In this way, the present disclosure can better meet requirements for practical application.

In addition to the foregoing embodiment, in an embodiment of the present disclosure, a difference from the foregoing embodiment is that a surface of the body portion 11 (or the abutment portion 12) is provided with a friction reducing material a to reduce friction of the body portion 11 (or the abutment portion 12) moving on the carrier 20. The friction reducing material a is an electroplated layer, Teflon, nylon, plastic, oil, a spraying material, a soaking material, or a soft material. In this way, the body portion 11 may easily move on the carrier 20.

In addition to the foregoing embodiment, in an embodiment of the present disclosure, a difference from the foregoing embodiment is that the abutment structure 1 or the body portion 11 is a rotator, a track member, a column member, a fastening member, a handle member, a flow channel, a flow baffle member, a chip, a flow spoiler, a heat sink, a support member, or an elastic member. The object 10 may be an electronic device, a motherboard, a server, a storage, a data center, a cabinet, a rack, a casing, a heat sink, or a heating member. In this way, the present disclosure can better meet requirements for practical application.

In addition to the foregoing embodiment, in an embodiment of the present disclosure, a difference from the foregoing embodiment is that an end of the body portion 11 is provided with a fitting portion 111. The body portion 11 or the fitting portion 111 of the body portion 11 is configured to be welded, riveted, expanded, snap-fitted, and locked to or integrally formed with an object 10. In this way, the present disclosure can better meet requirements for practical application.

In addition to the foregoing embodiment, in an embodiment of the present disclosure, a difference from the foregoing embodiment is that an end of the elastic element 13 abuts against the body portion 11, and an other end of the elastic element 13 abuts against the abutment portion 12. In this way, an elastic abutment space S with a fixed distance may be formed between the body portion 11 and the abutment portion 12 through pushing of the elastic element 13.

In addition to the foregoing embodiment, in an embodiment of the present disclosure, a difference from the foregoing embodiment is that the body portion 11 is provided with a limiting portion 18. The limiting portion 18 limits the movable joining of the abutment portion 12 and the body portion 11. In this way, the abutment portion 12 may be movably limited to the body portion 11 through the limiting portion 18.

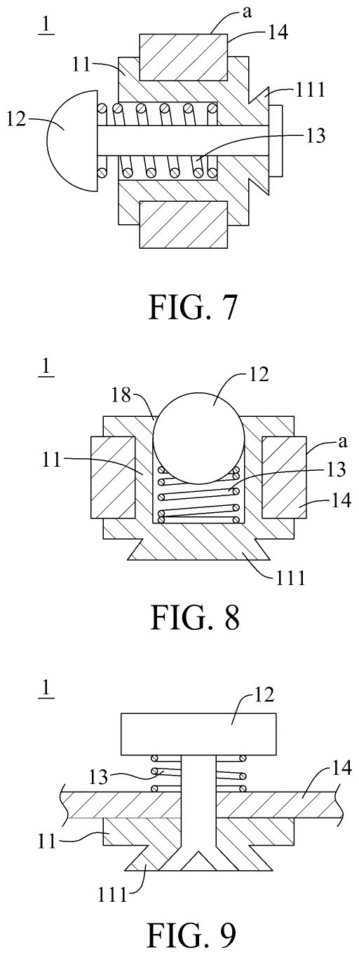

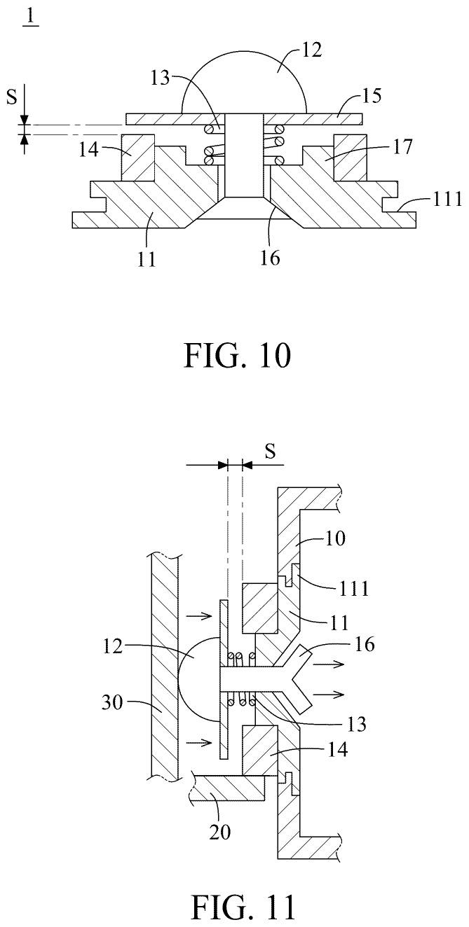

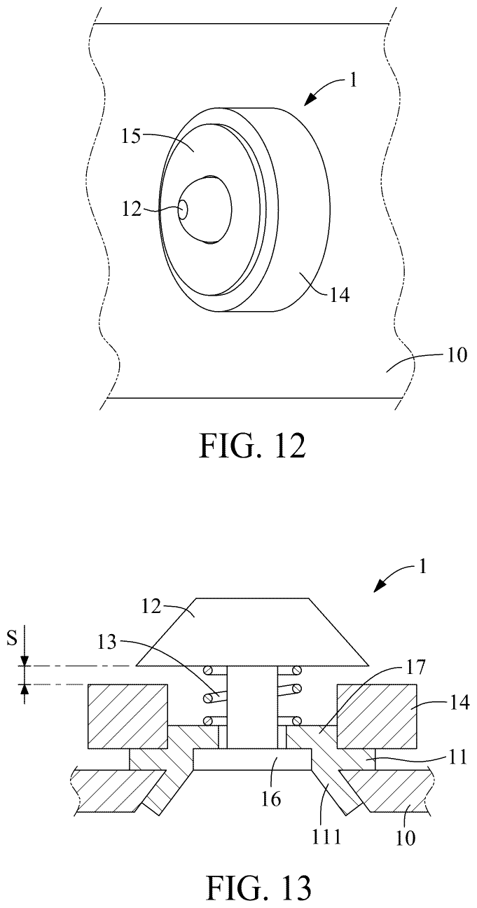

Referring to FIG. 7 to FIG. 12, as shown in the figures, in addition to the foregoing embodiment, in an embodiment of the present disclosure, a difference from the foregoing embodiment is that the present disclosure provides another abutment structure, including a body portion 11, at least one abutment portion 12, a wheel member 14, and an elastic element 13. The abutment portion 12 is movably arranged on an inner side of the body portion 11. The wheel member 14 is movably arranged on an outer side of the body portion 11 (or the wheel member 14 and the abutment portion 12 are integrally formed). The elastic element 13 is arranged between the body portion 11 and the abutment portion 12, so that an elastic abutment space S is formed between the abutment portion 12, the wheel member 14, and the body portion 11 during application.

During application of the abutment structure 1, the elastic abutment space S may be formed between the abutment portion 12, the wheel member 14, and the body portion 11 through cooperation among the body portion 11, the abutment portion 12, the elastic element 13, and the wheel member 14. The abutment structure 1 may be fitted to the object 10 at one end of the body portion 11, the wheel member 14 on the outer side of the body portion 11 is arranged on the carrier 20, and the abutment portion 12 abuts against the pushed object 30, to enable the wheel member 14 to move on the carrier 20. However, the abutment portion 12 mates with the elastic element 13 to align through abutment, move, elastically align, elastically move, limit, or elastically limit the object 10. In this way, the purpose of smoother movement and abutment and limitation is achieved through the abutment structure 1.

In addition to the foregoing embodiment, in an embodiment of the present disclosure, a difference from the foregoing embodiment is that a surface of the wheel member 14 is provided with a friction reducing material a to reduce friction of the wheel member 14 moving on the carrier 20. The friction reducing material a is an electroplated layer, Teflon, nylon, plastic, oil, a spraying material, a soaking material, or a soft material. In this way, the wheel member 14 may easily move on the carrier 20.

In addition to the foregoing embodiments, in one embodiment of the present disclosure, a difference from the foregoing embodiment is that one end of the elastic element 13 abuts against the body portion 11, and the other end of the elastic element 13 abuts against a stop portion 15 fitted to the abutment portion 12. In this way, an elastic abutment space S with a fixed distance may be formed between the abutment portion 12, the wheel member 14, and the body portion 11 through cooperation between the stop portion 15 and the elastic element 13.

In addition to the foregoing embodiment, in an embodiment of the present disclosure, a difference from the foregoing embodiment is that the abutment portion 12 is provided with an engagement portion 16. The engagement portion 16 is fitted to the body portion 11. In this way, the abutment portion 12 is stably fitted to the body portion 11 through the engagement portion 16.

Referring to FIG. 13, as shown in the figure, in addition to the foregoing embodiment, in an embodiment of the present disclosure, a difference from the foregoing embodiment is that the body portion is provided with a limit portion 17. The limit portion is limited between the wheel member 14 and the elastic element 13, and the engagement portion 16 is limited to the limit portion 17. In this way, the wheel member 14 may be stably fitted to a predetermined position of the body portion 11 through the limit portion 17.

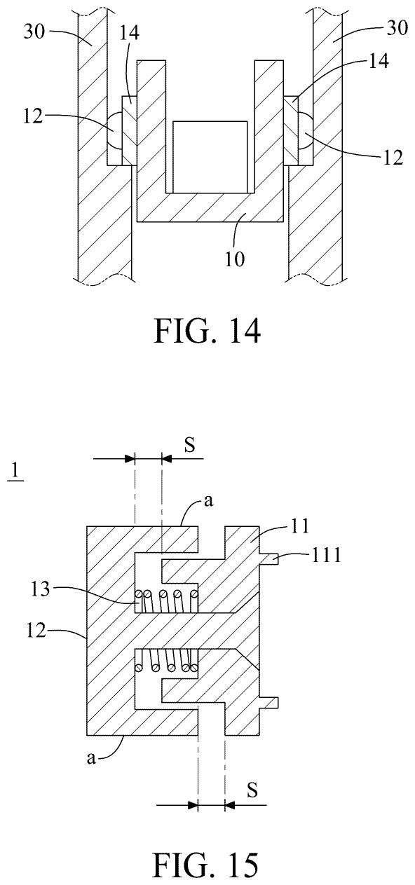

Referring to FIG. 14, as shown in the figure, in addition to the foregoing embodiment, in an embodiment of the present disclosure, a difference from the foregoing embodiment is that two (or more than two) abutment portions 12 are arranged. Each of the abutment portions 12 is arranged at two sides, two ends, or different positions of the object 10 to abut against the pushed object 30 through each abutment portion 12.

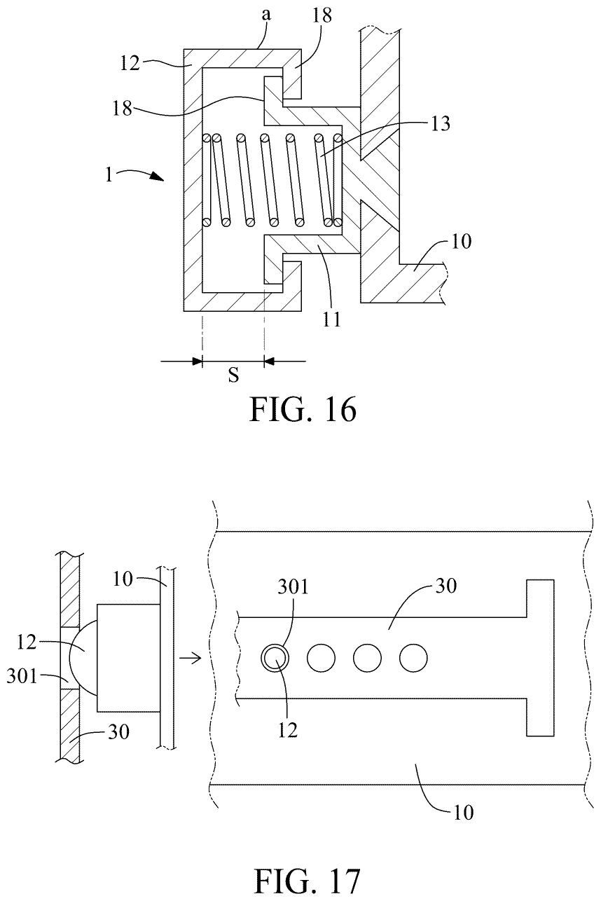

Referring to FIG. 15 and FIG. 16, as shown in the figures, in addition to the foregoing embodiments, in an embodiment of the present disclosure, a difference from the foregoing embodiments is that the abutment portion 12 and the body portion 11 are each provided with a limiting portion 18 for joining. The limiting portion 18 limits movable joining of the abutment portion 12 and the body portion 11. In this way, the abutment portion 12 is movably limited to the body portion 11, so that the abutment portion 12 may be used as a wheel member.

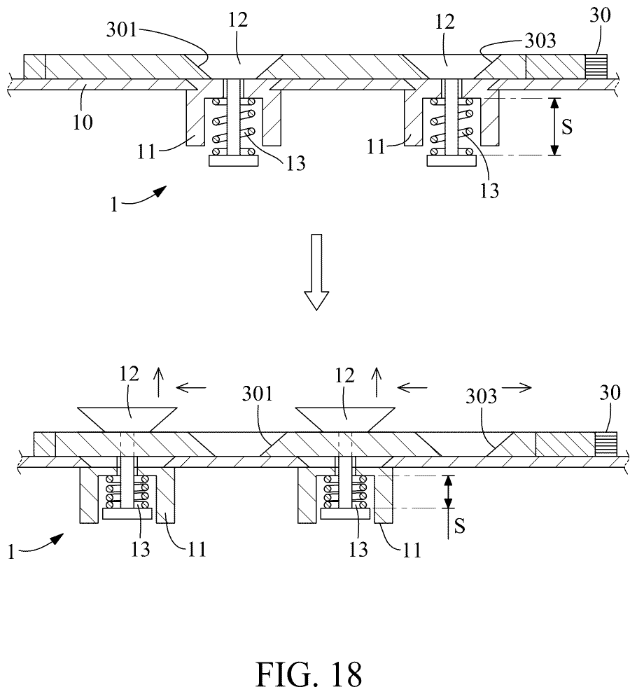

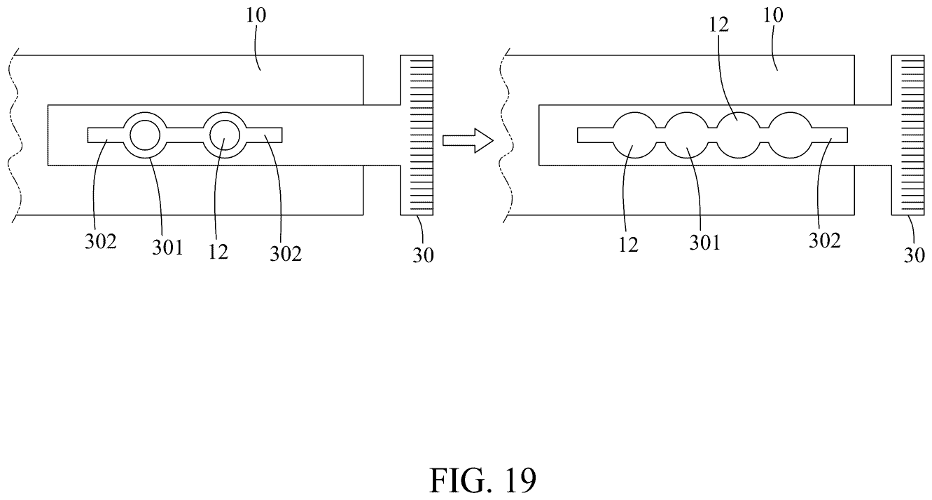

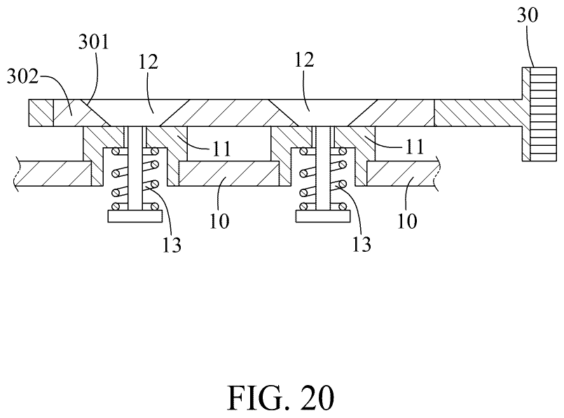

Referring to FIG. 17 to FIG. 20, as shown in the figures, in addition to the foregoing embodiments, in an embodiment of the present disclosure, a difference from the foregoing embodiments is that the abutment portion 12 is located in a lateral position of the body portion 11, so that the abutment portion 12 is located in the lateral position of the object 10.

In addition to the foregoing embodiments, in an embodiment of the present disclosure, a difference from the foregoing embodiments is that the abutment structure 1 and the pushed object 30 are combined into a module. The abutment structure 1 or the module may be a handle, a track, a slider, a moving object, a rod member, a rotating member, a heat sink, a rotator, a chip, a track member, a column member, a fastening member, a handle member, a flow channel, a flow baffle member, a flow spoiler, a heat sink, a support member, a bundle line member, a bundle tube member, an optical fiber bundle member, a wire member, a tube member, an optical fiber member, an elastic member, a housing, a printed circuit board, or a telescopic structure. In this way, the present disclosure can better meet requirements for practical application.

In addition to the foregoing embodiments, in an embodiment of the present disclosure, a difference from the foregoing embodiments is that the pushed object 30 is provided with at least one entry portion 301. The entry portion 301 is in communication with a channel 302. The entry portion 301 is configured to lift the abutment portion 12. In this embodiment, the entry portion 301 is provided with an inclined surface 303 (or a slope surface) configured to lift the abutment portion 12. The entry portion 301 is configured to enable the abutment portion 12 to elastically abut against or be elastically snap-fitted to the entry portion 301. In this way, the purpose of smoother movement and abutment and limitation may be achieved through the abutment structure 1.

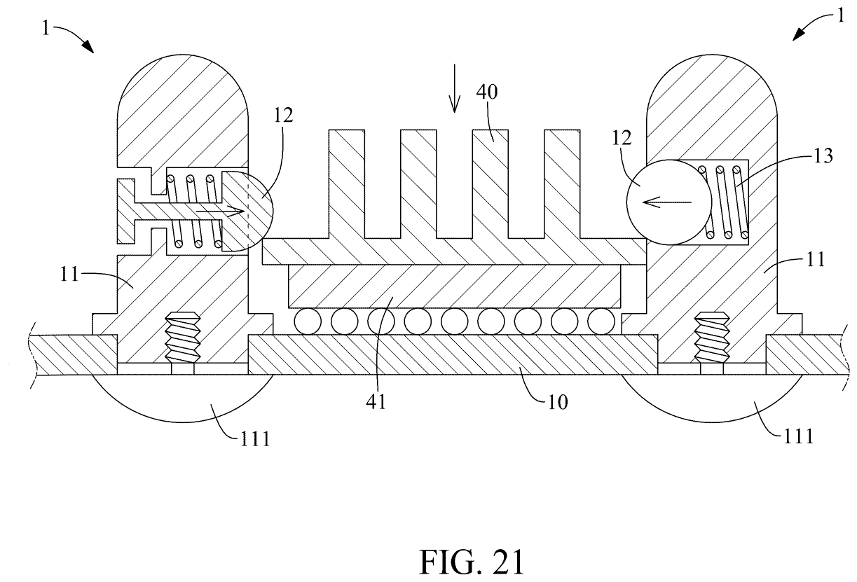

Referring to FIG. 21, as shown in the figure, in addition to the foregoing embodiment, in an embodiment of the present disclosure, a difference from the foregoing embodiment is that the abutment portion 12 is configured to abut against a heat sink 40, so that the heat sink 40 applies pressure to a heating member 41 through an abutment force of the abutment portion 12, to enable the heat sink 40 to dissipate heat of the heating member 41. In this way, the present disclosure can better meet requirements for practical application.

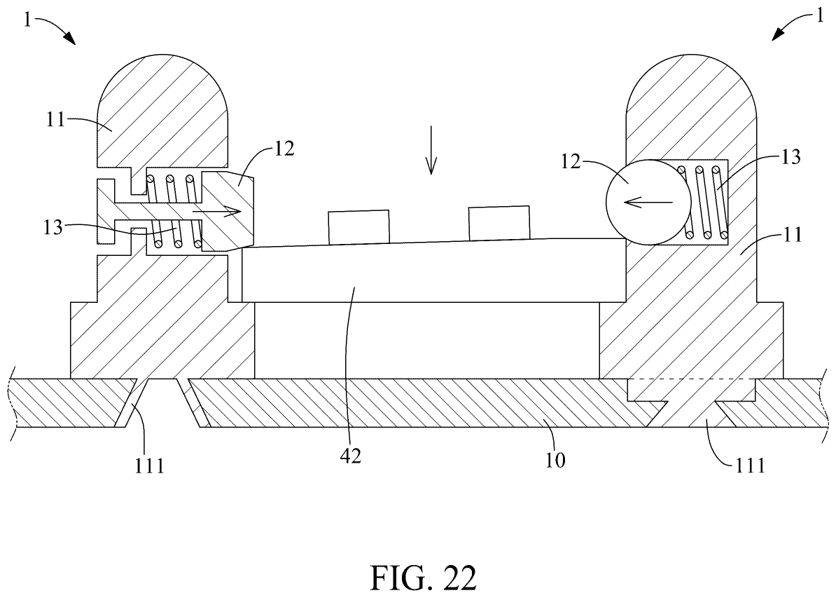

Referring to FIG. 22, as shown in the figure, in addition to the foregoing embodiment, in an embodiment of the present disclosure, a difference from the foregoing embodiment is that the abutment portion 12 is configured to apply pressure and abut against a printed circuit board 42 (or the object 10) through the abutment force. A thickness of the printed circuit board 42 (or the object 10) may be consistent or inconsistent. In this way, the present disclosure can better meet requirements for practical application.

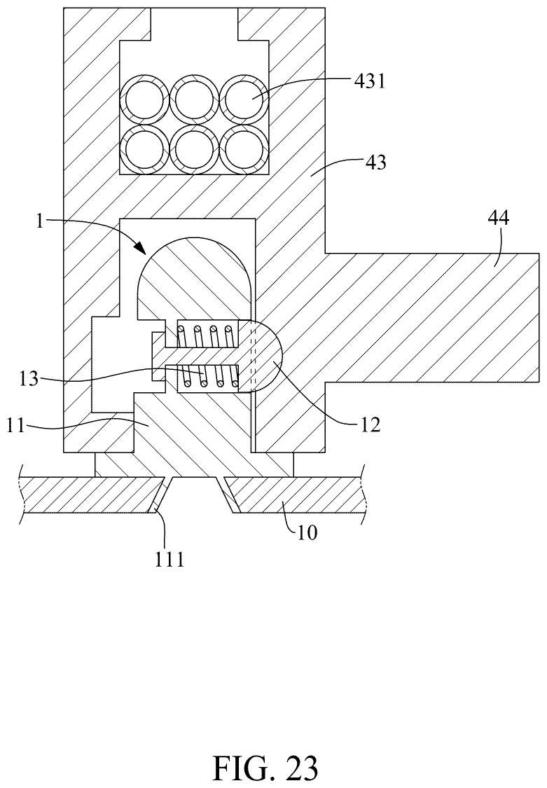

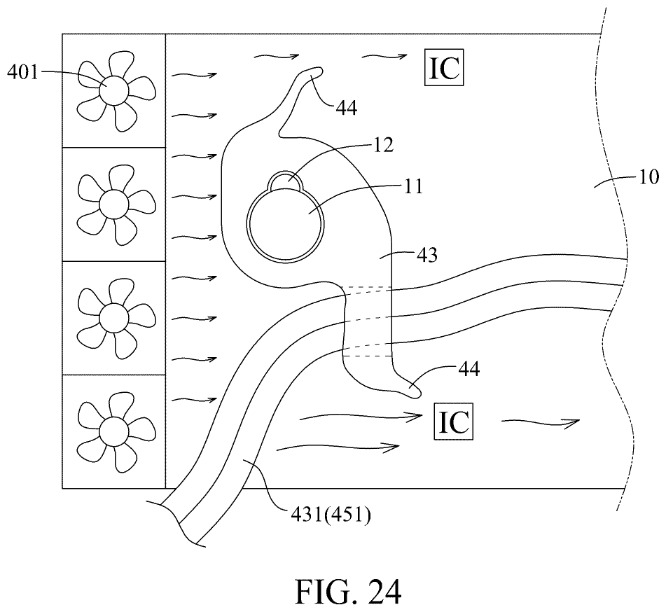

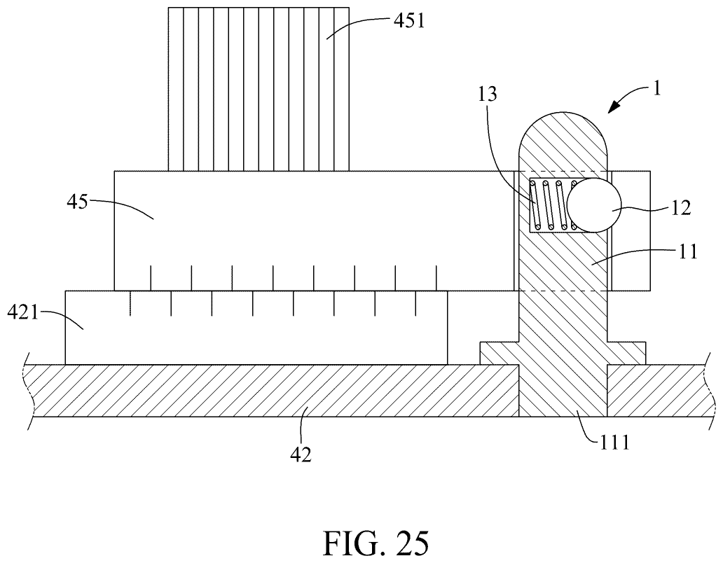

Referring to FIG. 23 to FIG. 25, as shown in the figures, in addition to the foregoing embodiments, in an embodiment of the present disclosure, a difference from the foregoing embodiments is that the abutment portion 12 is configured to be snap-fitted to a receiving member 43 and a flow baffle member 44 (or snap-fitted to a flow guide member or a flow spoiler). The receiving member 43 is configured to fix a required tube 431, a flat cable, a connector, or a wire, and the flow baffle member 44 may be configured to guide or block a fluid. In addition, the abutment portion 12 may be further configured to be snap-fitted to a spacer or a driving member, so that the spacer is configured to separate the fluid, and the driving member is configured to drive the fluid. The fluid is a gas, a liquid, oil, or a current (as shown in FIG. 23 and FIG. 24). For example, the fluid may be a gas generated by a fan 401 (as shown in FIG. 24). In addition, the abutment portion 12 may also be configured to be snap-fitted to the heat sink 40 and the heating member 41, so that the abutment structure 1, the heat sink 40, or the heating member 41 guides a heat source to a fluid, an object, a metal object, or a non-metal object. In this way, the present disclosure can better meet requirements for practical application.

In addition to the foregoing embodiment, in an embodiment of the present disclosure, a difference from the foregoing embodiments is that the receiving member 43 may be a fixing bracket, a flow baffle member, a heat sink, a heating member, a flow guide member, a flow spoiler, a connector, a spacer, or a driving member, so that the receiving member 43 may fix the tube, the flat cable, the connector, or the wire, or the receiving member 43 is configured to guide the fluid, block the fluid, separate the fluid, or drive the fluid. Alternatively, the abutment structure 1 mates with the receiving member 43 to guide the heat source to a fluid, an object, a metal object, or a non-metal object. In this way, the present disclosure can better meet the requirements for practical application.

In addition to the foregoing embodiments, in an embodiment of the present disclosure, a difference from the foregoing embodiments is that the abutment portion 12 is configured to be snap-fitted to a connector 45 having a flat cable 451. The connector 45 is connected to a connector 421 arranged on the printed circuit board 42 (as shown in FIG. 24). In this way, the present disclosure can better meet the requirements for practical application.

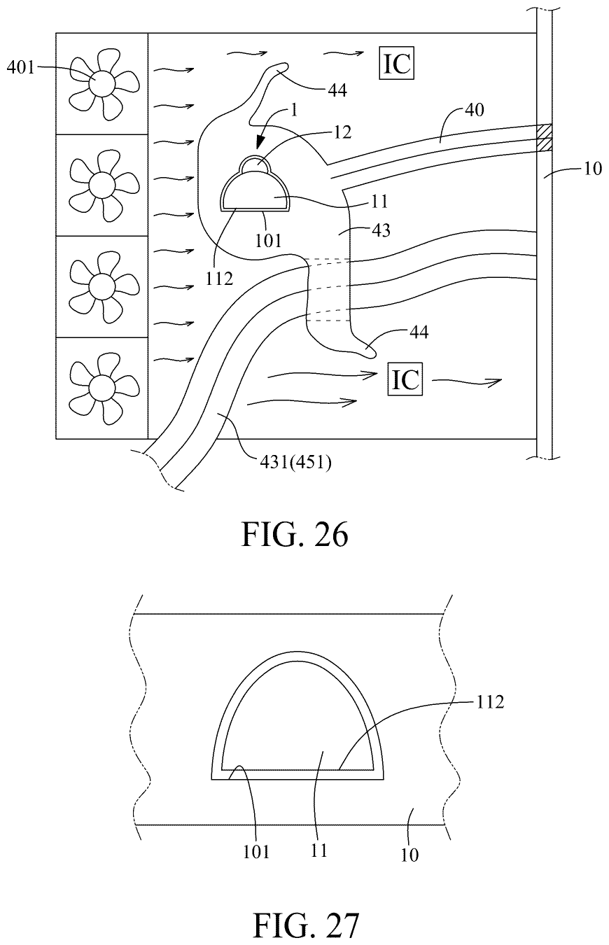

Referring to FIG. 26 and FIG. 27, as shown in the figures, in addition to the foregoing embodiments, in an embodiment of the present disclosure, a difference from the foregoing embodiments is that the abutment structure 1 is provided with an anti-rotation portion 112. In this embodiment, the anti-rotation portion 112 may be arranged on the fitting portion 111 of the body portion 11. The anti-rotation portion 112 and the corresponding anti-rotation portion 101 of the object 10 mutually prevent rotation and limit each other and may limit the direction of the object 10. In this way, the present disclosure can better meet the requirements for practical application.

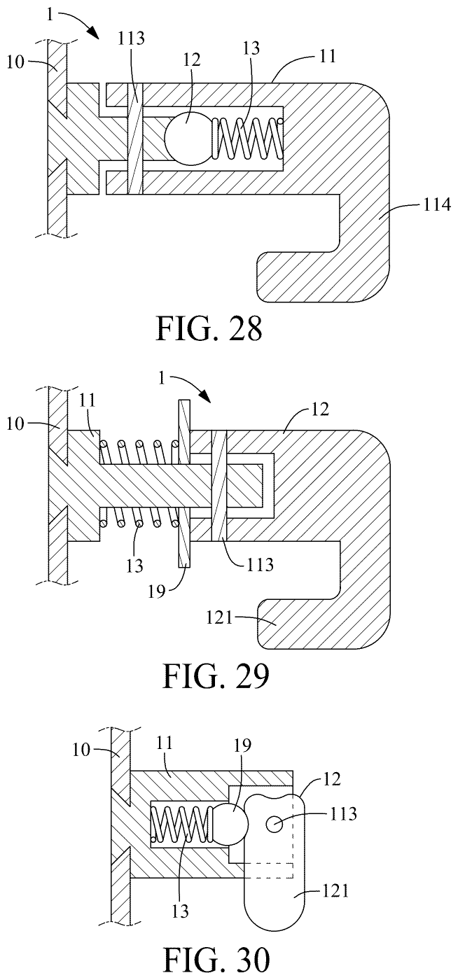

Referring to FIG. 28 to FIG. 31, as shown in the figures, in addition to the foregoing embodiments, in an embodiment of the present disclosure, a difference from the foregoing embodiments is that the body portion 11 and the abutment portion 12 are fixedly or movably fitted through a joining portion 113. For example, the joining portion 113 is bolted to the body potion 11 and the abutment portion 12, so that the body potion 11 and the abutment portion 12 are fixedly or movably fitted through bolting. In this way, the present disclosure can better meet the requirements for practical application.

In addition to the foregoing embodiments, in an embodiment of the present disclosure, a difference from the foregoing embodiments is that the body portion 11 is provided with a handle portion 114 (as shown in FIG. 28). The handle portion 114 is configured to apply force to the body portion 11. In this way, the present disclosure can better meet the requirements for practical application.

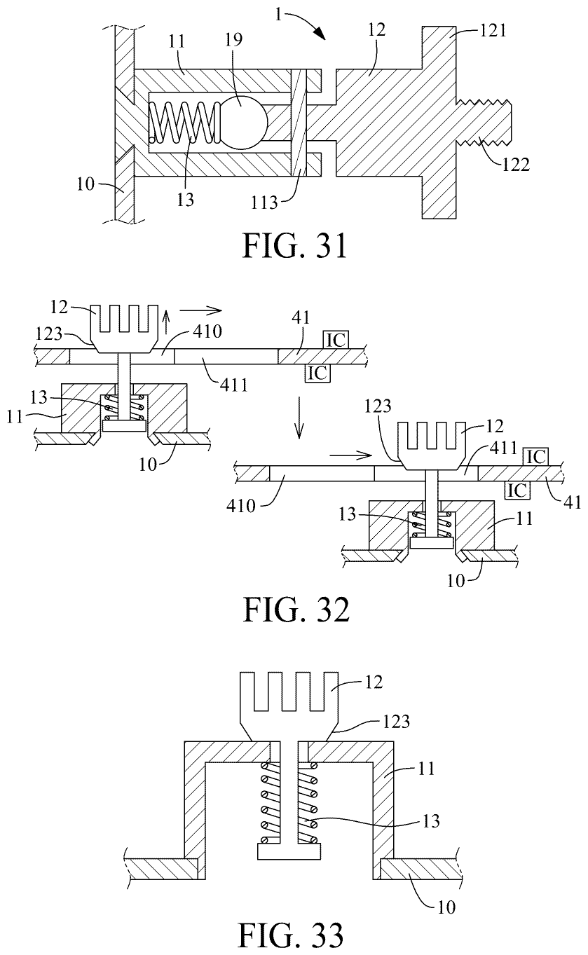

In addition to the foregoing embodiments, in an embodiment of the present disclosure, a difference from the foregoing embodiments is that the abutment portion 12 is provided with a handle portion 121 (as shown in FIG. 29 and FIG. 30). The handle portion 121 is configured to apply force to the abutment portion 12. In this way, the present disclosure can better meet the requirements for practical application.

In addition to the foregoing embodiments, in an embodiment of the present disclosure, a difference from the foregoing embodiments is that the abutment portion 12 (or the body portion 11) is provided with a handle portion 121 and a first fastening portion 122 (as shown in FIG. 31). The first fastening portion 122 is configured to apply force to the abutment portion 12, and the first fastening portion 122 is configured to perform a required snap-fit operation. In this way, the present disclosure can better meet the requirements for practical application.

In addition to the foregoing embodiments, in an embodiment of the present disclosure, a difference from the foregoing embodiments is that an intermediary member 19 is arranged between the body portion 11, the abutment portion 12, and the elastic element 13 (as shown in FIG. 29 to FIG. 31). The intermediary member 19 serves as an abutment or stop between the body portion 11, the abutment portion 12, and the elastic element 13. In this way, the present disclosure can better meet the requirements for practical application.

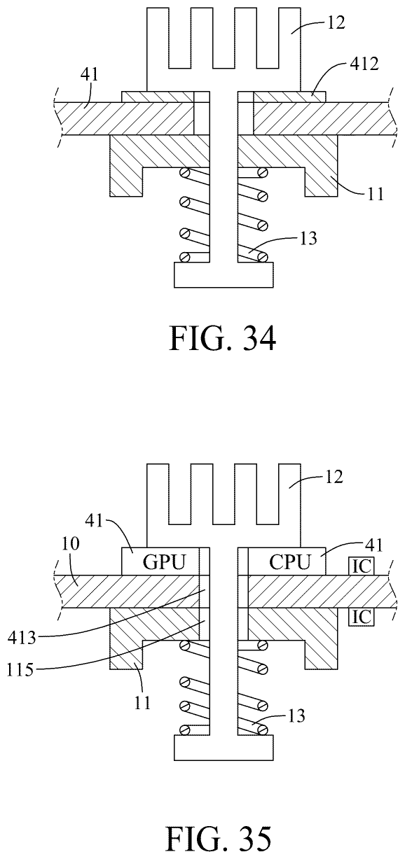

Referring to FIG. 32 to FIG. 35, as shown in the figures, in addition to the foregoing embodiments, in an embodiment of the present disclosure, a difference from the foregoing embodiments is that the abutment portion 12 may be arranged as a heat sink as needed, so that the abutment portion 12 applies pressure or applies pressure to a heating member 41 for heat dissipation through a snap-fit connection. Alternatively, the heating member 41 is a printed circuit board, an IC, a metal member, a non-metal member, or a chip, so as to provide the heating member 41 for heat dissipation through the abutment portion 12. In this way, the present disclosure can better meet the requirements for practical application.

In addition to the foregoing embodiments, in an embodiment of the present disclosure, a difference from the foregoing embodiments is that the abutment portion 12 enters through an entry portion 410 of the heating member 41, and then the abutment portion 12 enters a channel 411 (or a structure) of the heating member 41, to enable the abutment portion 12 to be snap-fitted to (or arranged on) the heating member 40, or enable the abutment portion 12 to be arranged between the heating member 40 and the body portion 11. In this way, the present disclosure can better meet the requirements for practical application.

In addition to the foregoing embodiments, in an embodiment of the present disclosure, a difference from the foregoing embodiments is that a bottom portion of the abutment portion 12 is provided with an inclined guide surface 123, so that the abutment portion 12 moves in the entry portion 410 and the channel 411 smoothly.

In addition to the foregoing embodiments, in an embodiment of the present disclosure, a difference from the foregoing embodiments is that a medium 412 is arranged between the abutment portion 12 and the heating member 41. The medium 412 is a heat dissipation medium, thermal grease, an elastic member, or a sheet member, so that the abutment portion 12 is firmly attached to the heating member 41 through the medium 412, to achieve a better heat dissipation effect.

In addition to the foregoing embodiment, in an embodiment of the present disclosure, a difference from the foregoing embodiments is that the body portion 11 and the heating member 41 each have a corresponding perforation 115 and 413, so that the abutment portion 12 movably extends through the perforations 115 and 413 and arranged between the heating member 40 and the body potion 11 (as shown in FIG. 35).

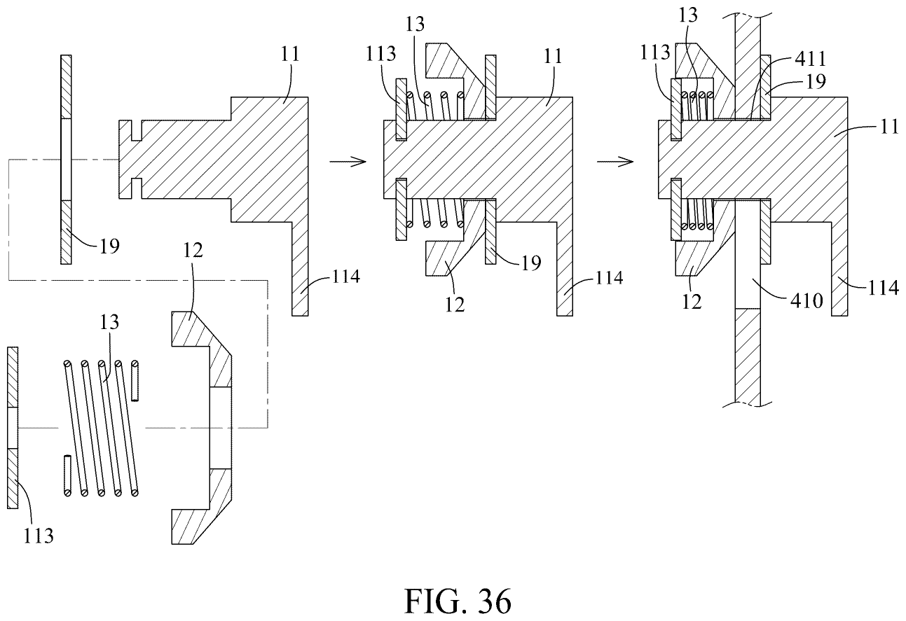

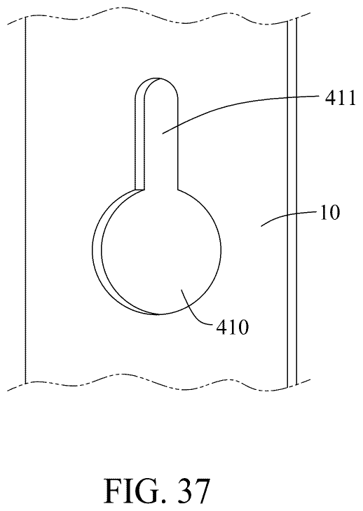

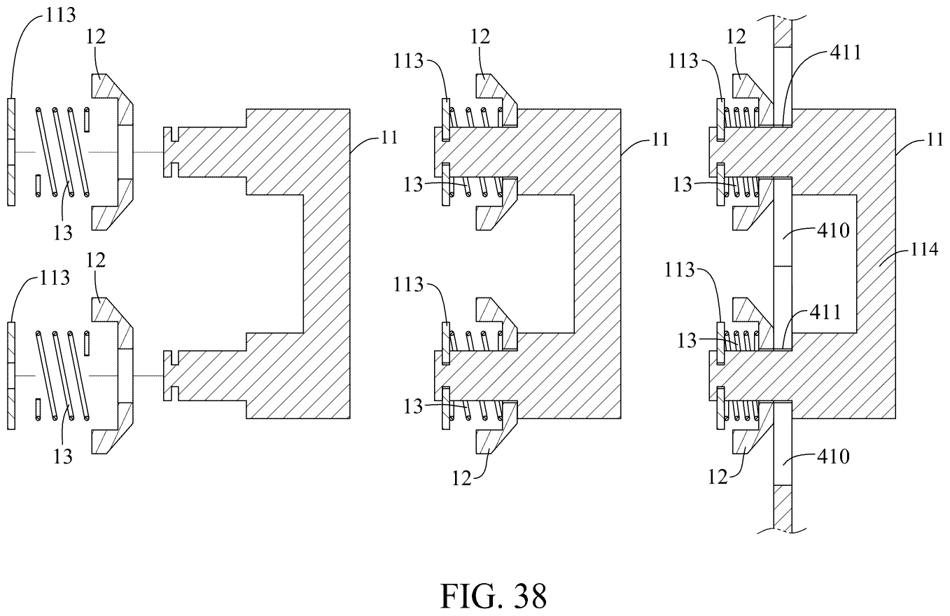

Referring to FIG. 36 to FIG. 38, as shown in the figures, in addition to the foregoing embodiments, in an embodiment of the present disclosure, a difference from the foregoing embodiments is that the body portion 11 is provided with a handle portion 114 (or the body portion 11 is a handle portion), so that the abutment portion 12 enters and is snap-fitted to the channel 411 through the entry portion 410 of the object 10, thereby performing the required snap-fit connection. In this way, the present disclosure can better meet the requirements for practical application.

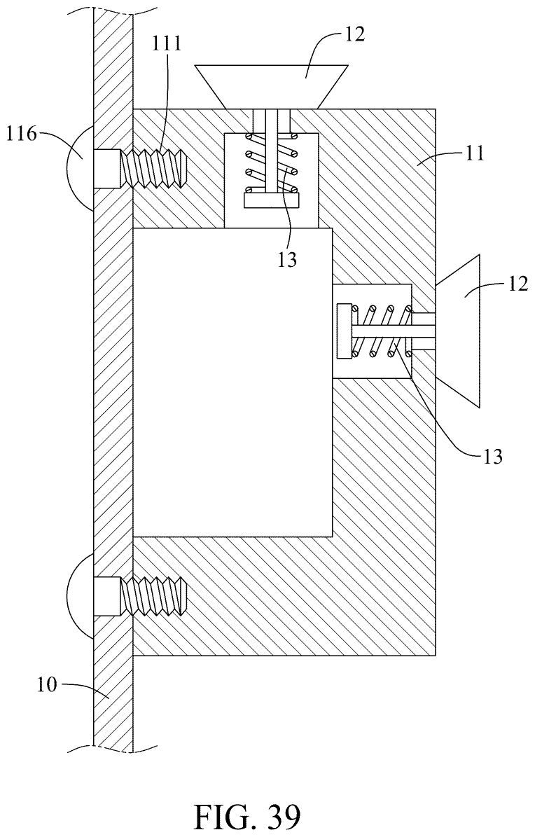

Referring to FIG. 39, as shown in the figure, in addition to the foregoing embodiments, in an embodiment of the present disclosure, a difference from the foregoing embodiments is that the body portion 11 is a handle portion, and the body portion 11 is provided with two abutment portions 12 that are adjacent to each other. An elastic element 13 is arranged between each of the abutment portions 12 and the body portion 11, and the body portion 11 is mounted to the object 10 through fitting portions 111 at two ends respectively mated with fixing elements 116. In this way, the present disclosure can better meet the requirements for practical application.

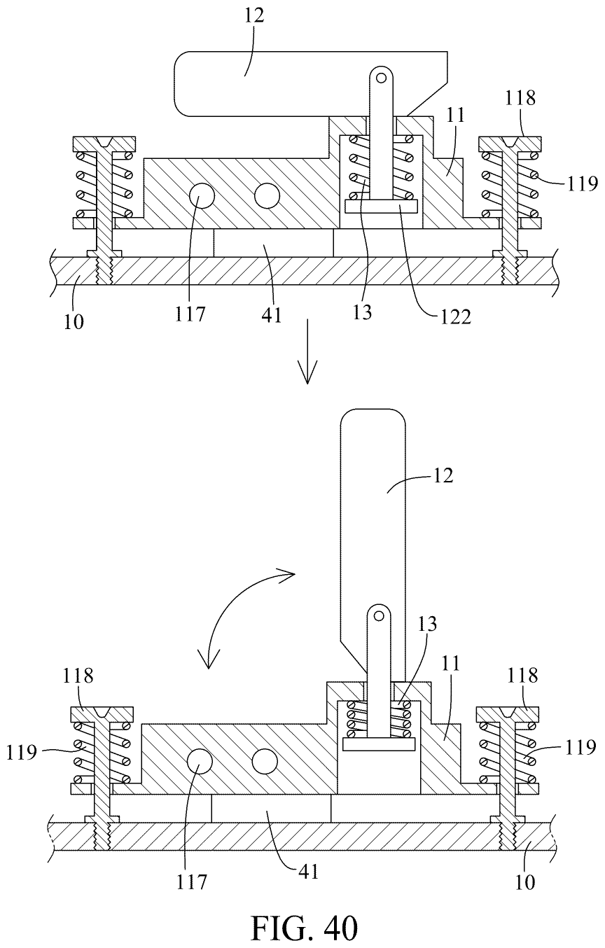

Referring to FIG. 40, as shown in the figure, in addition to the foregoing embodiments, in an embodiment of the present disclosure, a difference from the foregoing embodiments is that the body portion 11 may be a heat sink. The body portion 11 (the heat sink) is configured for heat dissipation by the heating member 41 arranged on the object 10. The body portion 11 is provided with a flow channel 117 for a fluid to pass through. The abutment portion 12 abuts against the body portion 11, and the body portion 11 is provided with a fastening member 118 snap-fitted to the object 10. The fastening member 118 has an elastic element 119 for applying elastic force to the body portion 11 to apply pressure to the heating member 41 for heat dissipation. The abutment portion 12 may be a handle (for example, a pull member) and is provided with a first fastening portion 122. The first fastening portion 122 is arranged on the body portion 11 to apply force to the abutment portion 12. The abutment portion 12 may be rotated to reduce a height.

During use, the body portion 11 may be arranged on the heating member 41, and the body portion 11 is fixedly snap-fitted to the object 10 through the fastening member 118. Then the abutment portion 12 may be pulled, so that the abutment portion 12 is rotated to reduce the height, and then the first fastening portion 122 drives the body portion 11 to abut against the heating member 41, so as to dissipate heat of the heating member 41 through the body portion 11 and the fluid in the flow channel 117 thereof.

In addition to the foregoing embodiments, in an embodiment of the present disclosure, a difference from the foregoing embodiments is that the object 10 may be a printed circuit board, a heat sink, or a metal member, and the heating member 41 may be a chip or a conductor. In this way, the present disclosure can better meet the requirements for practical application.

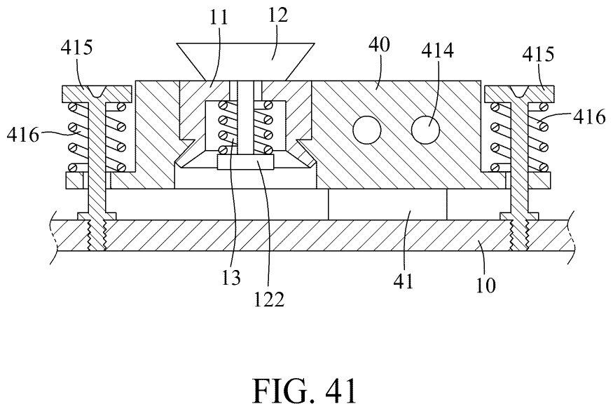

Referring to FIG. 41, as shown in the figure, in addition to the foregoing embodiments, in an embodiment of the present disclosure, a difference from the foregoing embodiments is that the body portion 11 of the abutment structure 1 is fitted to the heat sink 40. The heat sink 40 is configured for heat dissipation of the heating member 41. The heat sink 40 is provided with a flow channel 414 for a fluid to pass through. The abutment portion 12 is a handle and abuts against the heat sink 40, and the abutment portion 12 is provided with a first fastening portion 122. The first fastening portion 122 is arranged on the heat sink 40. The heating member 41 is arranged on the object 10, and the heating member 41 is provided with a fastening member 415 for being snap-fitted to the object 10. The fastening member 415 has an elastic element 416 for applying elastic force to the heat sink 40 to apply pressure to the heating member 41 for heat dissipation. The abutment portion 12 may be rotated to reduce the height, to drive the body portion 11 and the heat sink 40 through the first fastening portion 122, so that the heat sink 40 abuts against the heating member 41, so as to dissipate heat of the heating member 41 through the heat sink 40 and the fluid in the flow channel 414 thereof.

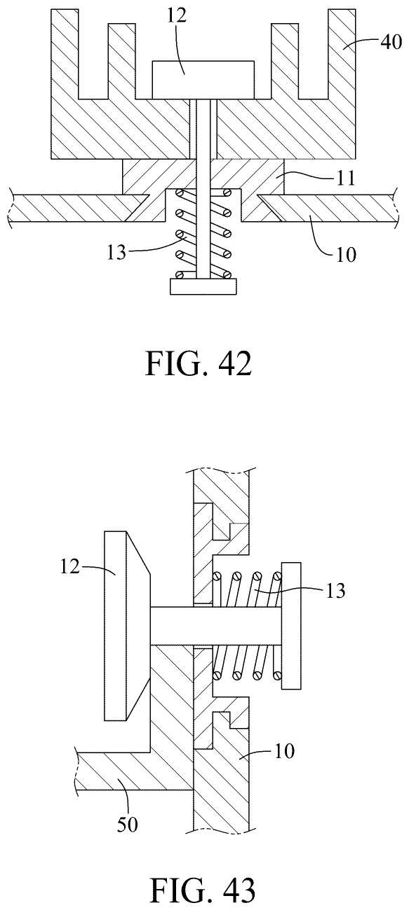

Referring to FIG. 42 and FIG. 43, as shown in the figures, in addition to the foregoing embodiments, in an embodiment of the present disclosure, a difference from the foregoing embodiments is that the abutment portion 12 is configured to be snap-fitted, fitted, clamped, slidably joined to or engaged with the heat sink 40. Alternatively, the abutment portion 12 is configured to be snap-fitted, fitted, clamped, slidably joined to or engaged with a track member 50. In this way, the present disclosure can better meet the requirements for practical application.

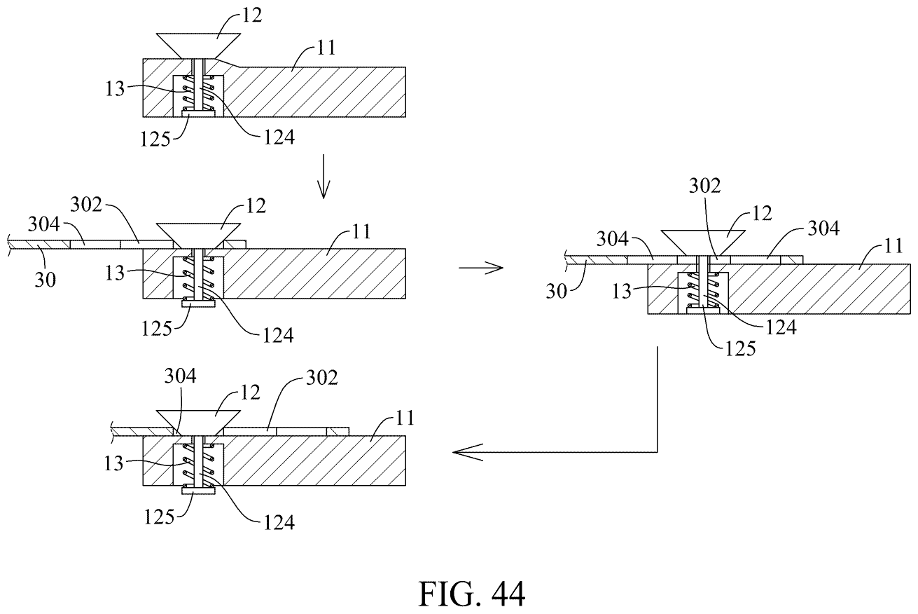

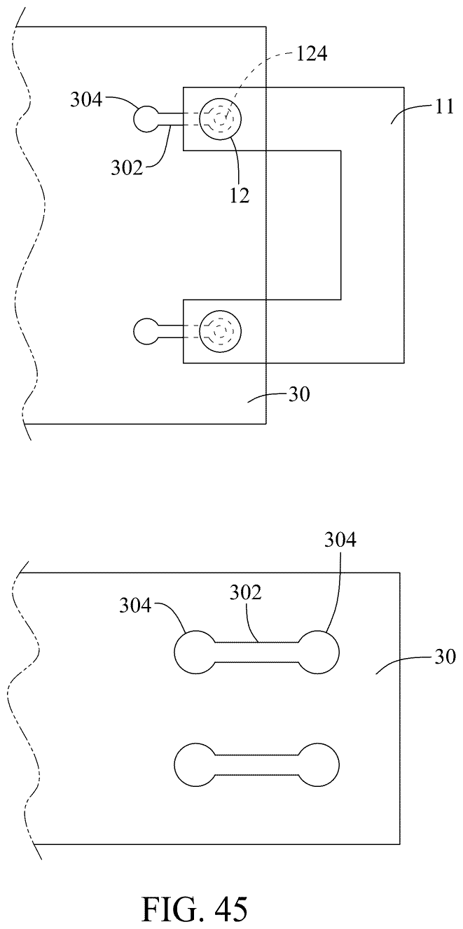

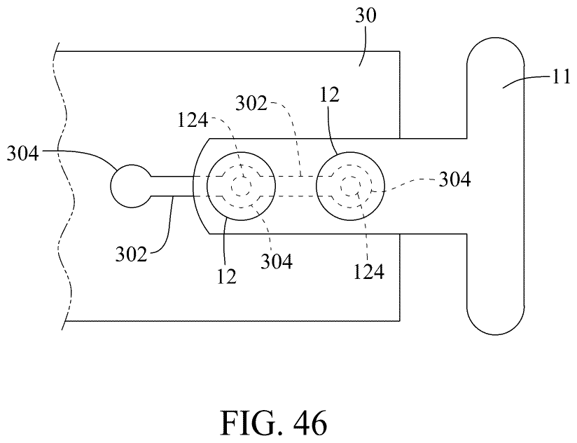

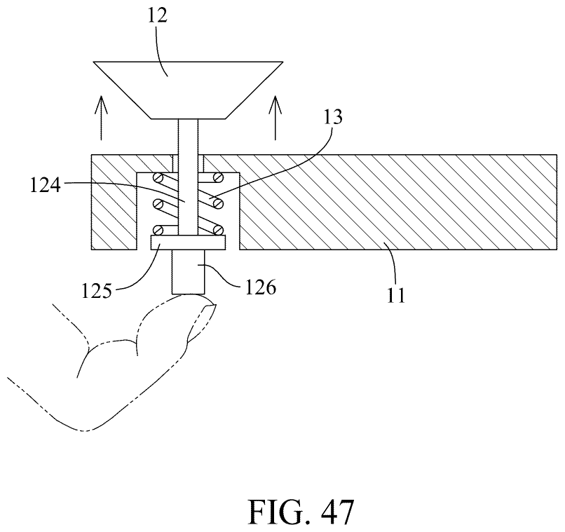

Referring to FIG. 44 to FIG. 47, as shown in the figures, in addition to the foregoing embodiments, in an embodiment of the present disclosure, a difference from the foregoing embodiments is that the abutment structure 1 has a pushed object 30. The pushed object 30 is provided with at least one entry portion 301. The entry portion 301 is configured to enable the abutment portion 12 to elastically abut against or be elastically snap-fitted to the entry portion 301. The entry portion 301 has a lifting portion 304, or the entry portion 301 has two lifting portions 304. The entry portion 301 is connected to a channel 302 for allowing the abutment portion 12 to move. The entry portion 301 is configured to lift the abutment portion 12. The entry portion 301 is an inclined surface, a slope surface, a step portion, a cross section, or an arc surface for lifting the abutment portion 12. In this way, the present disclosure can better meet the requirements for practical application.

In addition to the foregoing embodiments, in an embodiment of the present disclosure, a difference from the foregoing embodiments is that the abutment structure 1 may be a component or a module that is retractable, telescopic, movable, slidable, or laterally slidable on the pushed object 30. In this way, the present disclosure can better meet the requirements for practical application.

In addition to the foregoing embodiments, in an embodiment of the present disclosure, a difference from the foregoing embodiments is that the abutment structure 1 may be a handle that is retractable, telescopic, movable, slidable, or laterally slidable on the pushed object 30. In this way, the present disclosure can better meet the requirements for practical application.

In addition to the foregoing embodiments, in an embodiment of the present disclosure, a difference from the foregoing embodiments is that a width of the channel 302 is greater than that of a neck portion 124 of the abutment portion 12, or one end of the elastic element 13 abuts against the body portion 11, and an other end abuts against a resisting portion 125 of the abutment portion 12. In this way, the present disclosure can better meet the requirements for practical application.

In addition to the foregoing embodiments, in an embodiment of the present disclosure, a difference from the foregoing embodiments is that a width of the lifting portion 304 is less than that of the abutment portion 12. The abutment portion 12 has an operating portion 126 for operating the abutment portion 12 to move or be snap-fitted. In this way, the present disclosure can better meet the requirements for practical application.

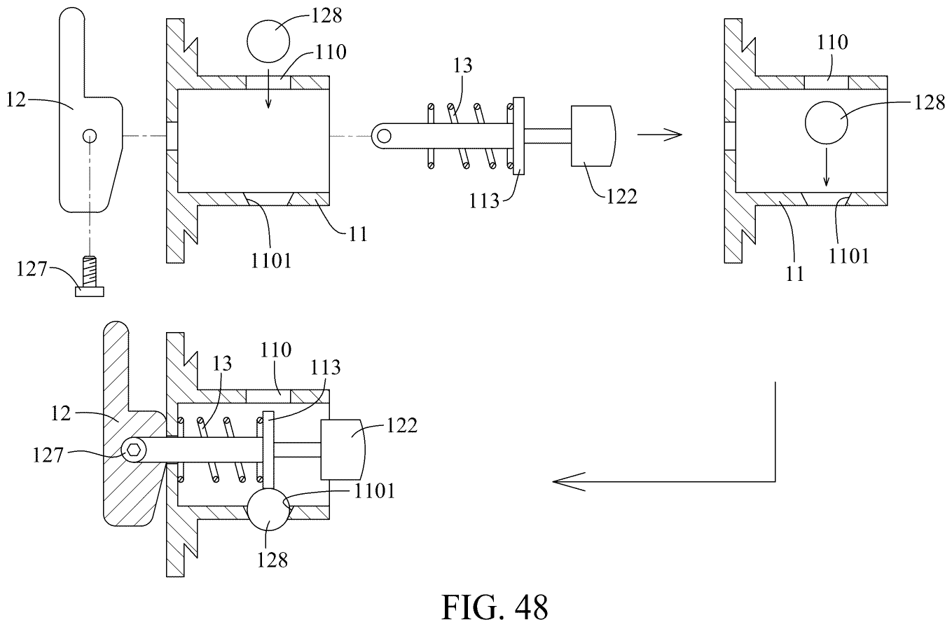

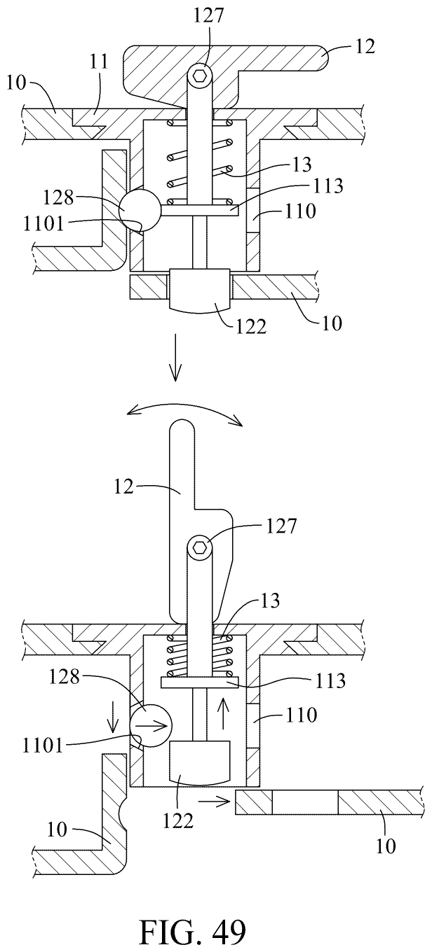

Referring to FIG. 48 and FIG. 49, as shown in the figures, in addition to the foregoing embodiments, in an embodiment of the present disclosure, a difference from the foregoing embodiments is that the present disclosure further includes a second fastening portion 128. The body portion 11 has an arrangement portion 110 configured to allow the second fastening portion 128 to reach an arrangement position 1101 to join the joining portion 113 to the body portion 11. In this way, the present disclosure can better meet the requirements for practical application.

In addition to the foregoing embodiments, in an embodiment of the present disclosure, a difference from the foregoing embodiments is that the abutment portion 12 is arranged on or extends through the body portion 11, or the abutment portion 12 is configured to control the second fastening portion 128. The joining portion 113 is a first fastening portion, or the joining portion 113 is the abutment portion configured to abut against the second fastening portion 128. The abutment portion 12 is configured to abut against the second fastening portion 125, or the abutment portion 12 is moved to control the movement or snap-fitting of the second fastening portion 128. In this way, the present disclosure can better meet the requirements for practical application.

In addition to the foregoing embodiments, in an embodiment of the present disclosure, a difference from the foregoing embodiments is that the joining portion 113 is joined to the abutment portion 12 through an other joining portion 127, so that the other joining portion 127 is moved to control the movement or snap-fitting of the second fastening portion 128, to allow the abutment portion 12 to drive the joining portion 127 into movement to control the movement or snap-fitting of the second fastening portion 128. The second fastening portion 128 may be a sphere, an inclined surface-equipped member, a one-way inclined surface-equipped member, a column member, or a fastening member. The arrangement portion 110 may be a perforation, a movement space, a groove portion, an inclined surface portion, a step portion, an arc surface portion, a right-angle portion, or a non-right angle portion. In this way, the present disclosure can better meet the requirements for practical application.

In addition to the foregoing embodiments, in an embodiment of the present disclosure, a difference from the foregoing embodiments is that the joining portion 113 may be joined to the body portion 11. The joining portion 113 is joined to the abutment portion 12 through the other joining portion 127, so that the joining portion 113 is moved to control the movement or snap-fitting of the first fastening portion 122 (or the abutment portion 12 drives the movement of the joining portion 113 to control the movement or snap-fitting of the first fastening portion 122). The joining portion 113 is configured to first pass through the body portion 11 and then be joined to the abutment portion 12 through the other joining portion 127 (or the joining portion 113 is configured to first pass through the body portion 11 and the elastic element 13 and then be joined to the abutment portion 12 through the other joining portion 127). In this way, the present disclosure can better meet the requirements for practical application.

In addition to the foregoing embodiments, in an embodiment of the present disclosure, a difference from the foregoing embodiments is that the abutment portion 12 is fitted to the joining portion 113 (or the abutment portion is a joining portion), and the first fastening portion 122 reaches the arrangement position 1101 through free fall, or the first fastening portion 122 is assisted by a tool or a magnetic tool to reach the arrangement position 1101. In this way, the present disclosure can better meet the requirements for practical application.

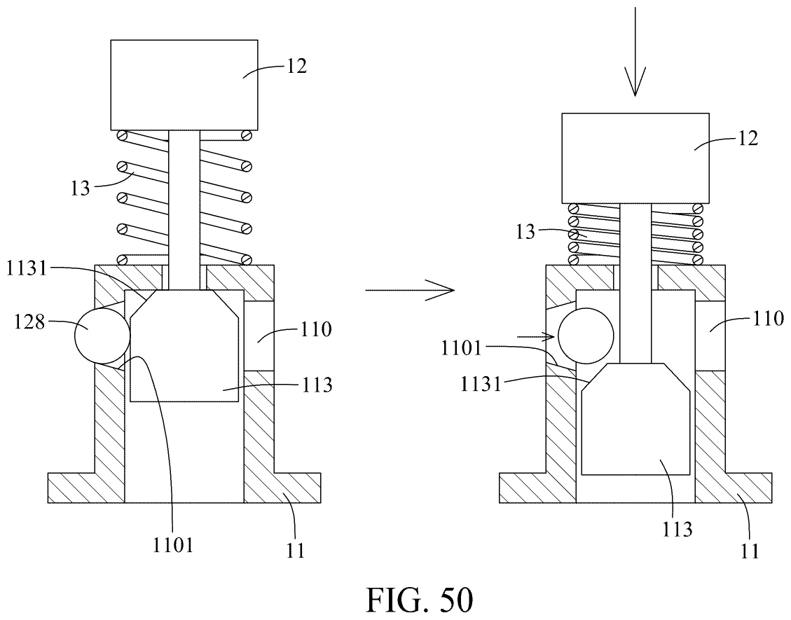

Referring to FIG. 50, as shown in the figure, in addition to the foregoing embodiments, in an embodiment of the present disclosure, a difference from the foregoing embodiments is that the joining portion 113 is a first fastening portion, and the abutment portion 12 and the joining portion 113 are integrally formed. The joining portion 113 abuts against the second fastening portion 128 through an inclined surface portion 1131. In this way, the abutment portion 12 may be moved, and the joining portion 113 controls the movement or snap-fitting of the second fastening portion 128, so that the present disclosure can better meet the requirements for practical application.

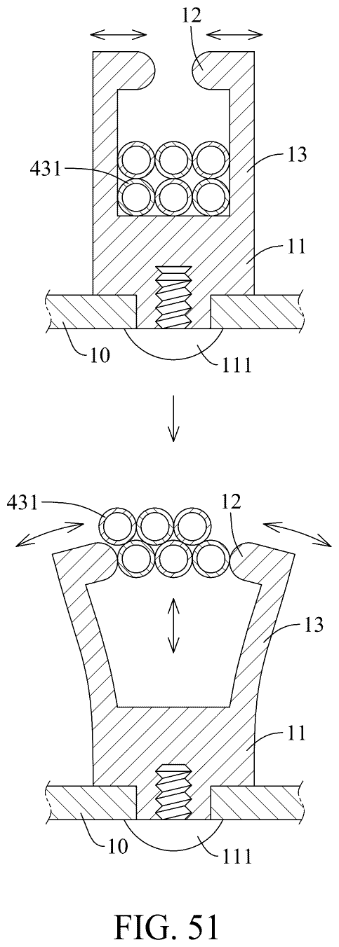

Referring to FIG. 51, as shown in the figure, in addition to the foregoing embodiments, in an embodiment of the present disclosure, a difference from the foregoing embodiments is that the body portion 11, the abutment portion 12, and the elastic element 13 are integrally formed (or the body portion 11 and the abutment portion 12 are integrally formed, or the body portion 11 and the elastic element 13 are integrally formed, or the abutment portion 12 and the elastic element 13 are integrally formed). The elastic element 13 is arranged between the body portion 11 and the abutment portion 12, and the body portion 11 is locked to the object 10 through the fitting portion 111. The abutment portion 12 is configured to mate with the elastic element 13 to snap-fit and fix a required tube 431 (for example, an optical fiber). In this way, the present disclosure can better meet the requirements for practical application.

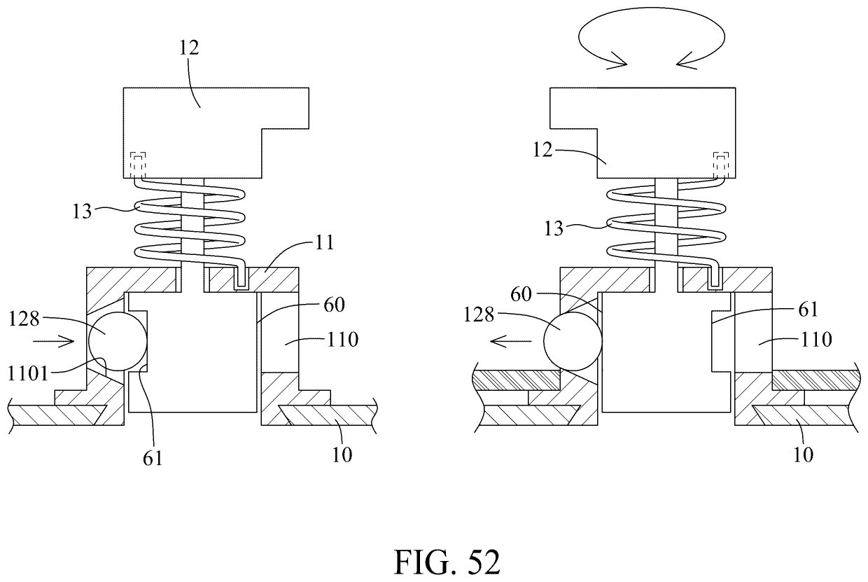

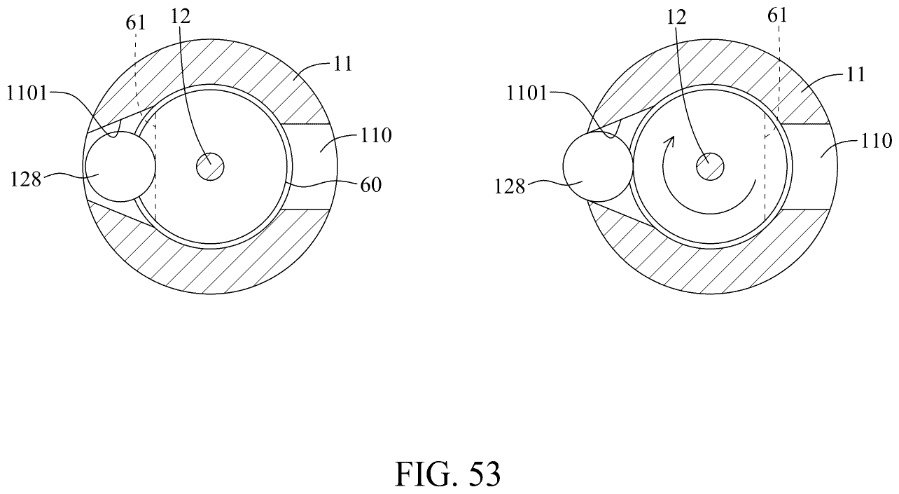

Referring to FIG. 52 and FIG. 53, as shown in the figures, in addition to the foregoing embodiments, in an embodiment of the present disclosure, a difference from the foregoing embodiments is that the present disclosure further includes a second fastening portion 128. The second fastening portion 128 may be a sphere, an inclined surface-equipped member, a one-way inclined surface-equipped member, a column member, or a fastening member. The abutment portion has a limiting portion and an open portion 61, and the limiting portion 60 and the open portion 61 may be respectively an arc surface, an inclined surface, a spherical surface, a groove, a hole, a plane, a concave portion, or a convex portion. The limiting portion 60 and the open portion 61 are configured to rotationally limit a limiting position of the second fastening portion 128, or configured to limit an open position of the second fastening portion 128. In this way, the second fastening portion 128 may be enabled to perform required position limitation or position release through cooperation between the limiting portion 60 and the open portion 61. In this way, the abutment portion 12 of the present disclosure can better meet the requirements for practical application.

In addition to the foregoing embodiments, in an embodiment of the present disclosure, a difference from the foregoing embodiments is that the elastic element 13 is a torsion spring (or a torsional elastic member). Two ends of the elastic element 13 are respectively limited to the body portion 11 and the abutment portion 12, so that the elastic element 13 is configured to drive the abutment portion 12 to be normally in a position where the second fastening portion 128 is limited, or enable the abutment portion 12 to be normally in a position where the second fastening portion 128 is opened. In this way, the present disclosure can better meet the requirements for practical application.

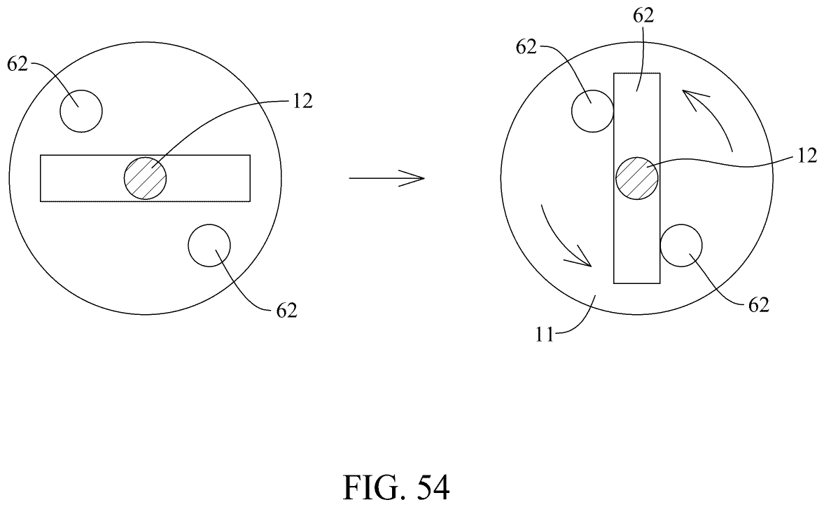

Referring to FIG. 54, as shown in the figure, in addition to the foregoing embodiments, in an embodiment of the present disclosure, a difference from the foregoing embodiments is that the body portion 11 and the abutment portion 12 may each have a limit portion 62. The limit portion 62 is configured to a rotation angle of the abutment portion 12. In this way, the present disclosure can better meet the requirements for practical application.

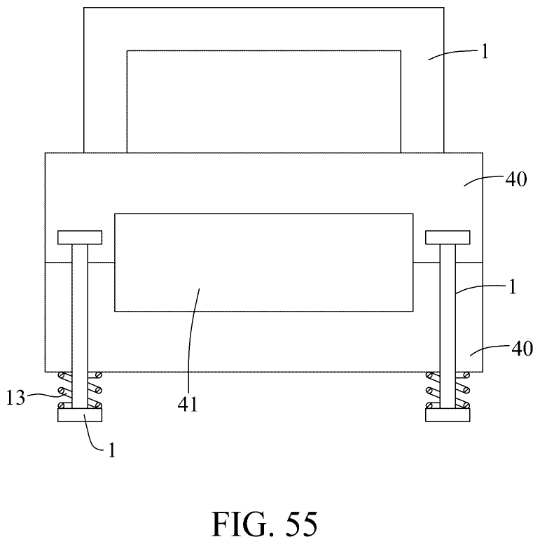

Referring to FIG. 55, as shown in the figure, in addition to the foregoing embodiments, in an embodiment of the present disclosure, a difference from the foregoing embodiments is that the abutment structure 1 may be arranged on a heat sink 40, to provide heat dissipation for a heating member 41 through the heat sink 40. In this embodiment, the heating member 41 is arranged between two heat sinks 40 for heat dissipation, and the heating member 41 is provided with upper and lower heat sinks 40 for heat dissipation. The abutment structure 1 is configured to fit the two heat sinks 40 (or the abutment structure 1 is configured to fit the heat sink 40 and an object 10). In this way, the present disclosure can better meet the requirements for practical application.

In addition to the foregoing embodiments, in an embodiment of the present disclosure, a difference from the foregoing embodiments is that the abutment structure 1 may be a fastening member or a handle, so that the abutment structure 1 is configure to lift or operate the heat sink 40. The heating member 41 may be a transistor, an energized member, a memory, a CPU, or a GPU. In this way, the present disclosure can better meet the requirements for practical application.

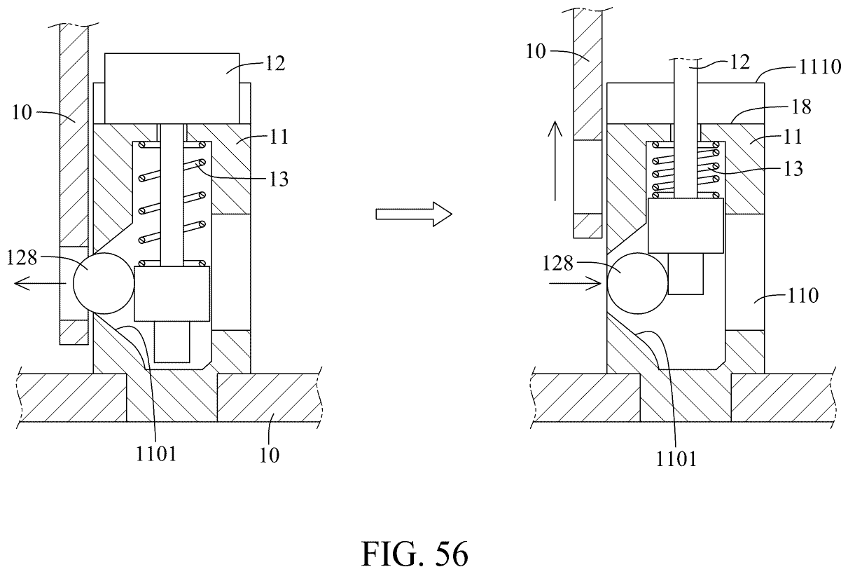

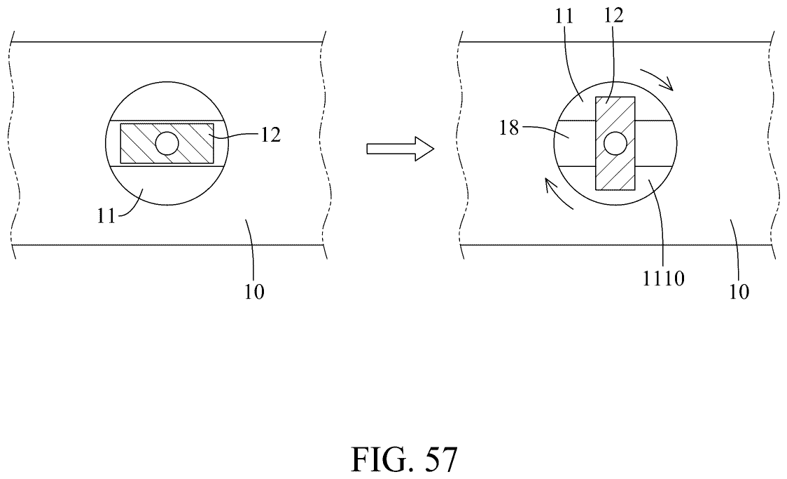

Referring to FIG. 56 and FIG. 57, as shown in the figures, in addition to the foregoing embodiments, in an embodiment of the present disclosure, a difference from the foregoing embodiments is that the present disclosure further includes a second fastening portion 128. The abutment portion 12 abuts against the second fastening portion 128. The body portion 11 has an arrangement portion 110, a limiting portion 18, and a lifting portion 1110. The limiting portion 18 limits the abutment portion 12. The abutment portion 12 moves longitudinally to enable the second fastening portion 128 to reach an arrangement position 1101 of the arrangement portion 110. The lifting portion 1110 is configured to abut against the abutment portion 12 that is rotated. In this way, the abutment portion 12 is moved to control the snap-fitting or tripping of the second fastening portion 128 and the object 10, so that the present disclosure can better meet the requirements for practical application.

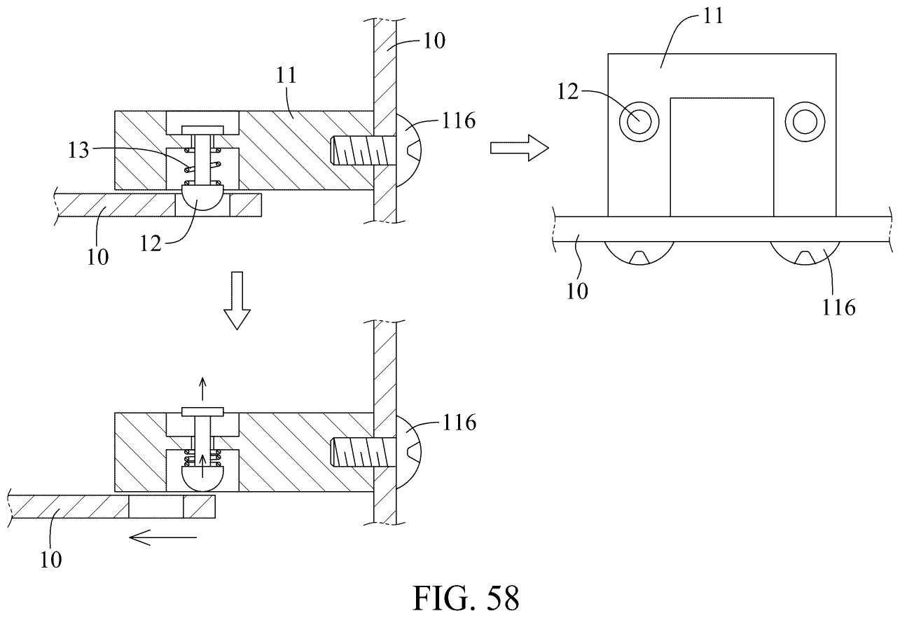

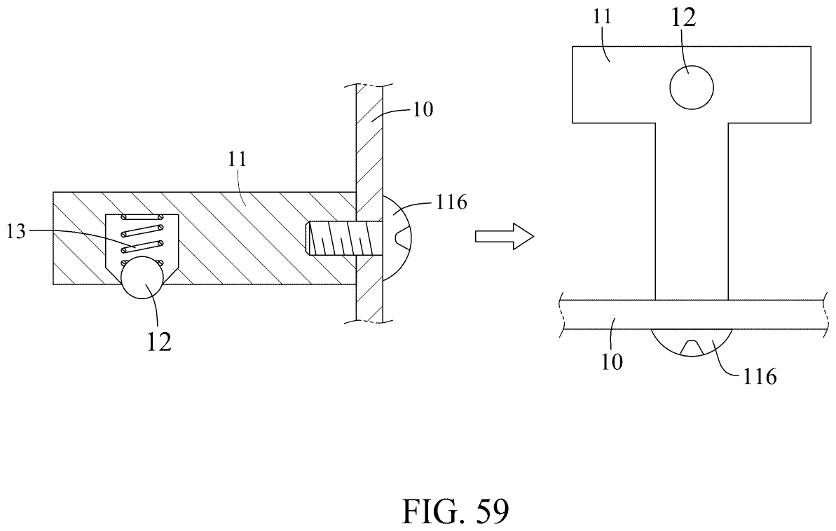

Referring to FIG. 58 and FIG. 59, as shown in the figures, in addition to the foregoing embodiments, in an embodiment of the present disclosure, a difference from the foregoing embodiments is that the body portion 11 is a handle, for example, a handle in the shape of a Chinese character “ [symbol] ” (as shown in FIG. 58) or a T-shaped handle (as shown in FIG. 59). The body portion 11 is mounted to the object 10 with fitting portions 111 at two ends respectively mated with fixing elements 116, and the body portion 11 is provided with two abutment portions 12 arranged adjacent to each other (as shown in FIG. 58) or the body portion 11 is provided with an abutment portion 12 (as shown in FIG. 59). In this way, the present disclosure can better meet the requirements for practical application.

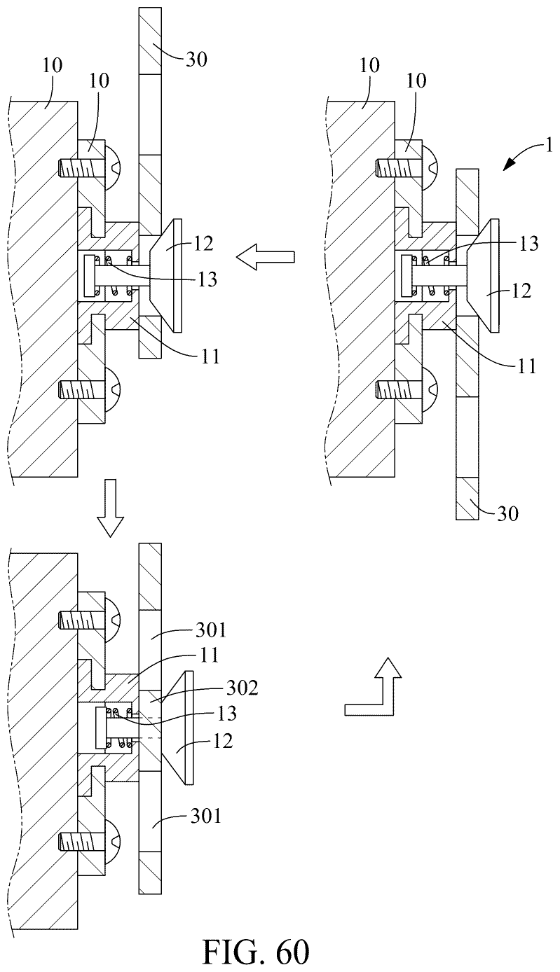

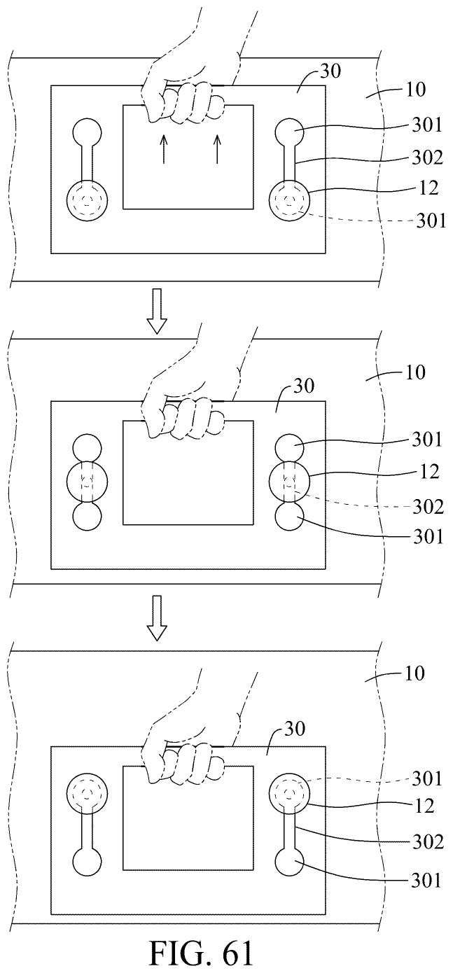

Referring to FIG. 60 and FIG. 61, as shown in the figures, in addition to the foregoing embodiments, in an embodiment of the present disclosure, a difference from the foregoing embodiments is that the abutment structure 1 has a pushed object 30. The pushed object 30 is a handle. The pushed object 30 is provided with at least one entry portion 301. The entry portion 301 is in communication with a channel 302. The entry portion 301 is configured to lift the abutment portion 12. The entry portion 301 is configured to enable the abutment portion 12 to elastically abut against or be elastically snap-fitted to the entry portion 301. In this way, the present disclosure can better meet the requirements for practical application.

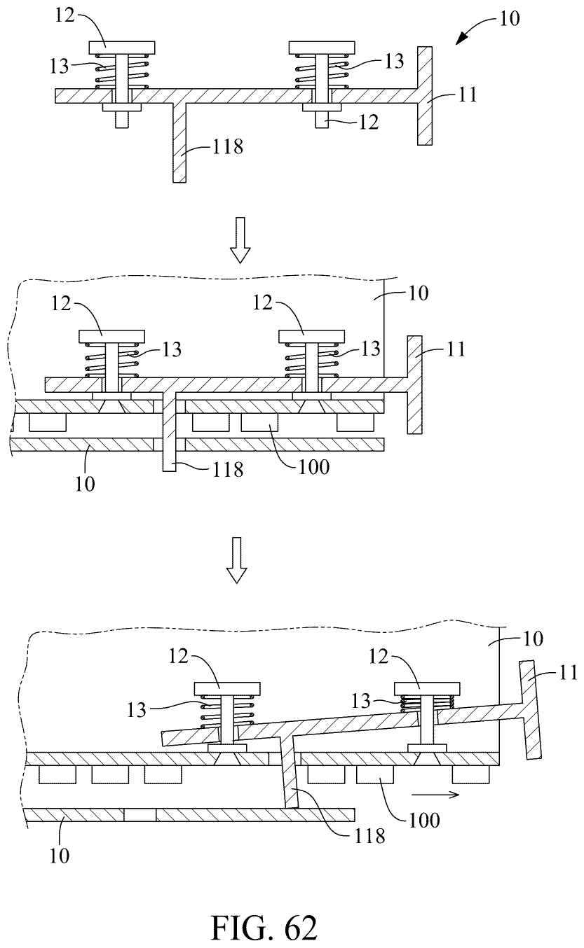

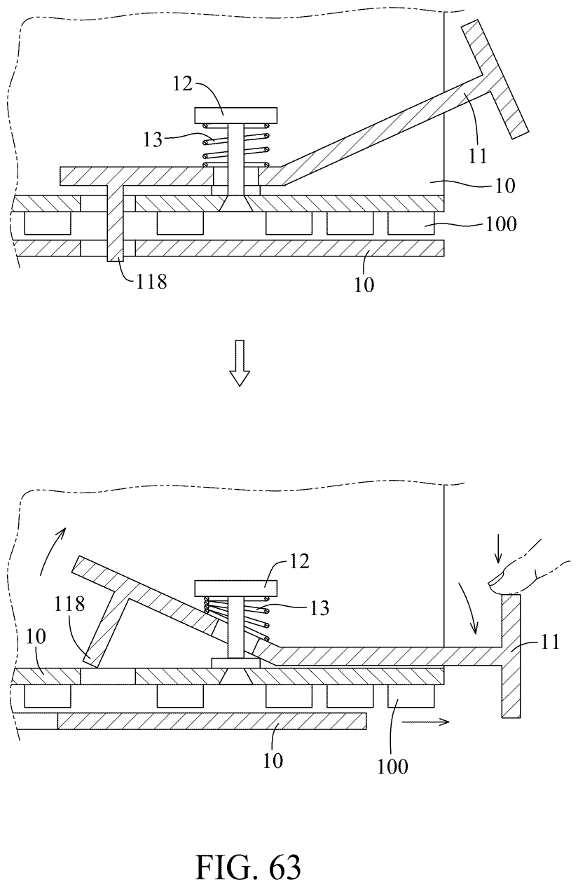

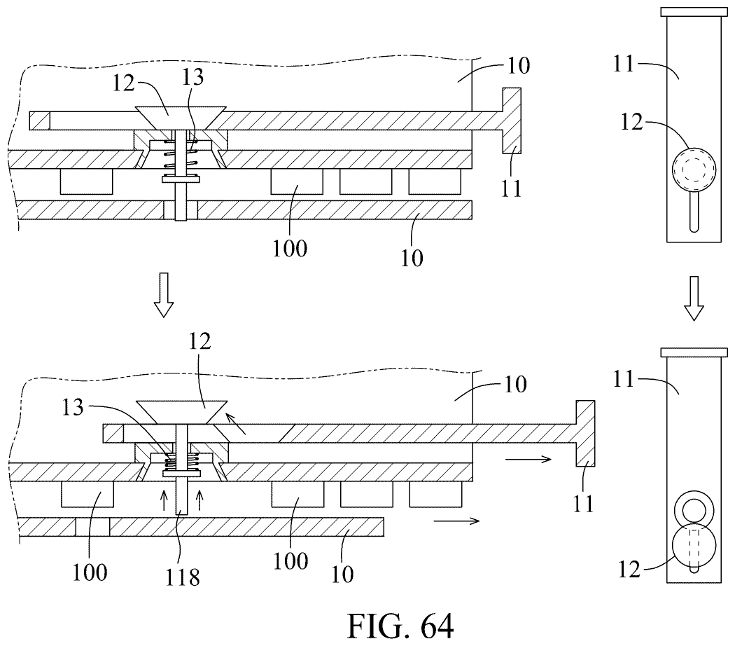

Referring to FIG. 62 to FIG. 64, as shown in the figures, in addition to the foregoing embodiments, in an embodiment of the present disclosure, a difference from the foregoing embodiments is that the abutment structure 1 or the body portion 11 is arranged on an object 10. The object 10 may be a casing or a cabinet with a wheel member 100 or a track. The body portion 11 is provided with a handle portion 114 or a fastening member 118, or the abutment portion 12 is provided with a first fastening portion 122. The handle portion 114 is configured to move the body portion 11 and mate with the abutment portion 12 to abut against the elastic element 13, to implement the snap-fitting and tripping of the fastening member 118 or the first fastening portion 122 and an object 10. In this way, the present disclosure can better meet the requirements for practical application.

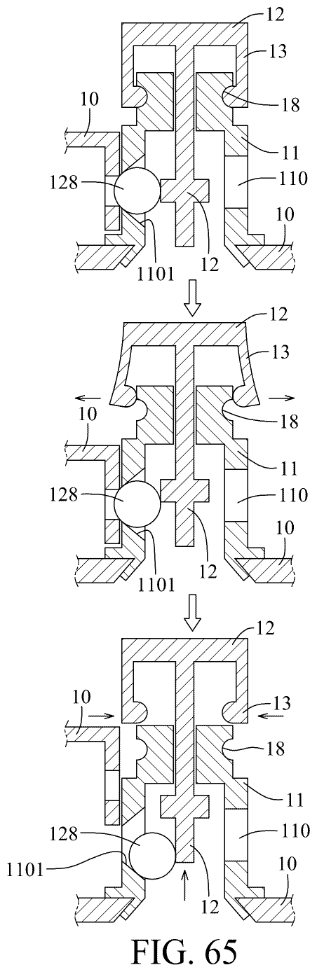

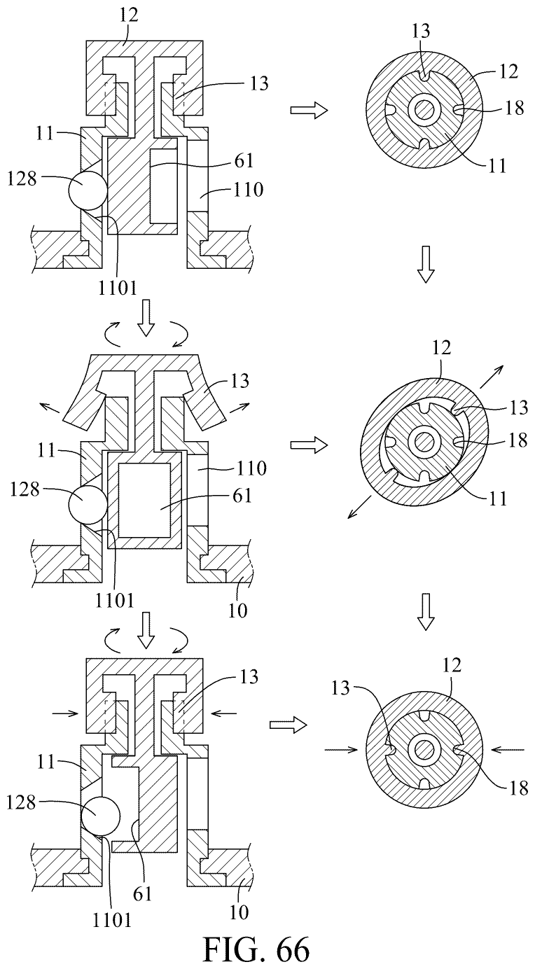

Referring to FIG. 65 and FIG. 66, as shown in the figures, in addition to the foregoing embodiments, in an embodiment of the present disclosure, a difference from the foregoing embodiments is that the present disclosure further includes a second fastening portion 128. The abutment portion 12 abuts against the second fastening portion 128. The body portion 11, the abutment portion 12, and the elastic element 13 are integrally formed. The body portion 11 is provided with an arrangement portion 110 and a limiting portion 18. The abutment portion 12 moves longitudinally or rotationally to enable the elastic element 13 to elastically limit or elastically disengage from the limiting portion 18 and enable the abutment portion 12 to drive the second fastening portion 128 to reach an arrangement position 1101 of the arrangement portion. The abutment portion 12 has an open portion 61. The open portion 61 is configured to rotationally limit a limiting position of the second fastening portion 128, or limit an open position of the second fastening portion 128, so that the second fastening portion 128 may be enabled to perform required position limitation or position release through cooperation of the open portion 61. In this way, the present disclosure can better meet the requirements for practical application.

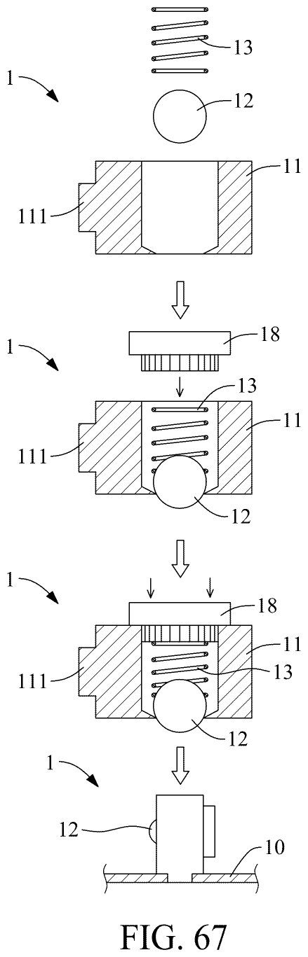

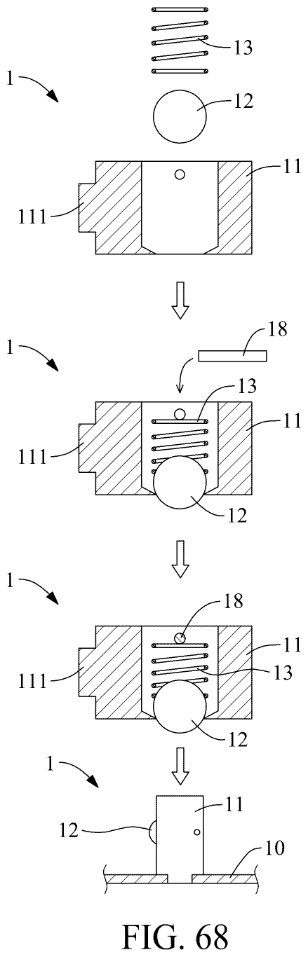

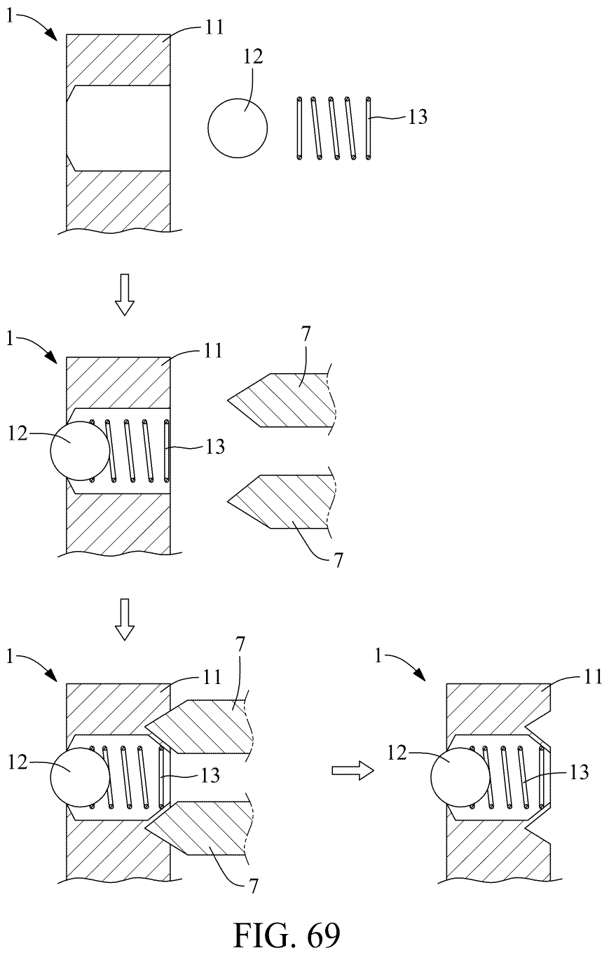

Referring to FIG. 67 to FIG. 69, as shown in the figures, in addition to the foregoing embodiments, in an embodiment of the present disclosure, a difference from the foregoing embodiments is that the body portion 11 is provided with a limiting portion 18. The limiting portion 18 is joined to the body portion 11 through a riveted connection (as shown in FIG. 67), a threaded connection (as shown in FIG. 68), a snap fit, a welded connection, a locked connection, hot melting, or stamping with a tool 7 (as shown in FIG. 69), to enable the limiting portion 18 to limit movable joining of the abutment portion 12 and the body portion 11. In this way, the abutment portion 12 may be movably limited and arranged on the body portion 11 to meet usage requirements of the abutment portion 12.

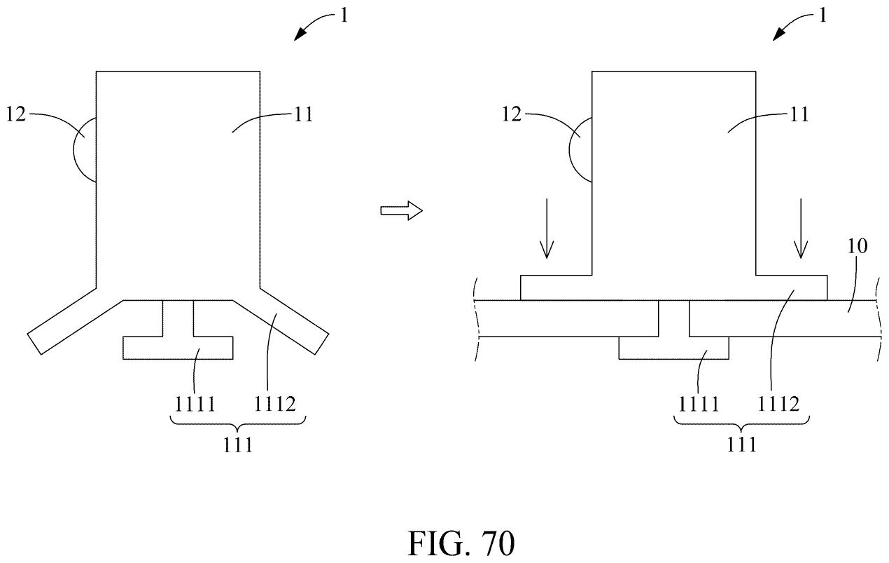

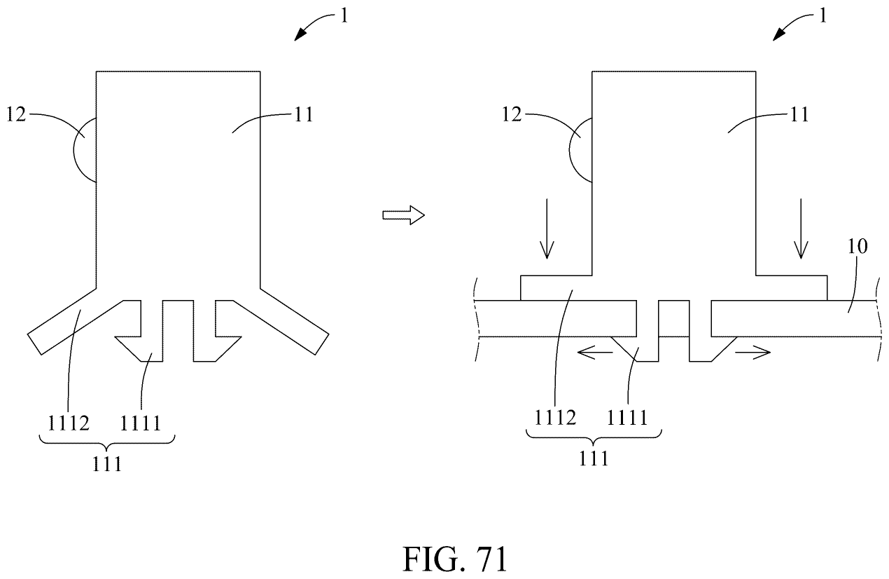

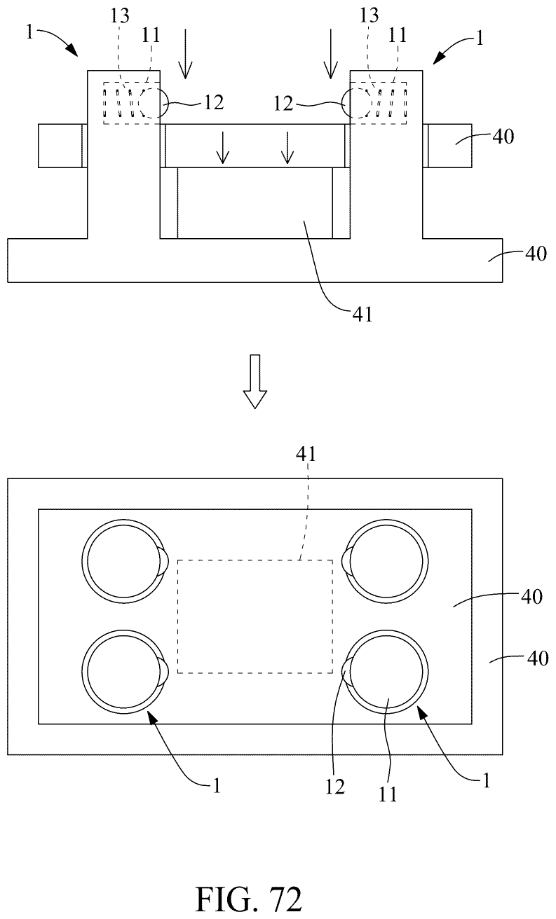

Referring to FIG. 70 and FIG. 71, as shown in the figures, in addition to the foregoing embodiments, in an embodiment of the present disclosure, a difference from the foregoing embodiments is that an end of the body portion 11 is provided with a fitting portion 111. The fitting portion 111 includes a snap-fit member 1111 or a snap member 1112. The body portion 11 is joined to the object 10 through the snap-fit member 1111 and the snap member 1112, and the snap-fit member 1111 may also be in the form of a snap. In this way, the present disclosure can better meet the requirements for practical application.

Referring to FIG. 72, as shown in the figure, in addition to the foregoing embodiments, in an embodiment of the present disclosure, a difference from the foregoing embodiments is that the abutment structure 1 is fitted to two heat sinks 40. A heating member 41 is arranged between the two heat sinks 40. The two heat sinks 40 are pressed against the heating member 41 through an abutment force of the abutment portion 12, so that the heat sinks 40 dissipate heat of the heating member 41. In this way, the present disclosure can better meet the requirements for practical application.

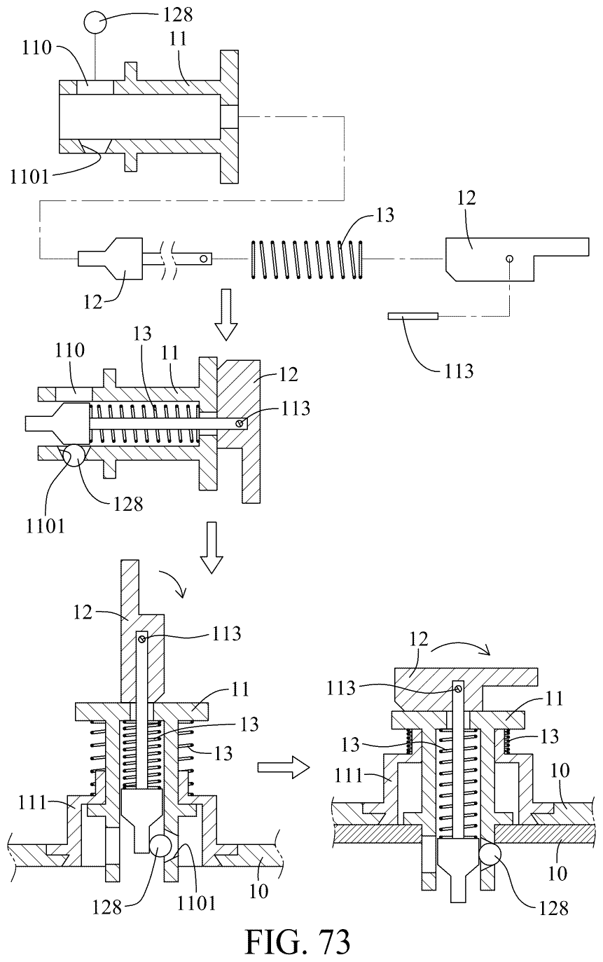

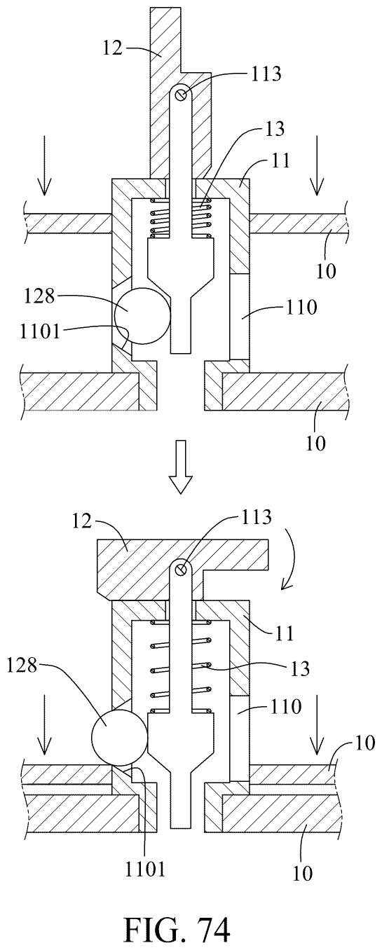

Referring to FIG. 73 and FIG. 74, as shown in the figures, in addition to the foregoing embodiments, in an embodiment of the present disclosure, a difference from the foregoing embodiments is that the present disclosure further includes a first fastening portion 122 and a second fastening portion 128. The body portion 11 has an arrangement portion 110 configured to allow the second fastening portion 128 to reach an arrangement position 1101. The abutment portion 12 is joined to the first fastening portion 122 through a joining portion 113, so that the abutment portion 12 is moved to control movement or snap-fitting of the second fastening portion 128.

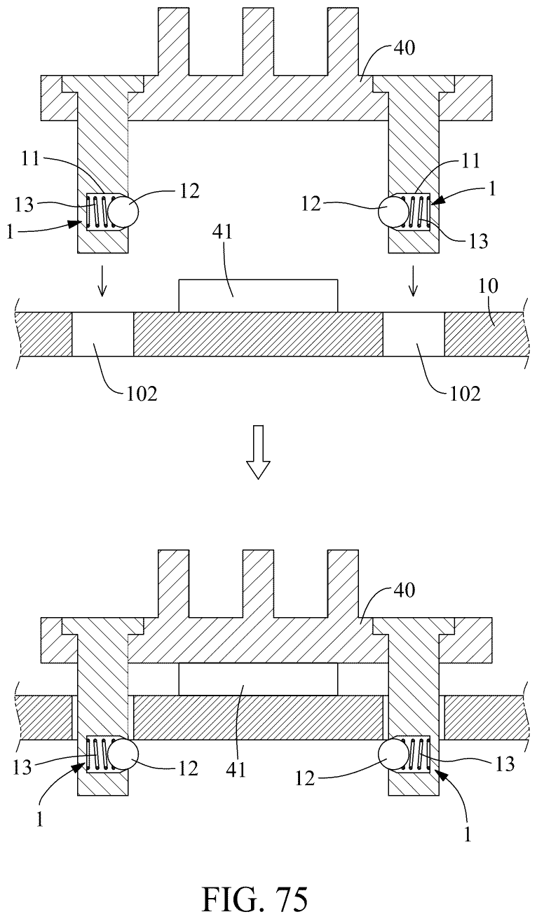

Referring to FIG. 75, as shown in the figure, in addition to the foregoing embodiments, in an embodiment of the present disclosure, a difference from the foregoing embodiments is that the abutment structure 1 is arranged or integrally formed on a heat sink 40. The abutment portion 12 is snap-fitted to or arranged on a snap-fit portion 102 of the object 10 (a circuit board or an other heat sink), so that the heat sink 40 is configured to provide heat dissipation for the heating member 41.

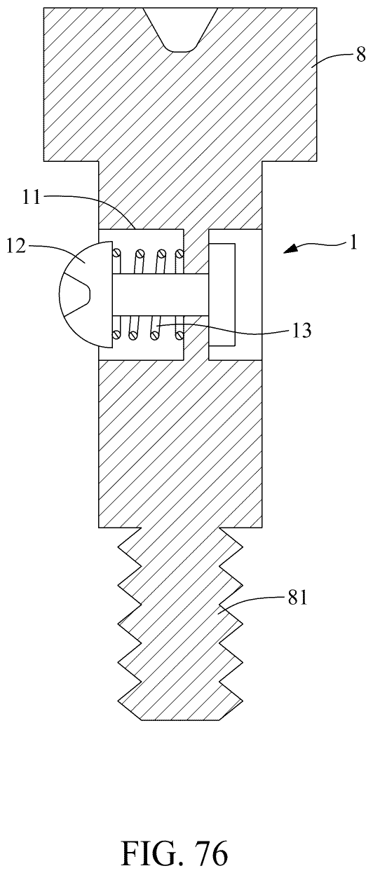

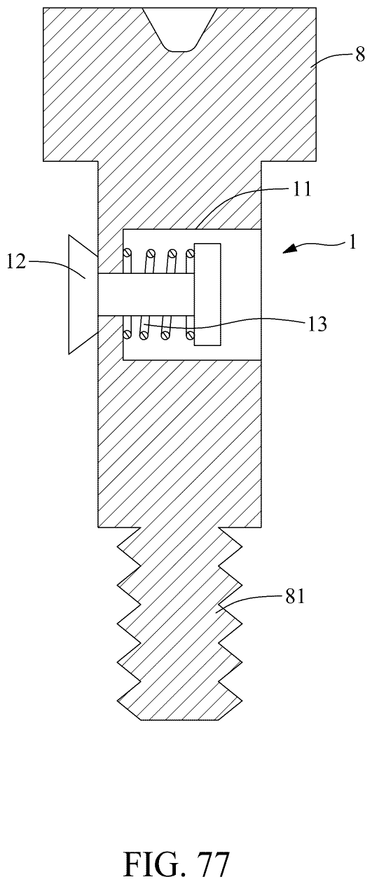

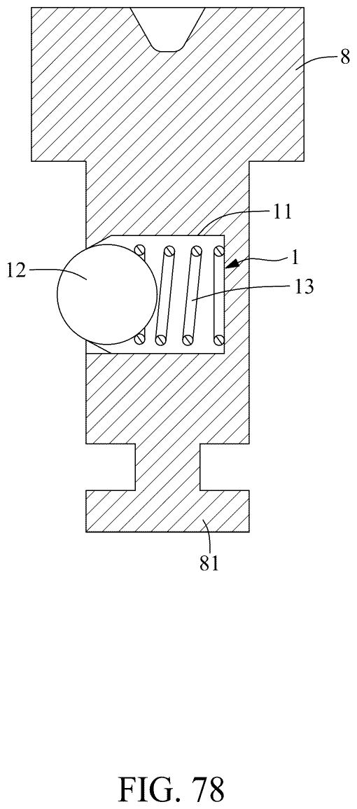

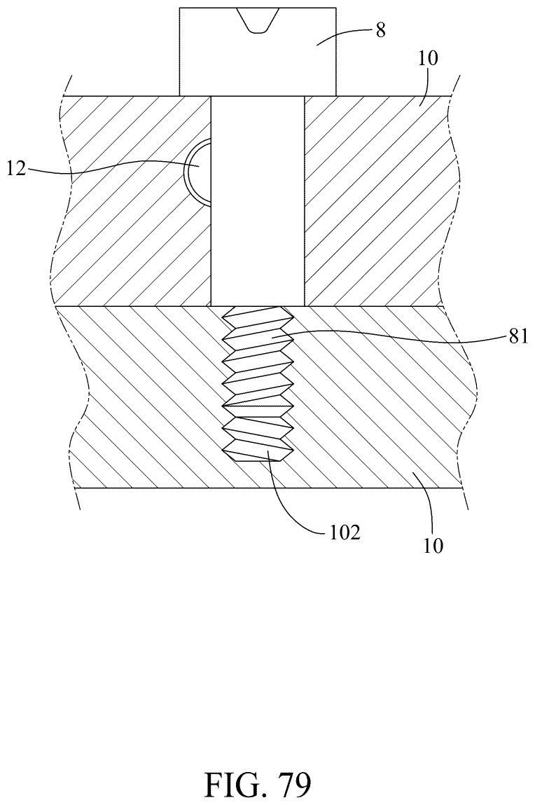

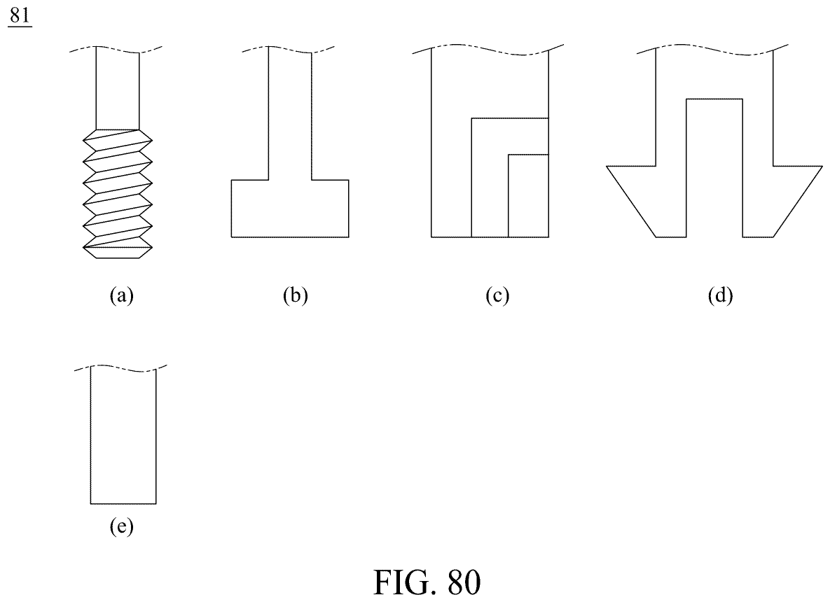

Referring to FIG. 76 to FIG. 80, as shown in the figures, in addition to the foregoing embodiments, in an embodiment of the present disclosure, a difference from the foregoing embodiments is that the abutment portion 12 is arranged on a fastener 8. The abutment portion 12 is configured to be snap-fitted to an object 10, enable a fastening portion 81 of the fastener 8 to be snap-fitted to or limited to a snap-fit portion 102 of the object 10, and prevent the fastener 8 from being detached from the object 10. In this way, the present disclosure can better meet the requirements for practical application.

In addition to the foregoing embodiments, in an embodiment of the present disclosure, a difference from the foregoing embodiments is that the fastening portion 81 may be a threaded member (as shown in part a of FIG. 80), an outer fastening member (as shown in part b of FIG. 80), an inner fastening member (as shown in part c of FIG. 80), a snap member (as shown in part d of FIG. 80), or a column member (as shown in part e of FIG. 80). In this way, the present disclosure can better meet the requirements for practical application.

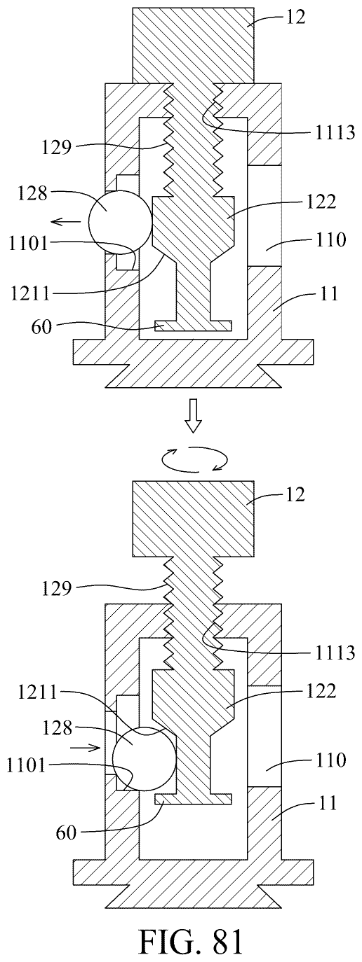

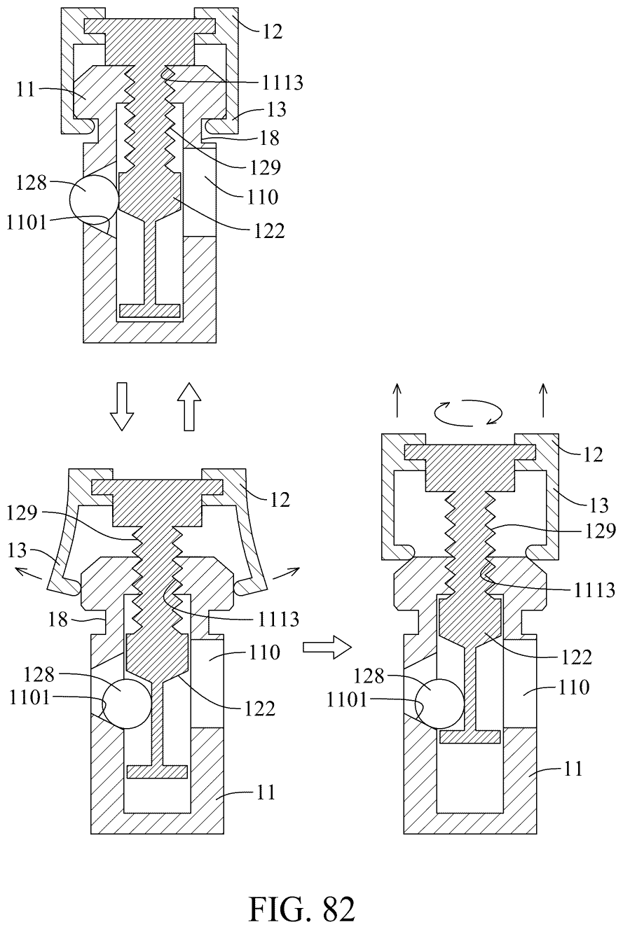

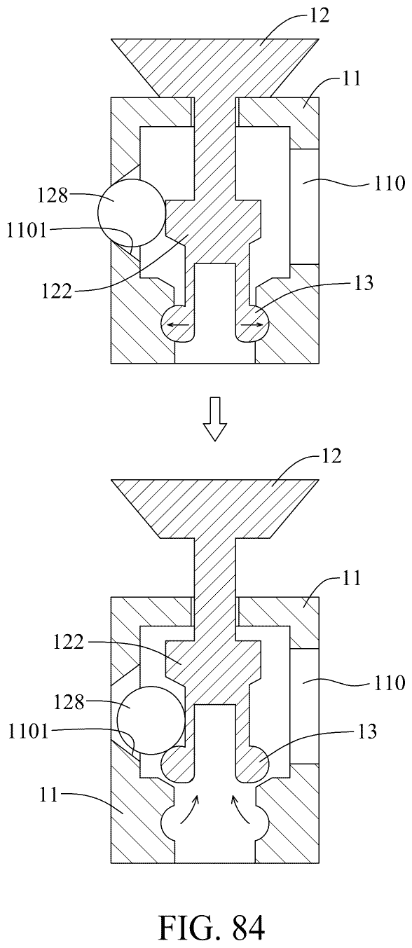

Referring to FIG. 81 and FIG. 84, as shown in the figures, in addition to the foregoing embodiments, in an embodiment of the present disclosure, a difference from the foregoing embodiments is that the present disclosure further includes a first fastening portion 122 and a second fastening portion 128. The first fastening portion 122 abuts against the second fastening portion 128. The body portion 11 is provided with a rotating portion 1113. The abutment portion 12 is provided with a corresponding rotating portion 129. The abutment portion 12 is rotated to enable the rotating portion 1113 to mate with the corresponding rotating portion 129, so that the first fastening portion 122 is allowed to control the movement of the second fastening portion 128 in a spiral manner. In this way, the present disclosure can better meet the requirements for practical application.

In addition to the foregoing embodiments, in an embodiment of the present disclosure, a difference from the foregoing embodiments is that the body portion 11, the abutment portion 12, and the elastic element 13 are integrally formed. The elastic element 13 is elastically deformable and snap-fitted to a limiting portion 18 of the body portion 11, so as to limit the abutment portion 12, or prevent the corresponding rotating portion 129 of the abutment portion 12 from being detached or loosened from the rotating portion 1113. In this way, the present disclosure can better meet the requirements for practical application.

In addition to the foregoing embodiments, in an embodiment of the present disclosure, a difference from the foregoing embodiments is that the second fastening portion 128 enters (or reaches) the arrangement position 1101 (or the snap-fit position). The abutment portion 12 is configured to abut against the second fastening portion 128, or the second fastening portion 128 is enabled to be opened or closed through the abutment portion 12. In this way, the abutment portion 12 and the second fastening portion 128 of the present disclosure can better meet the requirements for practical application.

In addition to the foregoing embodiments, in an embodiment of the present disclosure, a difference from the foregoing embodiments is that the second fastening portion 128 is first arranged in the arrangement position 1101, and then the elastic element 13 (or the abutment portion 12) is arranged on the body portion 11 to abut against the abutment portion 12. Alternatively, the elastic element 13 is arranged on the body portion 11 to abut against the body portion 11 and the abutment portion 12, so that the abutment portion 12 can achieve the effects of automatic reset, elastic snap-fit, or positioning after actuation through cooperation of the elastic element 13.

In addition to the foregoing embodiments, in an embodiment of the present disclosure, a difference from the foregoing embodiments is that the abutment portion 12 has a guide portion 1211 to guide movement of the second fastening portion 128. The guide portion 1211 may be an inclined surface, a curved surface, an arc surface, a step portion, a recess, a protrusion, or a flat surface. The abutment portion 12 has a limiting portion 60 for limiting a position of the second fastening portion 128 or a position after movement. in this way, the abutment portion 12 and the second fastening portion 128 of the present disclosure can better meet the requirements for practical application.

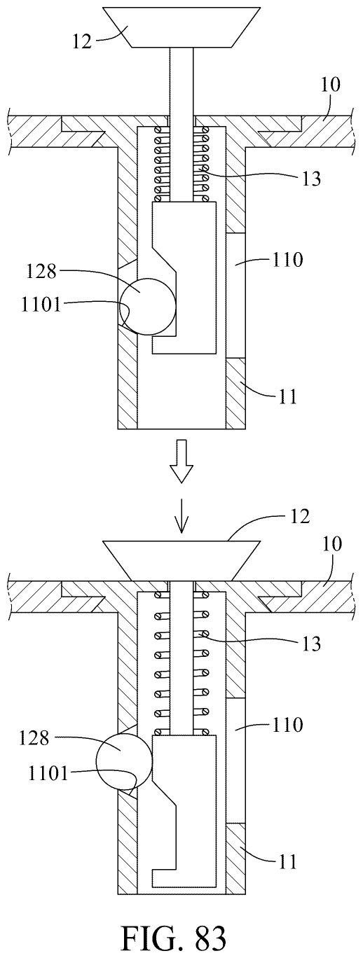

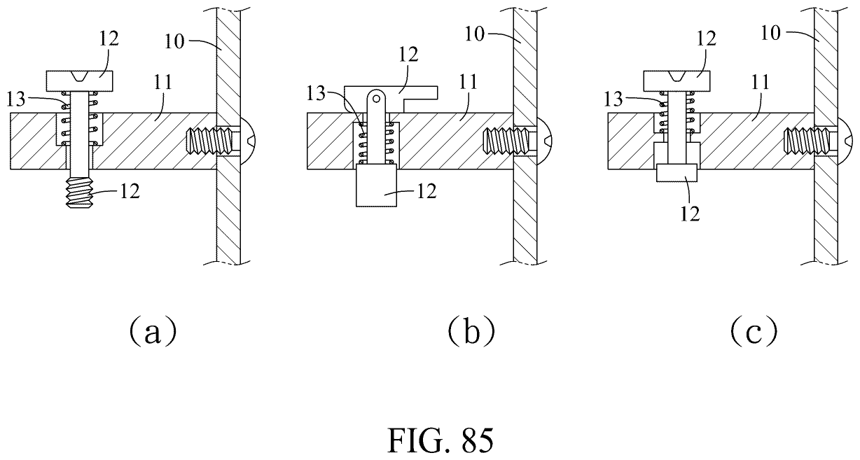

Referring to FIG. 85, as shown in the figure, in addition to the foregoing embodiments, in an embodiment of the present disclosure, a difference from the foregoing embodiments is that the abutment portion 12 may be a threaded member (as shown in part a of FIG. 83), a column member (as shown in part b of FIG. 83), an outer fastening member (as shown in part c of FIG. 83), an inner fastening member, or a snap member. In this way, the abutment portion 12 of the present disclosure can better meet the requirements for practical application.

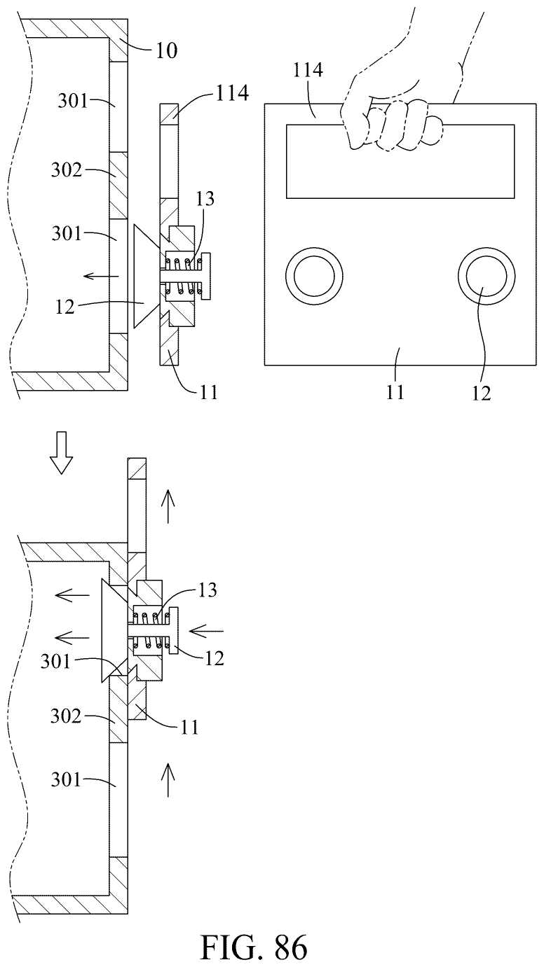

Referring to FIG. 86, as shown in the figure, in addition to the foregoing embodiments, in an embodiment of the present disclosure, a difference from the foregoing embodiments is that the body portion 11 is provided with a handle portion 114. The pushed object 30 is provided with at least one entry portion 301. The entry portion 301 is in communication with a channel 302. The entry portion 301 is configured to lift the abutment portion 12. The entry portion 301 is configured to enable the abutment portion 12 to elastically abut against or be elastically snap-fitted to the entry portion 301. In this way, the present disclosure can better meet the requirements for practical application.

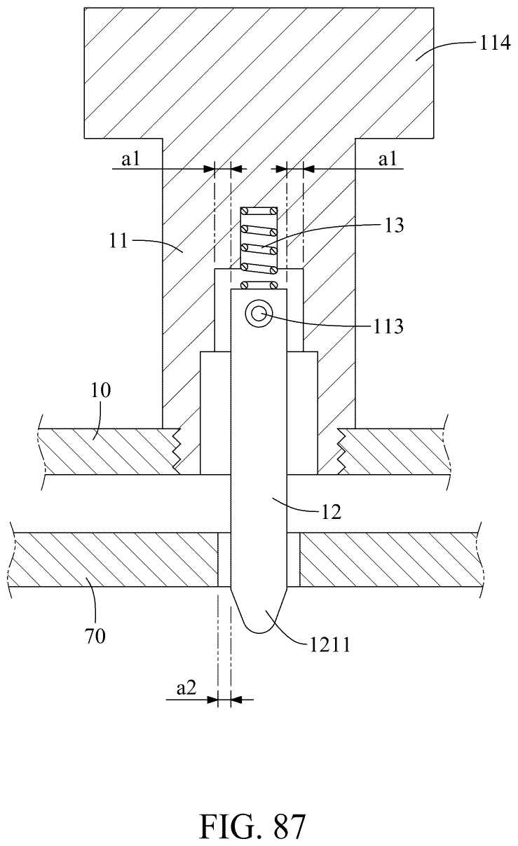

Referring to FIG. 87, as shown in the figure, in addition to the foregoing embodiments, in an embodiment of the present disclosure, a difference from the foregoing embodiments is that the body portion 11 is provided with a handle portion 114. The body portion 11 is arranged on an object 10. The abutment portion 12 is provided with a guide portion 1211. The guide portion 1211 and the handle portion 114 are fitted through a joining portion 113. The joining portion 113 is a threaded member, a riveted member, or an expanded member. One end of the elastic element 13 abuts against the body portion 11, and an other end abuts against the abutment portion 12. The guide portion 1211 is configured to guide the handle portion 114 (or the object 10) to approach, enter, be arranged, or be mounted to an other object 70. In this way, the present disclosure can better meet the requirements for practical application.

In addition to the foregoing embodiments, in an embodiment of the present disclosure, a difference from the foregoing embodiments is that a margin a1 is defined between the guide portion 1211 and the handle portion 114, or an other margin a2 is defined between the handle portion 114 and the other object 70. The margin a1 and the other margin a2 are configured for guiding adjustment of the handle portion 114 (or the object 10) when approaching, entering, being arranged, or being mounted to the other object 70.

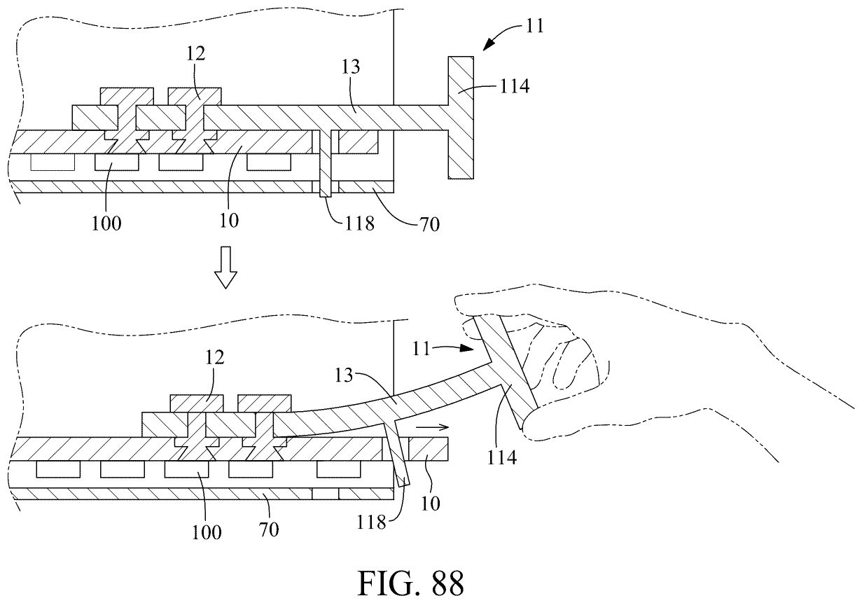

Referring to FIG. 88, as shown in the figure, in addition to the foregoing embodiments, in an embodiment of the present disclosure, a difference from the foregoing embodiments is that the body portion 11 is provided with a handle portion 114 (or a pulling portion) and a fastening member 118. The elastic element 13 is arranged on the body portion 11 (or the body portion 11 is an elastic element). The fastening member 118 is snap-fitted to an object 10 and an other object 70, which is configured to perform elastic tripping to enable the object 10 to move through a wheel member 100. The object 10 is a casing, and the other object 70 is a rack or a cabinet. In this way, the present disclosure can better meet the requirements for practical application.

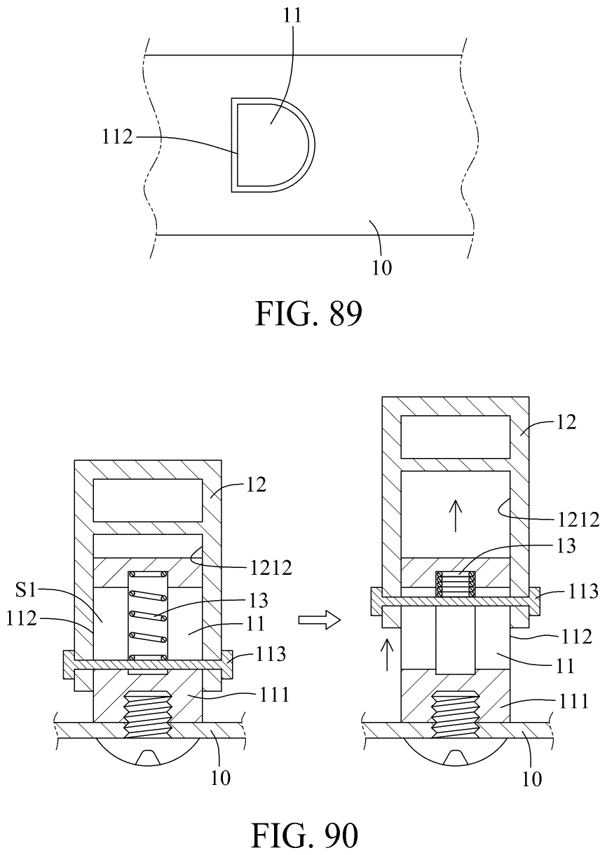

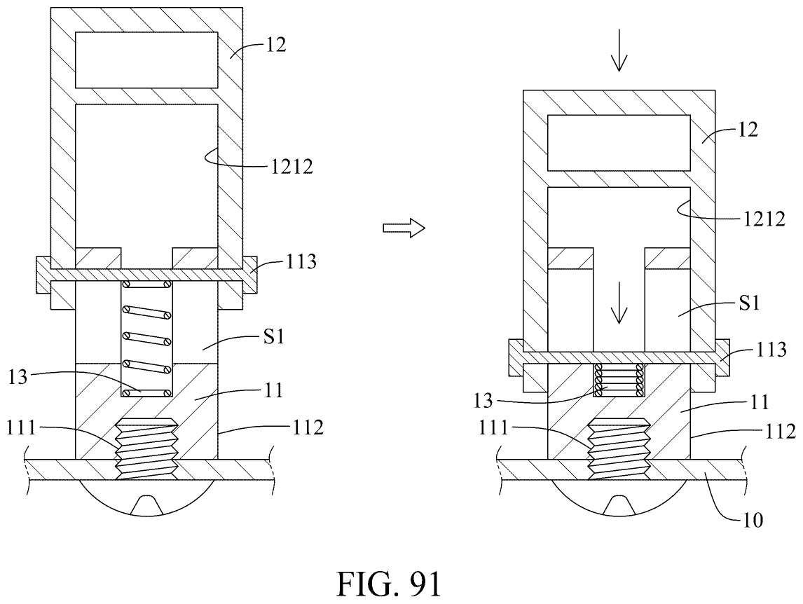

Referring to FIG. 89 to FIG. 91, as shown in the figures, in addition to the foregoing embodiments, in an embodiment of the present disclosure, a difference from the foregoing embodiments is that the body portion 11 is provided with an anti-rotation portion 112. The abutment portion 12 is provided with a corresponding anti-rotation portion 1212. The anti-rotation portion 112 and the corresponding anti-rotation portion 1212 are configured to prevent rotation between the body portion 11 and the abutment portion 12, or the anti-rotation portion 112 and the corresponding anti-rotation portion 1212 are configured to prevent rotation with respect to an object 10.

In addition to the foregoing embodiments, in an embodiment of the present disclosure, a difference from the foregoing embodiments is that the abutment portion 12 is provided with a handle portion 121. The body portion 11 is joined to the abutment portion 12 through the joining portion 113. Two ends of the elastic element 13 respectively abut against the body portion 11 and the joining portion 113. The body portion 11 is provided with a motion space SI for movement of the joining portion 113. The handle portion 121 is pressed to move the abutment portion 12 for abutment.

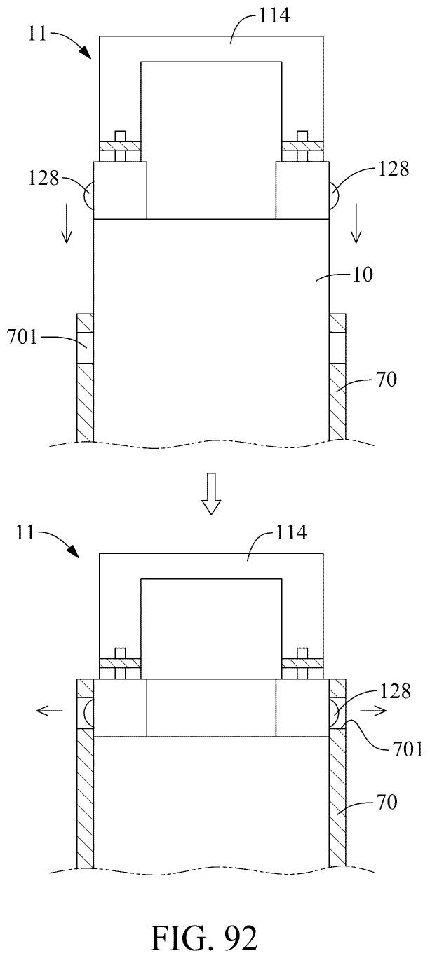

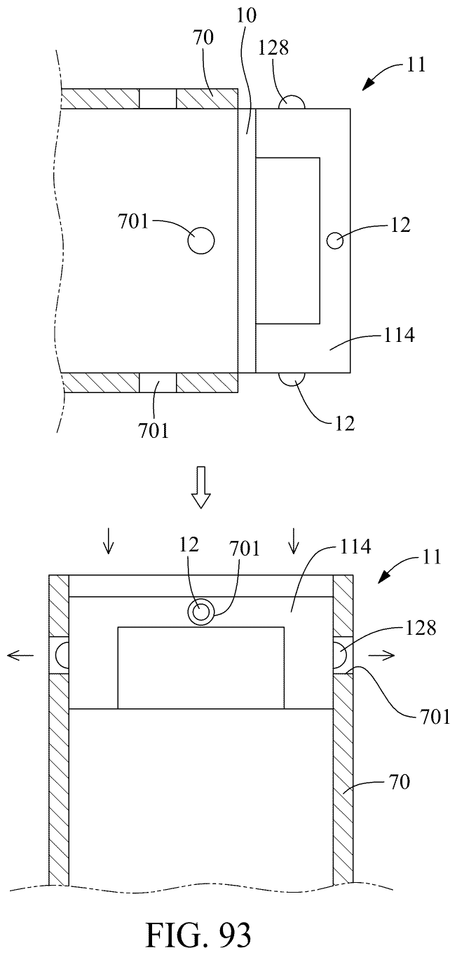

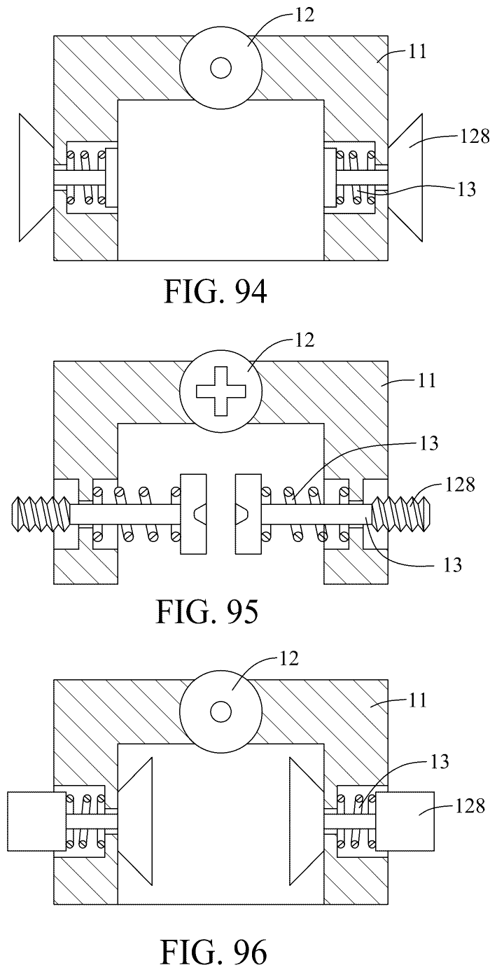

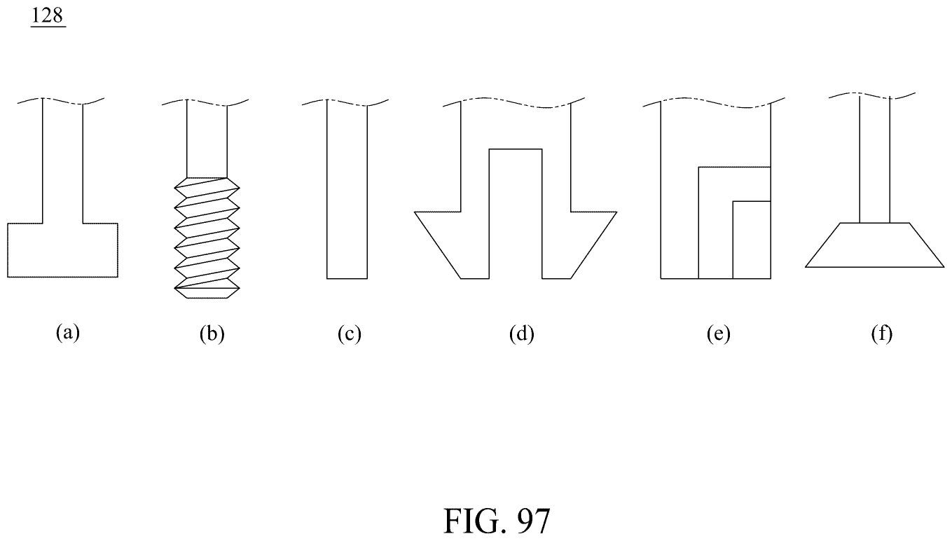

Referring to FIG. 92 to FIG. 97, as shown in the figures, in addition to the foregoing embodiments, in an embodiment of the present disclosure, a difference from the foregoing embodiments is that the body portion 11 is provided with a handle portion 114 and a second fastening portion 128. The body portion 11 is arranged on an object 10. The second fastening portion 128 is snap-fitted to a receiving portion 701 of an other object 70 (as shown in FIG. 92), or the abutment portion 12 and the second fastening portion 128 are respectively snap-fitted to the receiving portion 701 of the other object 70 (as shown in FIG. 93 to FIG. 96). In this way, the present disclosure can better meet the requirements for practical application.

In addition to the foregoing embodiments, in an embodiment of the present disclosure, a difference from the foregoing embodiments is that the second fastening portion 128 may be an outer fastening member (as shown in part a of FIG. 97), a threaded member (as shown in part b of FIG. 97), a column member (as shown in part c of FIG. 97), a snap member (as shown in part d of FIG. 97), an inner fastening member (as shown in part e of FIG. 97), an inclined surface-equipped member (as shown in part f of FIG. 97), or a curved surface-equipped member. In this way, the second fastening portion 128 can better meet the requirements for practical application.

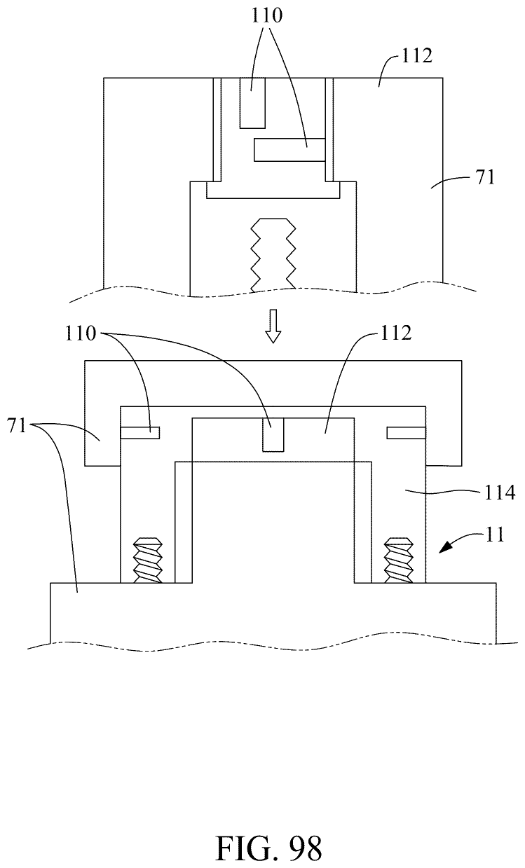

Referring to FIG. 98, as shown in the figure, in addition to the foregoing embodiments, in an embodiment of the present disclosure, a difference from the foregoing embodiments is that the body portion 11 is provided with an arrangement portion 110 configured to allow mounting of the second fastening portion 128. The arrangement portion 110 has an anti-rotation portion 112 (or a limiting portion) configured to prevent rotation of (or limit) the handle portion 114 when it is shaped during manufacturing by stamping by applying a force to a mold 71, so that the arrangement portion 110 is kept in a position or a direction where the second fastening portion 128 is correctly mounted, so as to maintain stability of the second fastening portion 128 during use. In this way, the present disclosure can better meet the requirements for practical application.

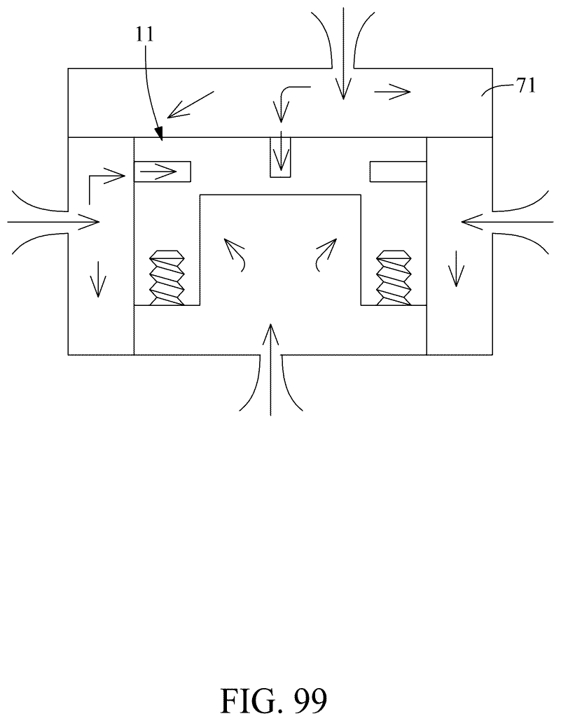

Referring to FIG. 99, as shown in the figure, in addition to the foregoing embodiment, in an embodiment of the present disclosure, a difference from the foregoing embodiment is that the handle portion 114 is formed by injection molding through a mold 71, and the arrangement portion 110 configured to allow mounting of the second fastening portion 128 is formed through the mold 71 or a module. The mode 71 may be formed by injection molding through a plastic or metal mold as required. In this way, the present disclosure can better meet the requirements for practical application.

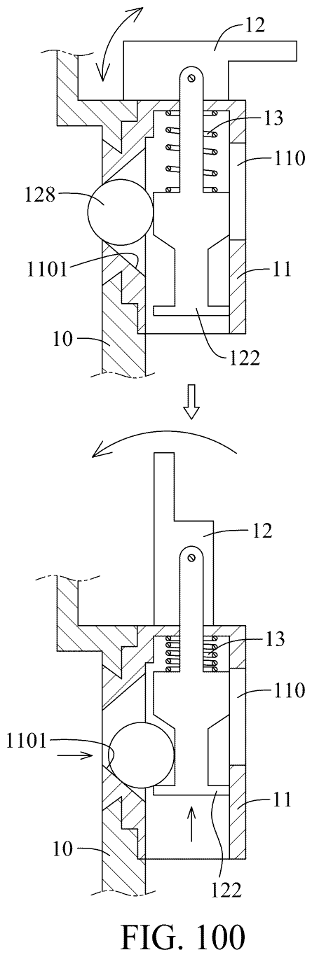

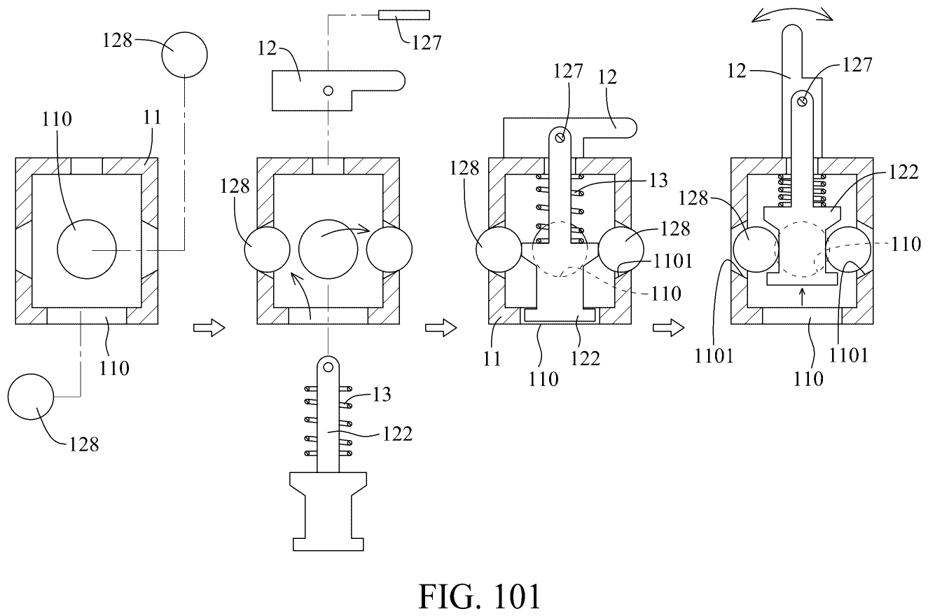

Referring to FIG. 100 and FIG. 101, as shown in the figures, in addition to the foregoing embodiments, in an embodiment of the present disclosure, a difference from the foregoing embodiments is that the body portion 11 is provided with at least one second fastening portion 128. The body portion 11 is laterally snap-fitted to an object 10 through the second fastening portion 128. In this way, the present disclosure can better meet the requirements for practical application.

In addition to the foregoing embodiments, in an embodiment of the present disclosure, a difference from the foregoing embodiments is that the body portion 11 is provided with an arrangement portion 110 configured to allow the second fastening portion 128 to enter (or reach) an arrangement position 1101 (or a snap-fit position). The arrangement portion 110 is located on a lateral side, above, or below the body portion 11. The second fastening portion 128 first enters the body portion 11 through the arrangement portion 110, then the elastic element 13 is arranged on the body portion 11 to abut against the abutment portion 12, and the other joining portion 127 is bolted to the first fastening portion 122 and the abutment portion 12. In this way, the present disclosure can better meet the requirements for practical application.

In addition to the foregoing embodiments, in an embodiment of the present disclosure, a difference from the foregoing embodiments is that one, two, or more than two second fastening portions 128 are arranged. In this way, the present disclosure can better meet the requirements for practical application.

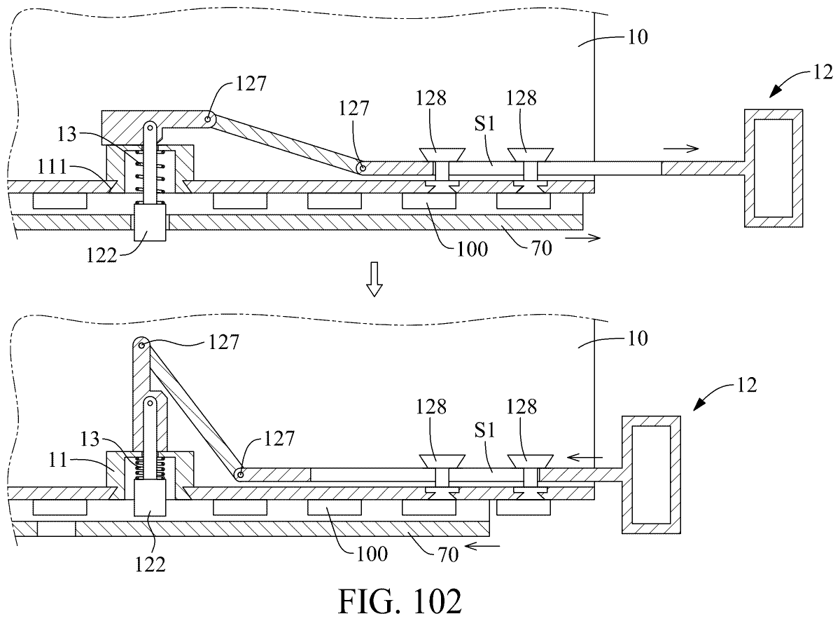

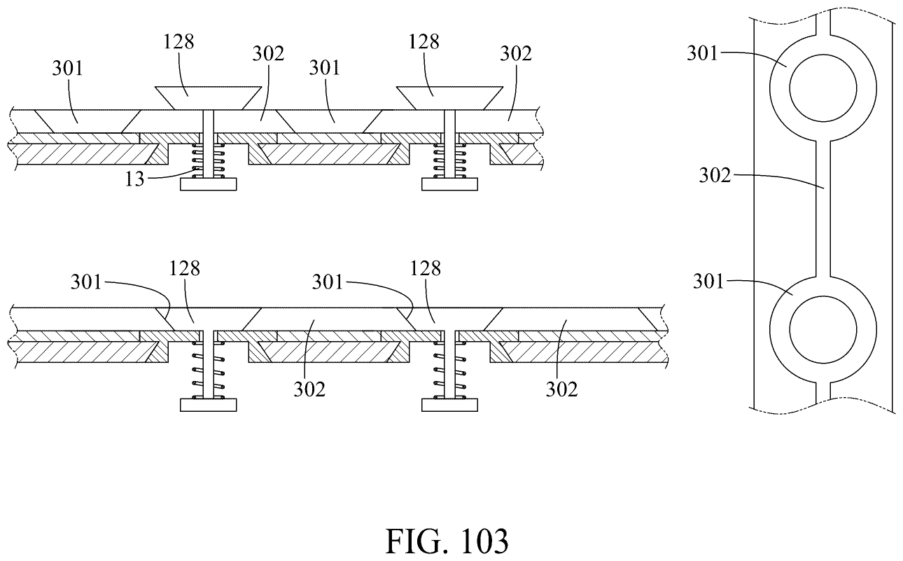

Referring to FIG. 102 and FIG. 103, as shown in the figures, in addition to the foregoing embodiments, in an embodiment of the present disclosure, a difference from the foregoing embodiments is that the body portion 11 is configured to be fitted to or integrally formed with an object 10. The abutment portion 12 is provided with a first fastening portion 122. The abutment portion 12 is configured to be fitted or bolted to the body portion 11 through the other joining portion 127, to form a fitted member, a connector, or a link member. The elastic element 13 abuts against the body portion 11 and the abutment portion 12. The object 10 is snap-fitted to an other object 70 through the first fastening portion 122. The object 10 is provided with a wheel member 100, a rolling member, a track member, or a sliding member, so that the first fastening portion 122 may be opened or closed to move the object 10 through the wheel member 100, the rolling member, the track member, or the sliding member, or configured to be detached from the other object 70. In this way, the present disclosure can better meet the requirements for practical application.

In addition to the foregoing embodiments, in an embodiment of the present disclosure, a difference from the foregoing embodiments is that the abutment portion 12 is provided with an entry portion 301, to enable a second fastening portion 128 to snap-fit the abutment portion 12 to the object 10. The entry portion 301 has a channel 302 configured to enable the second fastening portion 128 having the elastic element 13 to limit, temporarily limit, or elastically limit the first fastening portion 122 to a snap-fit position or a tripping position, or enable the first fastening portion 122 to move to the snap-fit position or the tripping position. In this way, the present disclosure can better meet the requirements for practical application.

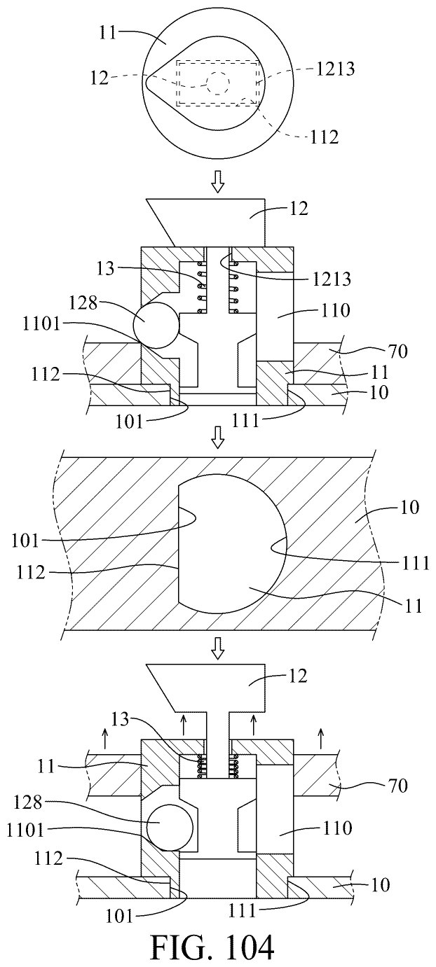

Referring to FIG. 104, as shown in the figure, in addition to the foregoing embodiments, in an embodiment of the present disclosure, a difference from the foregoing embodiments is that the body portion 11 is provided with an anti-rotation portion 112 configured to prevent rotation with respect to the object 10. The abutment portion 12 is provided with an other anti-rotation portion 1213 configured to prevent rotation with respect to the body portion 11. The other anti-rotation portion 1213 is configured to limit a position or movement of the abutment portion 12, or the other anti-rotation portion 1213 is configured to limit a snap-fit direction, a snap-fit angle, or a snap-fit position of the second fastening portion 128. In this way, the present disclosure can better meet the requirements for practical application.

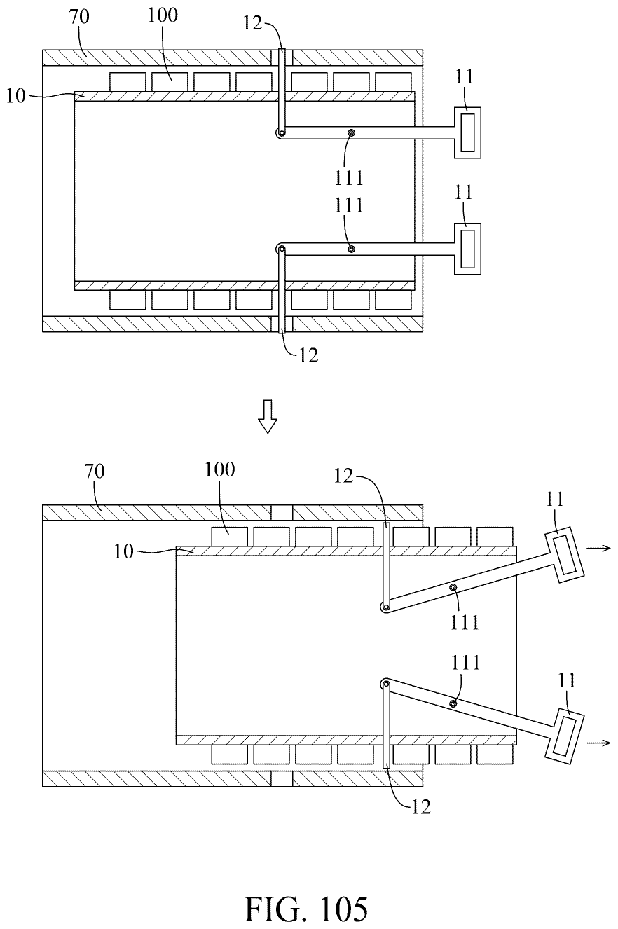

Referring to FIG. 105, as shown in the figure, in addition to the foregoing embodiment, in an embodiment of the present disclosure, a difference from the foregoing embodiment is that the body portion 11 fits the abutment portion 12 to the object 10 through a fitting portion 111. The abutment portion 12 is a fastening portion. The object 10 is arranged on an other object 70. The object 10 and the other object 70 are each a casing or a cabinet. The abutment portion 12 is snap-fitted to the other object 70 to operate, rotate, or pull the body portion 11, to enable the abutment portion 12 to be detached from the other object 70, or to enable the object 10 having a wheel member 100 (or a track) to be partially or completely detached from or snap-fitted to the other object 70 through rolling of the wheel member 100 (or sliding of the track). In this way, the present disclosure can better meet the requirements for practical application.

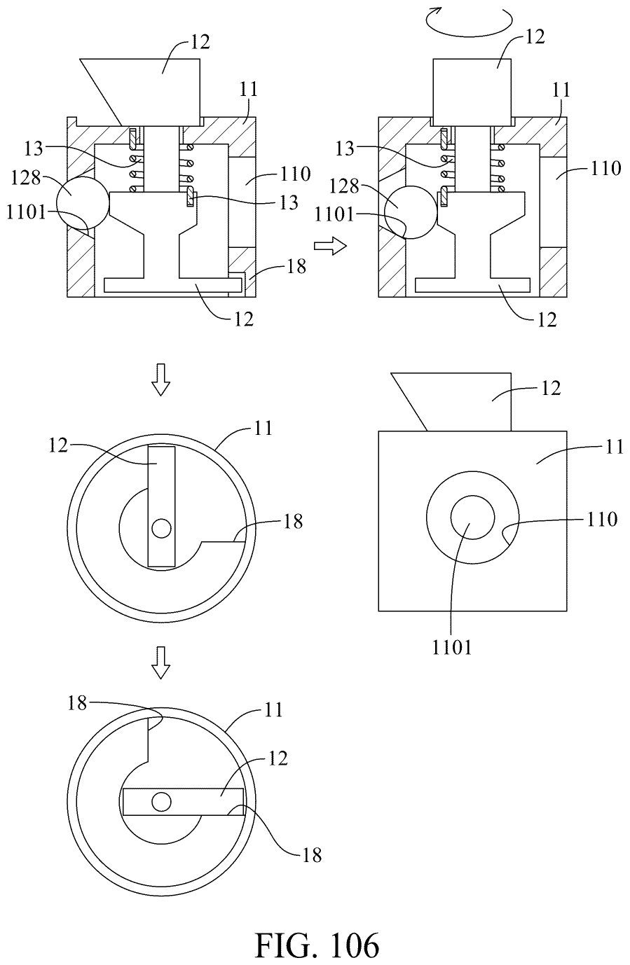

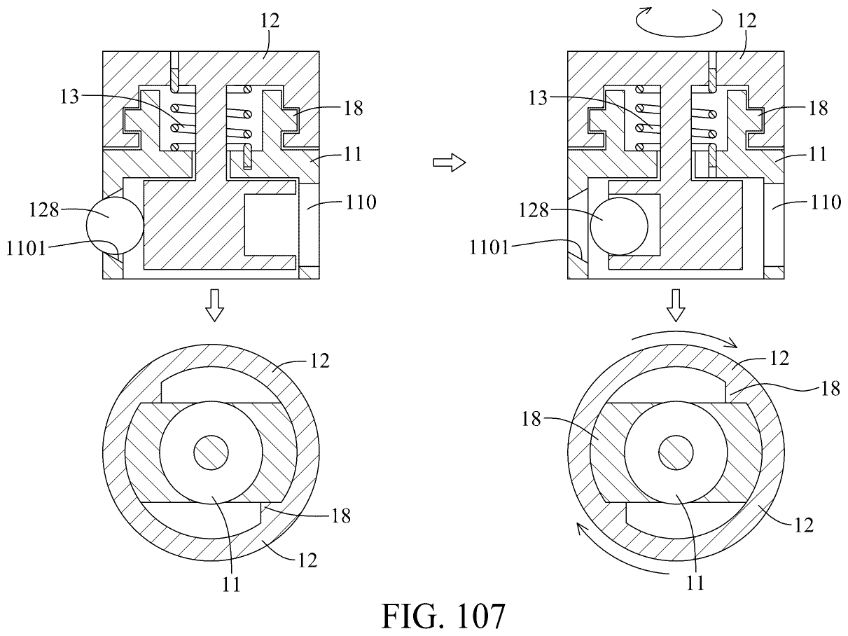

Referring to FIG. 106 and FIG. 107, as shown in the figures, in addition to the foregoing embodiments, in an embodiment of the present disclosure, a difference from the foregoing embodiments is that the body portion 11 is provided with an arrangement portion 110 configured to allow mounting of the second fastening portion 128. The arrangement portion 110 is configured to allow the second fastening portion 128 to reach an arrangement position 1101, the arrangement position 1101 and the arrangement portion 110 are opposite positions or positions reachable through free fall, and then the abutment portion 12 is configured to provide limitation. In this way, the present disclosure can better meet the requirements for practical application.

In addition to the foregoing embodiments, in an embodiment of the present disclosure, a difference from the foregoing embodiments is that the elastic element 13 is a torsion spring having two ends respectively arranged on the body portion 11 and the abutment portion 12, so as to enable the abutment portion 12 to elastically rotate and abut against the second fastening portion 128, and enable the second fastening portion 128 to be located in a snap-fit position or a non-snap-fit position. The body portion 11 (or the abutment portion 12) may be provided with a limiting portion 18 configured to limit the abutment portion 12 to enable the second fastening portion 128 to be in the snap-fit position or the non-snap-fit position. In this way, the present disclosure can better meet the requirements for practical application.

In addition to the foregoing embodiments, in an embodiment of the present disclosure, a difference from the foregoing embodiments is that the second fastening portion 128 may also reach the arrangement position 1101 through the arrangement portion 110 by using a tool, and then the abutment portion 12 is configured to provide limitation. In this way, the present disclosure can better meet the requirements for practical application.

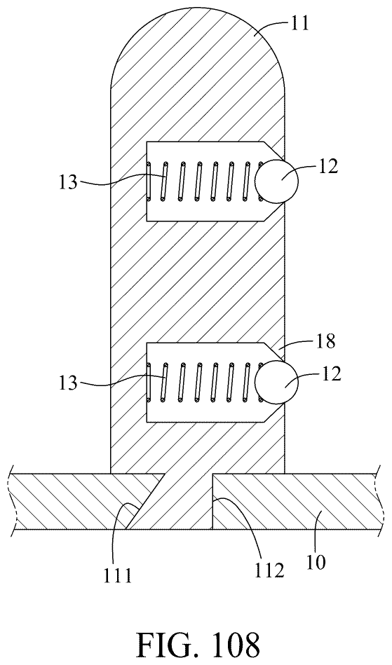

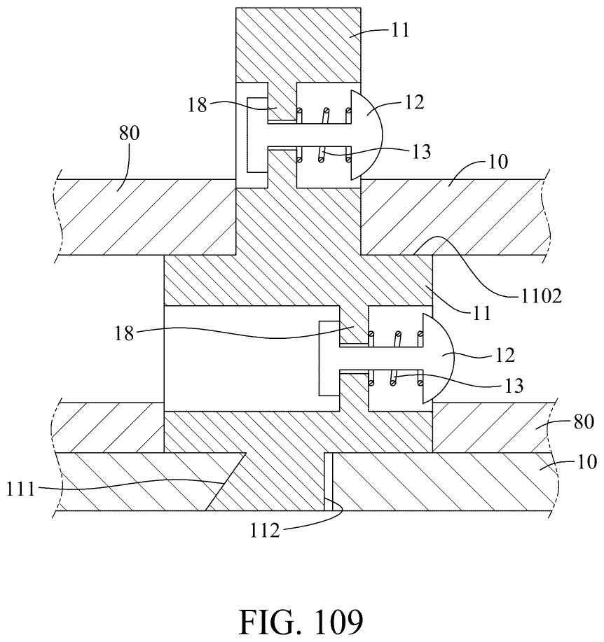

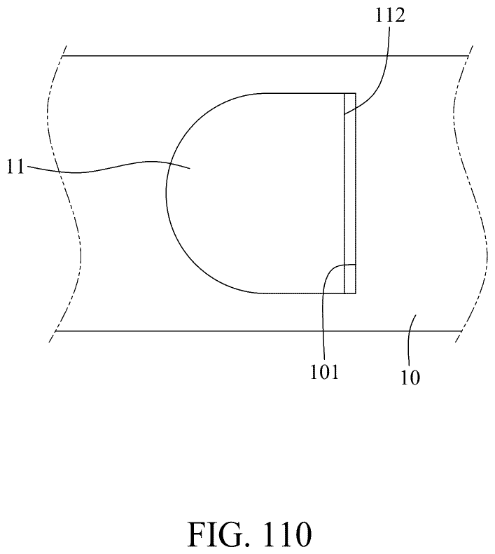

Referring to FIG. 108 to FIG. 110, as shown in the figures, in addition to the foregoing embodiments, in an embodiment of the present disclosure, a difference from the foregoing embodiments is that two abutment portions 12 and two elastic elements 13 are arranged. The abutment portions 12 are configured to be snap-fitted to two receiving objects 80. The body portion 11 is provided with a shoulder portion 1102, a fitting portion 111, and an anti-rotation portion 112. The shoulder portion 1102 is configured to support at least one receiving object 80. The fitting portion 111 is configured to be fitted to an object 10. The anti-rotation portion 112 and a corresponding anti-rotation portion 101 of the object 10 mutually prevent rotation, so that the anti-rotation portion 112 is configured to limit a direction of the body portion 11 and snap-fit directions of the abutment portions 12, or the anti-rotation portion 112 is configured to limit directions of the body portion 11, the abutment portions 12, and the object 10. In this way, the present disclosure can better meet the requirements for practical application.

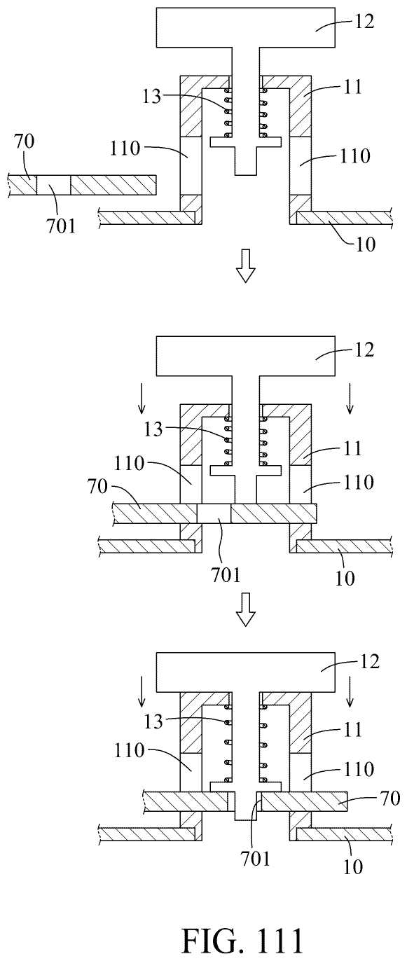

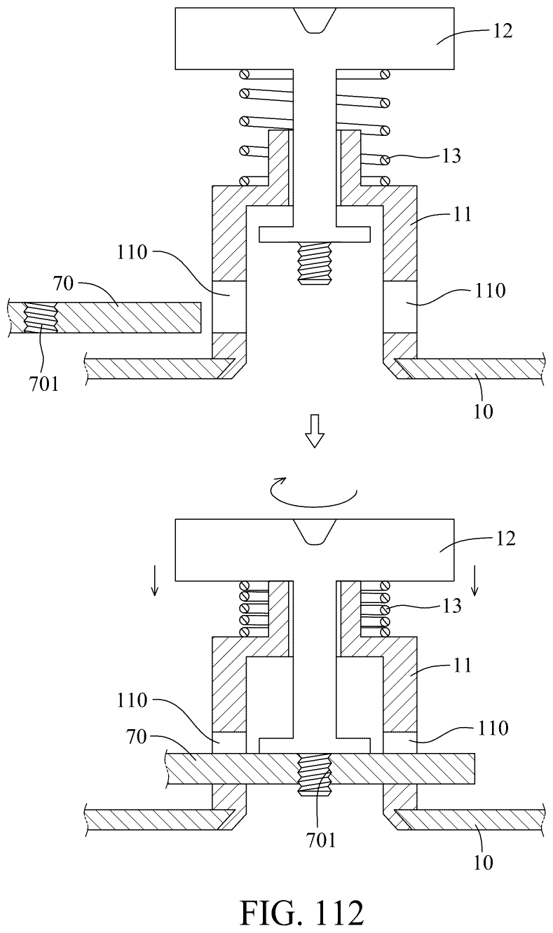

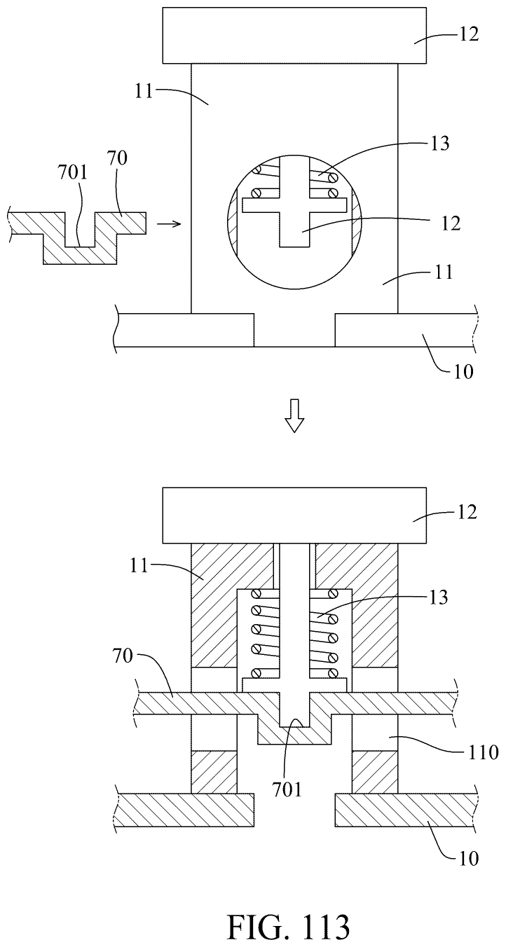

Referring to FIG. 111 to FIG. 114, as shown in the figures, in addition to the foregoing embodiments, in an embodiment of the present disclosure, a difference from the foregoing embodiments is that the body portion 11 is provided with an arrangement portion 110. The other object 70 (or the object 10) enters the body portion 11 through the arrangement portion 110 and is snap-fitted, interference-fitted, locked, or enabled to conduct current through the abutment portion 12. In this way, the present disclosure can better meet the requirements for practical application.

In addition to the foregoing embodiments, in an embodiment of the present disclosure, a difference from the foregoing embodiments is that the other object 70 (or the object 10) may be a receiving member, a conductive member, a wire, a fastener, an optical fiber, a metal member, a plastic member, a column member, or a plate member, so that the abutment portion 12 is snap-fitted to a receiving portion 701 of the other object 70 (or the object 10) for conductivity. In this way, the present disclosure can better meet the requirements for practical application.

In addition to the foregoing embodiments, in an embodiment of the present disclosure, a difference from the foregoing embodiments is that the abutment portion 12 may be a fastening portion, a column member, a threaded member, a convex member, a concave member, or a planar member, and two ends of the elastic element 13 respectively abut against the body portion 11 and the abutment portion 12. In addition, the arrangement portion 110 may be a hole portion, a groove portion, a trench portion, or a space. In this way, the present disclosure can better meet the requirements for practical application.

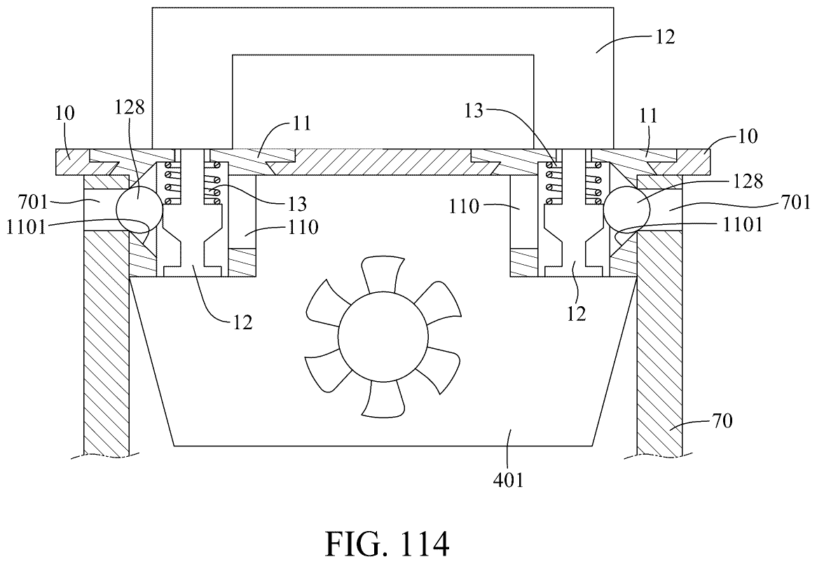

In addition to the foregoing embodiments, in an embodiment of the present disclosure, a difference from the foregoing embodiments is that a fan 401 (or a power supply or a heat sink) may be joined to the other object 70 through the abutment structure 1, and the abutment structure 1 is used for snap-fitting or conductivity (as shown in FIG. 114). In this way, the present disclosure can better meet the requirements for practical application.

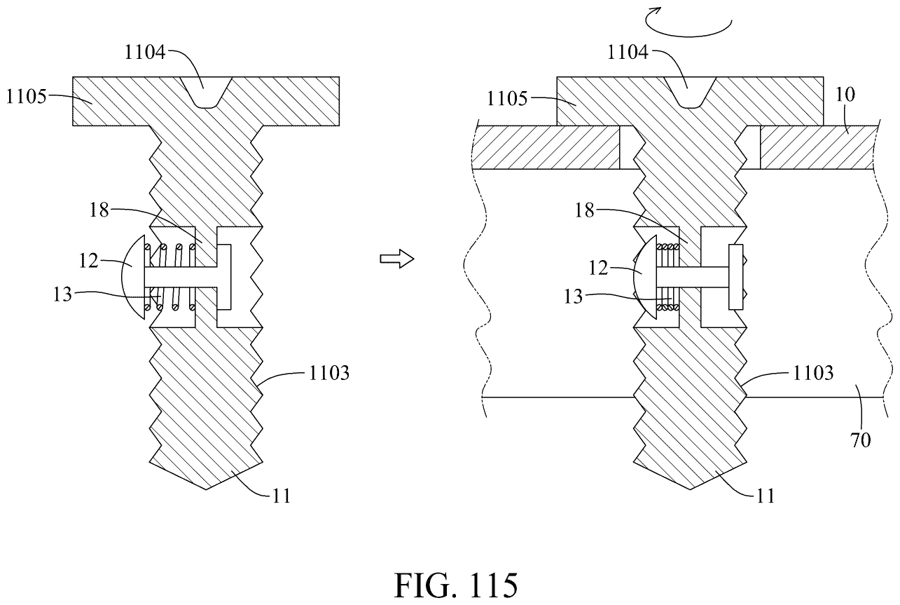

Referring to FIG. 115 to FIG. 117, as shown in the figures, in addition to the foregoing embodiments, in an embodiment of the present disclosure, a difference from the foregoing embodiments is that the body portion 11 is provided with a limiting portion 18. The limiting portion 18 is configured to limit the abutment portion 12 and the elastic element 13, and the body portion 11 is provided with a screw thread 1103 configured to be fixed to the object 10 (or the other object 70). The abutment portion 12 is laterally fitted to the body portion 11 and is configured to laterally abut against or be snap-fitted to the other object 70 (or the object 10, as shown in FIG. 115). In this way, the present disclosure can better meet the requirements for practical application.

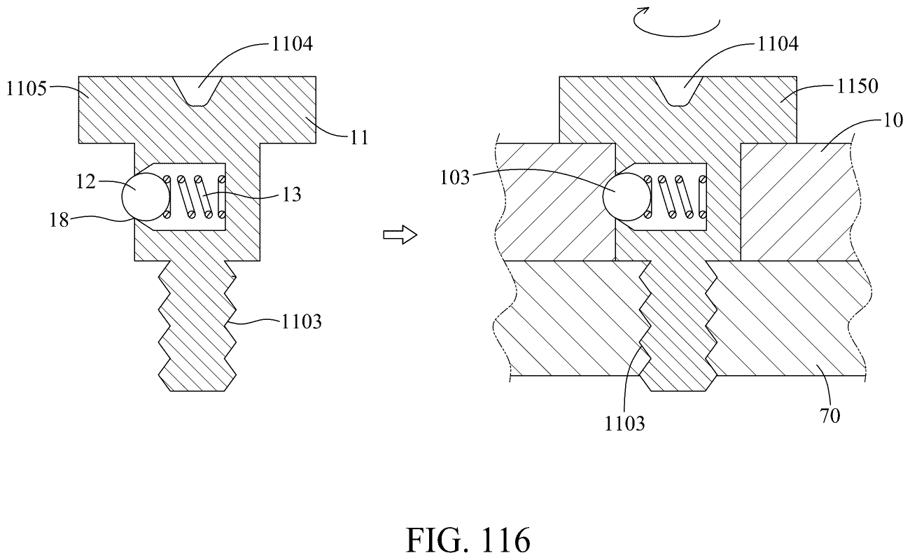

In addition to the foregoing embodiments, in an embodiment of the present disclosure, as shown in FIG. 116, a difference from the foregoing embodiments is that the screw thread 1103 of the body portion 11 first passes through the object 10 and then is fixed to the other object 70, and the abutment portion 12 is enabled to laterally abut against or be snap-fitted to the object 10 or the receiving portion 103 of the object 10. In this way, the present disclosure can better meet the requirements for practical application.

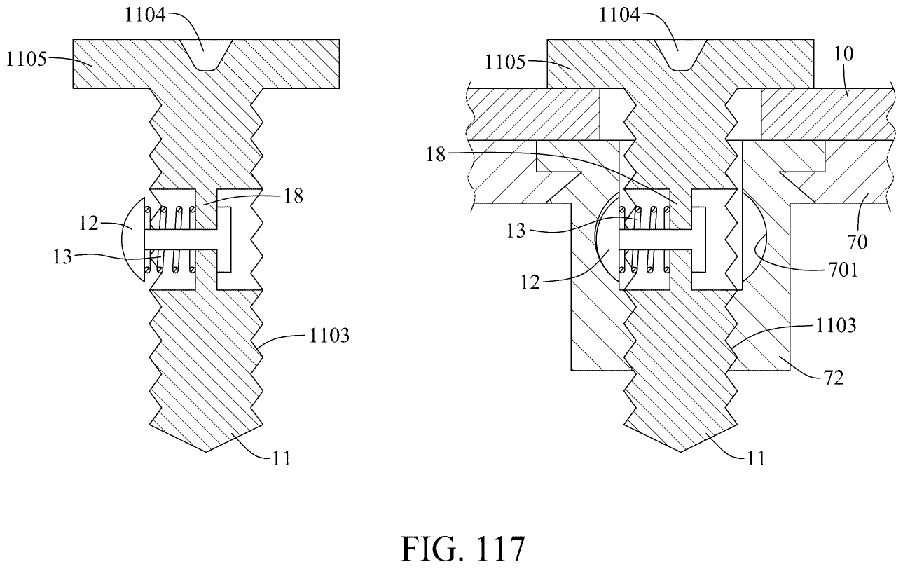

In addition to the foregoing embodiments, in an embodiment of the present disclosure, as shown in FIG. 117, a difference from the foregoing embodiments is that the screw thread 1103 of the body portion 11 first passes through the object 10 and then is configured to be locked into the other object 70, the abutment portion 12 abuts against or is snap-fitted to the other object 70 or the receiving portion 701 of the other object 70, and the abutment portion 12 is allowed to be laterally interference-fitted to a nut 72 (a screw thread or the object 10) to prevent loosening or snap-fitting. In this way, the present disclosure can better meet the requirements for practical application.

In addition to the foregoing embodiments, in an embodiment of the present disclosure, a difference from the foregoing embodiments is that the body portion 11 is provided with an operating portion 1104 and a head portion 1105. An external rotation force may be applied to the operating portion 1104 or the head portion 1105 during use, so that the screw thread 1103 of the body portion 11 is fixed to the object 10, the other object 70, or the nut 72. In this way, the present disclosure can better meet the requirements for practical application.

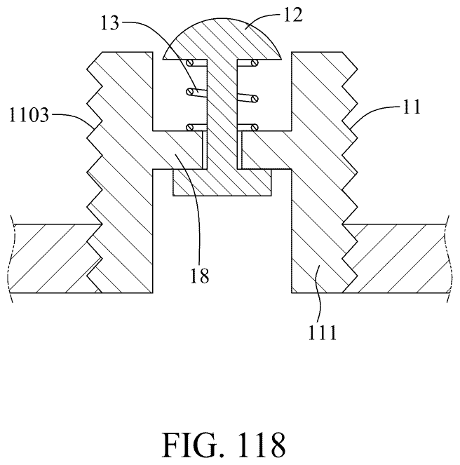

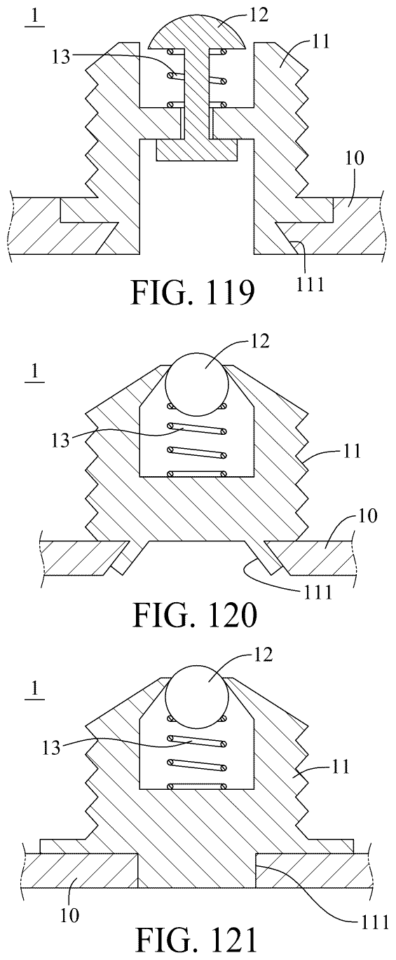

Referring to FIG. 118 to FIG. 121, as shown in the figures, in addition to the foregoing embodiments, in an embodiment of the present disclosure, a difference from the foregoing embodiments is that the fitting portion 111 of the body portion 11 is configured to be locked (as shown in FIG. 118), riveted (as shown in FIG. 119), expanded (as shown in FIG. 120), welded (as shown in FIG. 121), or snap-fitted to the object 10. In this way, the body portion 11 of the abutment structure 1 may be firmly engaged with the object 10, so that the present disclosure can better meet the requirements for practical application.

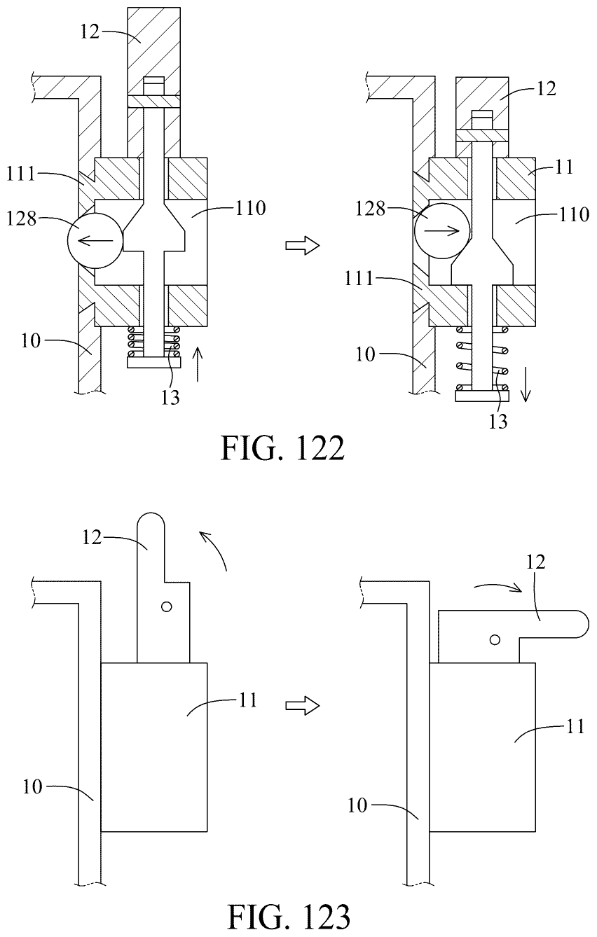

Referring to FIG. 122 to FIG. 123, as shown in the figures, in addition to the foregoing embodiments, in an embodiment of the present disclosure, a difference from the foregoing embodiments is that the abutment portion 12 may be a handle (for example, a pull member). The elastic element 13 is arranged between the body portion 11 and the abutment portion 12, and the elastic element 13 is located on an outer side (as shown in FIG. 122) of the body portion 11, or the elastic element 13 is located on an inner side (as shown in FIG. 123) of the body portion 11.

During use, the body portion 11 may be arranged on the object 10, and the abutment portion 12 is pulled to rotate the abutment portion 12 to reduce the height, so that the abutment portion 12 drives the snap-fitting or tripping of the second fastening portion 128.

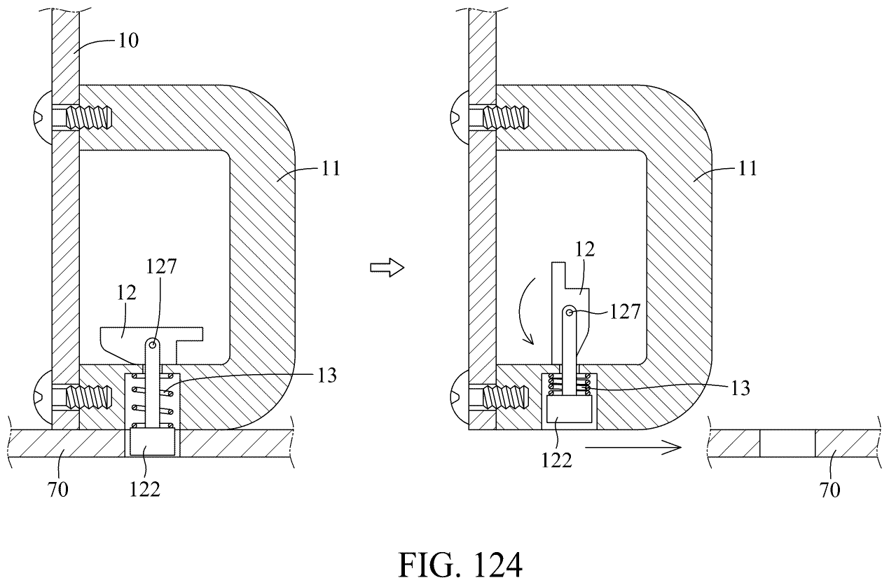

Referring to FIG. 124, as shown in the figure, in addition to the foregoing embodiments, in an embodiment of the present disclosure, a difference from the foregoing embodiments is that the abutment portion 12 may be in the form of a pull member, and the body portion 11 may be in the form of a handle. The abutment portion 12 is joined to the first fastening portion 122 through the other joining portion 127, which is configured to pull the abutment portion 12 to control snap-fitting or tripping of the first fastening portion 122 and the other object 70. In this way, the abutment portion 12 may drive the first fastening portion 122 and the other object 70 to be firmly engaged or quickly detached, so that the present disclosure can better meet the requirements for practical application.

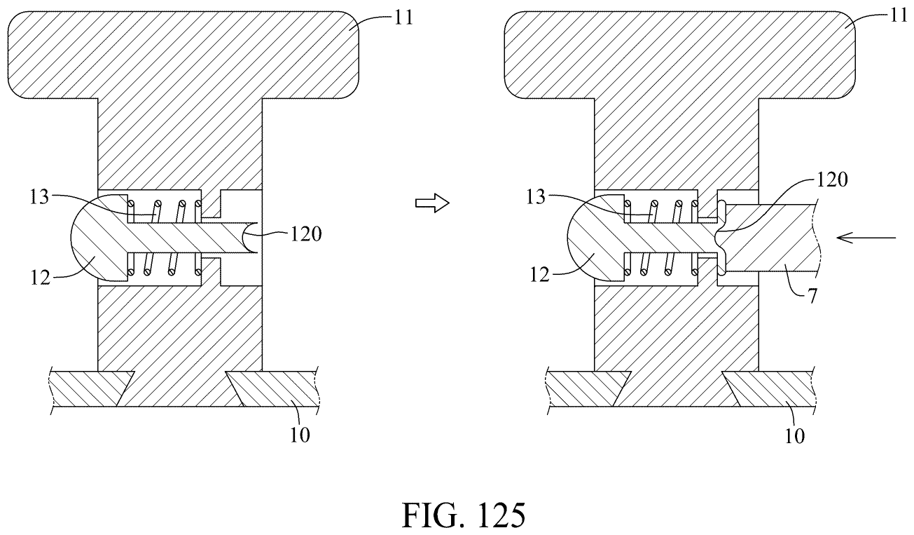

Referring to FIG. 125, as shown in the figure, in addition to the foregoing embodiments, in an embodiment of the present disclosure, a difference from the foregoing embodiments is that the abutment portion 12 is pressed by the tool 7 (or the mold 71) to enable the abutment portion 12 to be expanded and fitted to the body portion 11. In this way, the abutment portion 12 may be firmly and movably arranged on the body portion 11, so that the present disclosure can better meet the requirements for practical application.

In addition to the foregoing embodiments, in an embodiment of the present disclosure, a difference from the foregoing embodiments is that the abutment portion 12 is provided with a groove portion 120 (a recess or a hole portion) configured for causing the tool 7 (or the mold 71) to apply pressure to the groove portion 120 (the recess or the hole portion), so that the abutment portion 12 is expanded and fitted to the body portion 11. In this way, the abutment portion 12 may be firmly and movably arranged on the body portion 11, so that the present disclosure can better meet the requirements for practical application.

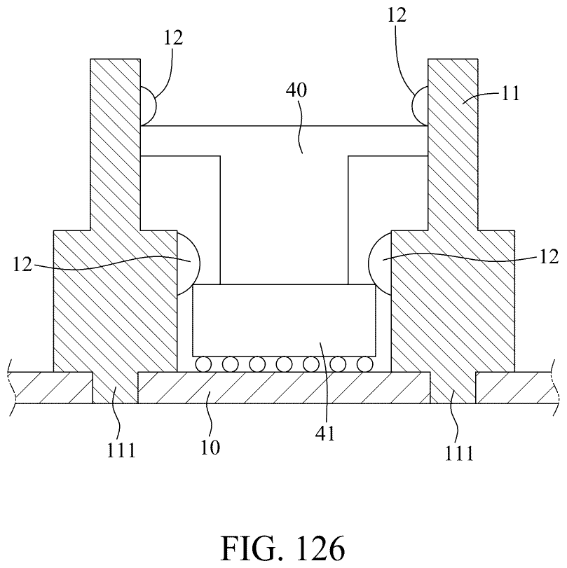

Referring to FIG. 126, as shown in the figure, in addition to the foregoing embodiments, in an embodiment of the present disclosure, a difference from the foregoing embodiments is that the abutment portion 12 is snap-fitted to the heating member 41 (for example, a chip or a conductor), or the abutment portion 12 is snap-fitted to the heat sink 40 to enable the heat sink 40 to dissipate heat of the heating member 41. In this way, the abutment portion 12 may be firmly snap-fitted to the heating member 41 or the heat sink 40, so that the present disclosure can better meet the requirements for practical application.

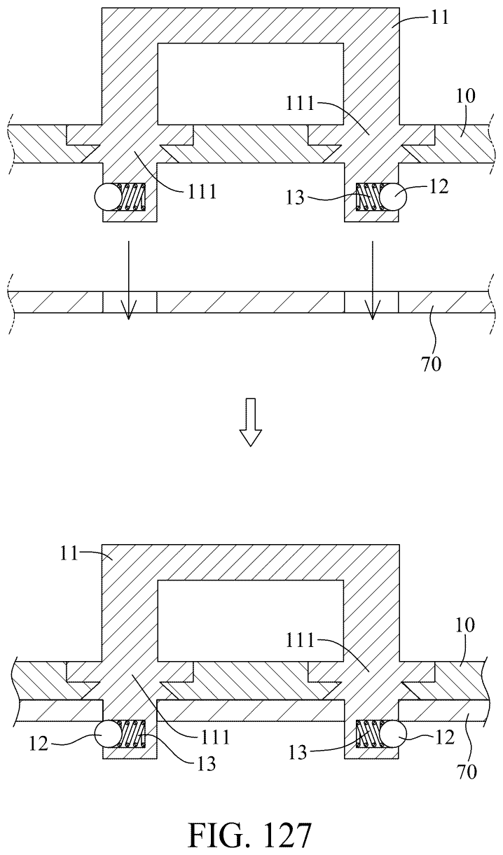

Referring to FIG. 127, as shown in the figure, in addition to the foregoing embodiments, in an embodiment of the present disclosure, a difference from the foregoing embodiments is that the body portion 11 may be a handle (or may be a fastening member, a track member, a heat sink, a moving member, a wheel, a rotating member, or a rolling member). The body portion 11 is arranged or mounted to an object 10, so that the abutment portion 12 is located on an other side of the object 10. In this way, the abutment portion 12 is snap-fitted to an other object 70, so that the present disclosure can better meet the requirements for practical application.

The present disclosure has been disclosed in the above with preferred embodiments. However, a person skilled in the art should understand that the embodiment is only used to illustrate the present disclosure, and should not be interpreted as a limitation on the scope of the present disclosure. It should be noted that all changes and substitutions equivalent to the embodiment should be considered to fall within the scope of the present disclosure. Therefore, the protection scope of the present disclosure is subject to the scope defined by the patent claims.

What is claimed is:

1. An abutment structure, comprising:
a body portion; and
at least one abutment portion, movably arranged on the body portion.

2. The abutment structure according to claim 1, further comprising a second fastening portion, wherein the abutment portion abuts against the second fastening portion, or the body portion has an arrangement portion, a limiting portion, or a lifting portion, or the limiting portion limits the abutment portion, the abutment portion moves longitudinally to enable the second fastening portion to reach an arrangement position of the arrangement portion, or the lifting portion is configured to abut against the abutment portion that is rotated.

3. The abutment structure according to claim 1, wherein the body portion is a handle, the body portion is mounted to an object through fitting portions on two ends respectively mated with fixing elements, the body portion is provided with two adjacent abutment portions, or the body portion is provided with one abutment portion, the abutment structure has a pushed object, the pushed object is a handle, the pushed object is provided with at least one entry portion, the entry portion is in communication with a channel, the entry portion is configured to lift the abutment portion, the entry portion is configured to enable the abutment portion to elastically abut against or be elastically snap-fitted to the entry portion, or the abutment structure or the body portion is arranged on the object, the object is a casing or a cabinet, the body portion is provided with a handle portion or a fastening member, the abutment portion is provided with a first fastening portion, or the handle portion is configured to move the body portion and mate with abutment of the abutment portion or an elastic element, or allow snap-fitting and tripping of the fastening member or the first fastening portion and the object.

4. The abutment structure according to claim 1, further comprising a second fastening portion or an elastic element, the abutment portion abuts against the second fastening portion, the body portion, the abutment portion, and the elastic element are integrally formed, the body portion is provided with an arrangement portion or a limiting portion, the abutment portion moves longitudinally or rotationally to enable the elastic element to be elastically limited or elastically disengage from the limiting portion, or to enable the abutment portion to drive the second fastening portion to reach an arrangement position of the arrangement portion, the abutment portion has an open portion, and the open portion is configured to rotationally limit a limiting position of the second fastening portion, or configured to limit an open position of the second fastening portion, so as to enable the second fastening portion to perform required position limitation or position release through cooperation of the open portion.

5. The abutment structure according to claim 1, wherein the body portion is provided with a limiting portion, the limiting portion is joined to the body portion through a riveted connection, a threaded connection, a snap fit, a welded connection, a locked connection, hot melting, or stamping with a tool, the limiting portion is configured to limit movable joining of the abutment portion and the body portion, an end of the body portion is provided with a fitting portion, the fitting portion comprises a snap-fit member or a snap member, or the body portion is joined to an object through the snap-fit member or the snap member.

6. The abutment structure according to claim 1, wherein the abutment structure is fitted to two heat sinks, a heating member is arranged between the two heat sinks, the two heat sinks are pressed against the heating member through an abutment force of the abutment portion, each of the heat sinks is configured to dissipate heat of the heating member, the abutment structure is arranged or integrally formed on one heat sink, or the abutment portion is snap-fitted to or arranged on an object, a circuit board, or the other heat sink, so that the heat sink dissipates heat of the heating member.

7. The abutment structure according to claim 1, further comprising a first fastening portion or a second fastening portion, wherein the body portion has an arrangement portion configured to allow the second fastening portion to reach an arrangement position, the abutment portion is joined to the first fastening portion through a joining portion, or the abutment portion is moved to control movement or snap-fit of the second fastening portion; or further comprising a first fastening portion or a second fastening portion, wherein the first fastening portion abuts against the second fastening portion, the body portion is provided with a rotating portion, the abutment portion is provided with a corresponding rotating portion, the abutment portion is rotated to enable the rotating portion to mate with the corresponding rotating portion, or the first fastening portion is allowed to control the movement of the second fastening portion in a spiral manner.

8. The abutment structure according to claim 1, wherein the abutment portion is arranged on a fastener, the abutment portion is configured to be snap-fitted to an object, enable a fastening portion of the fastener to be snap-fitted to or be limited to a snap-fit portion of the object, or prevent the fastener from detaching from the object, and the fastening portion is a threaded member, an outer fastening member, an inner fastening member, a snap member, or a column member.

9. The abutment structure according to claim 1, wherein the body portion, the abutment portion, and an elastic element are integrally formed, and the elastic element is elastically deformable and snap-fitted to a limiting portion of the body portion, so as to limit the abutment portion or prevent the corresponding rotating portion of the abutment portion from being detached or loosened from the rotating portion, or the abutment portion is a threaded member, a column member, an outer fastening member, an inner fastening member, or a snap member.

10. The abutment structure according to claim 1, wherein the body portion is provided with a handle portion, the body portion is arranged on an object, the abutment portion is provided with a guide portion, the guide portion is configured to guide the handle portion or the object to approach, enter, or be arranged or assembled to an other object, a margin is defined between the guide portion and the handle portion, an other margin is defined between the handle portion and the other object, the guide portion and the handle portion are fitted through a joining portion, the joining portion is a threaded member, a riveted member, or an expanded member, an end of an elastic element abuts against the body portion, and an other end abuts against the abutment portion, the body portion is provided with a handle portion, a pulling portion, or a fastening member, the elastic element is arranged on the body portion, the body portion is the elastic element, the fastening member is snap-fitted to an object and an other object, or is configured to perform elastic tripping to enable the object to move through the wheel member, the object is a casing, or the other object is a rack or a cabinet.

11. The abutment structure according to claim 1, wherein the body portion is provided with an anti-rotation portion, the abutment portion is provided with a corresponding anti-rotation portion, the anti-rotation portion and the corresponding anti-rotation portion are configured to prevent rotation between the body portion and the abutment portion, or the anti-rotation portion or the corresponding anti-rotation portion is configured to prevent rotation with respect to an object.

12. The abutment structure according to claim 1, wherein the body portion is provided with a handle portion or a second fastening portion, the body portion is arranged on an object, the second fastening portion is snap-fitted to an other object, the second fastening portion is an outer fastening member, a threaded member, a column member, a snap member, an inner fastening member, an inclined surface-equipped member, or a curved surface-equipped member, the body portion is provided with an arrangement portion configured to allow arrangement of the second fastening portion, the arrangement portion has an anti-rotation portion or a limiting portion, or is configured to prevent rotation of or limit the handle portion when it is shaped during manufacturing by stamping by applying a force, the arrangement portion is kept in a position or a direction where the second fastening portion is correctly mounted, the handle portion is formed by injection molding through a mold, the arrangement portion for arranging the second fastening portion is formed through a mold or a module, or the mode is formed through injection molding in a plastic or metal mold.

13. The abutment structure according to claim 1, wherein the body portion is provided with at least one second fastening portion, the body portion is snap-fitted to an object through the second fastening portion, or the body portion is provided with an arrangement portion configured to allow the second fastening portion to enter or reach an arrangement position or a snap-fit position, the arrangement portion is located on a lateral side, above, or below the body portion, the second fastening portion first enters the body portion through the arrangement portion, the second fastening portion enters an arrangement position or a snap-fit position, the abutment portion is configured to abut against the second fastening portion, or the second fastening portion is enabled to be opened or closed through the abutment portion, an elastic element is arranged on the body portion to abut against the abutment portion, the elastic element is arranged on the body portion to abut against the body portion and the abutment portion, the abutment portion has a guide portion to guide movement of the second fastening portion, the guide portion is an inclined surface, a curved surface, an arc surface, a step portion, a recess, a protrusion, or a flat surface, the abutment portion has a limiting portion for limiting the position of the second fastening portion or a position after the movement, or one, two, or more than two second fastening portions are arranged.

14. The abutment structure according to claim 1, wherein the body portion is provided with an arrangement portion configured to allow the second fastening portion to enter or reach an arrangement position or a snap-fit position, the arrangement portion is located on a lateral side, above, or below the body portion, the second fastening portion first enters the body portion through the arrangement portion, the second fastening portion enters an arrangement position or a snap-fit position, the abutment portion is configured to abut against the second fastening portion, or the second fastening portion is enabled to be opened or closed through the abutment portion, an elastic element is arranged on the body portion to abut against the abutment portion, the elastic element is arranged on the body portion to abut against the body portion and the abutment portion, the abutment portion has a guide portion to guide movement of the second fastening portion, the guide portion is an inclined surface, a curved surface, an arc surface, a step portion, a recess, a protrusion, or a flat surface, or the abutment portion has a limiting portion for limiting the position of the second fastening portion or a position after the movement.

15. The abutment structure according to claim 1, wherein the body portion is provided with an arrangement position configured to allow arrangement of a second fastening portion, the arrangement position is located on a lateral side, above, or below the body portion, the second fastening portion enters the arrangement position or a snap-fit position, the abutment portion is configured to abut against the second fastening portion, or the second fastening portion is enabled to be opened or closed through the abutment portion, the second fastening portion is first arranged in the arrangement position, then the abutment portion or an elastic element is arranged on the body portion to abut against the abutment portion, the elastic element is mounted in the body portion to abut against the body portion and the abutment portion, the abutment portion has a guide portion to guide movement of the second fastening portion, the guide portion is an inclined surface, a curved surface, an arc surface, a step portion, a recess, a protrusion, or a flat surface, the abutment portion has a limiting portion to limit a position of the second fastening portion or a position after movement, the body portion has an arrangement portion configured to allow the second fastening portion to reach the arrangement position, and then the abutment portion or the elastic element is arranged on the body portion to abut against the abutment portion.

16. The abutment structure according to claim 1, wherein the body portion is configured to be fitted to or integrally formed with an object, the abutment portion is provided with a first fastening portion, the abutment portion is configured to be fitted or bolted to the body portion to form a fitted member, a connector, or a link member, an elastic element abuts against the body portion and the abutment portion, the object is snap-fitted to an other object through the first fastening portion, or the object is provided with a wheel member, a rolling member, a track member, or a sliding member, so that the first fastening portion is opened or closed to move the object through the wheel member, the rolling member, the track member, or the sliding member, or configured to be detached from the other object; the abutment portion is provided with an entry portion configured to enable a second fastening portion to snap-fit the abutment portion to the object; the entry portion has a channel configured to enable the second fastening portion with the elastic element to limit, temporarily limit, or elastically limit the first fastening portion in a snap-fit position or a tripping position, or the first fastening portion is moved to the snap-fit position or the tripping position.

17. The abutment structure according to claim 1, wherein the body portion is provided with an anti-rotation portion configured to prevent rotation with respect to an object, the abutment portion is provided with an other anti-rotation portion configured to prevent rotation with respect to the body portion, the other anti-rotation portion is configured to limit a position or movement of the abutment portion, or the other anti-rotation portion is configured to limit a snap-fit direction, a snap-fit angle, or a snap-fit position of a second fastening portion.

18. The abutment structure according to claim 1, wherein the body portion is fitted to the abutment portion and an object, the abutment portion is a fastening portion, the object is arranged on an other object, the object and the other object are each a casing or a cabinet, or the abutment portion is snap-fitted to the other object to operate, rotate, or pull the body portion, to enable the abutment portion to be detached from the other object, or to enable an object with a wheel member or a track to be partially or completely detached from or snap-fitted to the other object through rolling of the wheel member or sliding of the track.

19. The abutment structure according to claim 1, wherein the body portion is provided with an arrangement portion, or the body portion is provided with an arrangement position, the arrangement portion is configured to allow a second fastening portion to reach the arrangement position, or the arrangement position and the arrangement portion are opposite positions or reachable positions through free fall.

20. The abutment structure according to claim 1, wherein the body portion is provided with an arrangement portion, the body portion is provided with an arrangement position, and the second fastening portion reaches the arrangement position through the arrangement portion.

21. The abutment structure according to claim 1, wherein the body portion is provided with an arrangement portion, the body portion is provided with an arrangement position, the second fastening portion reaches the arrangement position through the arrangement portion, and an abutment portion is arranged on the body portion to abut against the second fastening portion.

22. The abutment structure according to claim 1, wherein the body portion is provided with an arrangement portion, the body portion is provided with an arrangement position, the second fastening portion reaches the arrangement position through the arrangement portion, the second fastening portion reaches the arrangement position through the arrangement portion through free fall, the second fastening portion reaches the arrangement position through the arrangement portion by using a tool, the second fastening portion is configured to limit the abutment portion after reaching the arrangement position, or the second fastening portion reaches the arrangement position through the arrangement portion, and then the abutment portion or an elastic element is arranged on the body portion to abut against the abutment portion.

23. The abutment structure according to claim 1, wherein the elastic element is a torsion spring having two ends respectively arranged on the body portion and the abutment portion, so as to enable the abutment portion to elastically rotate and abut against a second fastening portion, or enable the second fastening portion to be located in a snap-fit position or a non-snap-fit position, or wherein the body portion or the abutment portion is provided with a limiting portion configured to limit the abutment portion to enable the second fastening portion to be in the snap-fit position or the non-snap-fit position.

24. The abutment structure according to claim 1, wherein two abutment portions and two elastic elements are arranged, the abutment portions are configured to be snap-fitted to two receiving objects, the body portion is provided with a shoulder portion, the shoulder portion is configured to support at least one receiving object, the body portion is provided with a fitting portion, the fitting portion is configured to be fitted to an object, the body portion is provided with an anti-rotation portion, the anti-rotation portion is configured to limit a direction of the body portion, the anti-rotation portion is configured to limit a snap-fit direction of the abutment portions, or the anti-rotation portion is configured to limit directions of the body portion, the abutment portions, and the object.

25. The abutment structure according to claim 1, wherein the body portion is provided with an arrangement portion, an object enters the body portion through the arrangement portion and is snap-fitted, interference-fitted, locked, or enabled to conduct current through the abutment portion, or wherein the object is a receiving member, a conductive member, a wire, a fastener, an optical fiber, a metal member, a plastic member, a column member, or a plate member, the abutment portion is a fastening portion, a column member, a threaded member, a convex member, a concave member, or a flat member, two ends of the elastic element respectively abut against the body portion and the abutment portion, or the arrangement portion is a hole portion, a groove portion, a trench portion, or a space.

26. The abutment structure according to claim 1, wherein the body portion is provided with a limiting portion, the limiting portion is configured to limit the abutment portion and the elastic element, or the body portion is provided with a screw thread to be fixed to an object, or first passes through the object and then is fixed to an other object, the abutment portion is laterally fitted to the body portion and is configured to laterally abut against or be snap-fitted to the object, or the abutment portion is configured to laterally abut against or be snap-fitted to a receiving portion of the object, the abutment portion first passes through the object and then laterally abuts against or is snap-fitted to the other object, the body portion first passes through the object and then is configured to be locked into the other object, the abutment portion abuts against or is snap-fitted to the other object or the receiving portion of the other object, or the abutment portion is configured to be laterally interference-fitted to a nut, the screw thread, or the object to prevent loosening or snap-fit, the body portion is provided with a fitting portion, the fitting portion is configured to be riveted, expanded, welded, snap-fitted, or locked to the object, the body portion is provided with an operating portion, or the body portion is provided with a head portion.

27. The abutment structure according to claim 1, further comprising an elastic element, wherein the elastic element is arranged between the body portion and the abutment portion and located on an outer side of the body portion, or wherein the abutment portion is a pull member, the body portion is a handle, or the abutment portion is joined to a first fastening portion through an other joining portion, or configured to pull the abutment portion to control snap-fitting or tripping of the first fastening portion and an other object.

28. The abutment structure according to claim 1, wherein the abutment portion is pressed by a tool or a mold, or the abutment portion is expanded and fitted to the body portion, or the abutment portion is provided with a groove portion, a recess, or a hole portion, and is configured to apply pressure to the groove portion, the recess, or the hole portion through a tool or a mold, causing the abutment portion to be expanded and fitted to the body portion.

29. The abutment structure according to claim 1, wherein the abutment portion is snap-fitted to a heating member or a heat sink, and the heat sink is configured to dissipate heat of the heating member, or wherein the body portion is a handle, a fastening member, a track member, a heat sink, a moving member, a wheel, a rotating member, or a rolling member, the body portion is arranged or mounted to an object, or the abutment portion is located on an other side of the object, and the abutment portion is configured to be snap-fitted to another object.
